(19) United States
(12) Patent Application Publication
(10) Pub. No.: US 2021/0092405 A1
(43) Pub. Date: Mar. 25, 2021

(54) MATRIX COMBINATION FOR MATRIX-WEIGHTED INTRA PREDICTION IN VIDEO CODING

(71) Applicant: QUALCOMM Incorporated, San Diego, CA (US)

(72) Inventors: Thibaud Laurent Biatek, Versailles (FR); Adarsh Krishnan Ramasubramonian, Irvine, CA (US); Geert Van der Auwera, Del Mar, CA (US); Marta Karczewicz, San Diego, CA (US)

(73) Assignee: QUALCOMM Incorporated, San Diego, CA (US)

(21) Appl. No.: 17/024,522

(22) Filed: Sep. 17, 2020

Related U.S. Application Data
(60) Provisional application No. 62/902,868, filed on Sep. 19, 2019.
(60) Provisional application No. 62/905,115, filed on Sep. 24, 2019.
(60) Provisional application No. 62/905,865, filed on Sep. 25, 2019.

(51) Int. Cl. H04N 19/159; H04N 19/46; H04N 19/176; H04N 19/70; H04N 19/59

(52) U.S. Cl. CPC H04N 19/159; H04N 19/46; H04N 19/59; H04N 19/70; H04N 19/176

(57) ABSTRACT

A video decoder obtains a transpose flag from the bitstream. The video decoder determines an input vector based on neighboring samples for a current block of the video data. The transpose flag indicates whether the input vector is transposed. Additionally, the video decoder determines a prediction signal. Determining the prediction signal includes multiplying a MIP matrix by the input vector. The prediction signal includes values corresponding to a first set of locations in a prediction block for the current block and the MIP matrix corresponds to the MIP mode index. The video decoder applies an interpolation process to the prediction signal to determine values corresponding to a second set of locations in the prediction block for the current block.

This application claims the benefit of U.S. Provisional Patent Application 62/902,868, filed Sep. 19, 2019, U.S. Provisional Patent Application 62/905,115, filed Sep. 24, 2019, and U.S. Provisional Patent Application 62/905,865, filed Sep. 25, 2019, the entire content of each of which are incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for matrix-weighted intra prediction (MIP) in video coding. As described herein, a video encoder may determine and signal a MIP mode syntax element and a transpose flag. The MIP mode syntax element indicates a MIP mode index that corresponds to a stored MIP matrix. The transpose flag indicates whether an input vector is transposed. Additionally, the video encoder may determine an input vector based on neighboring samples for a current block of the video data. The video encoder may determine a prediction signal. As part of determining the prediction signal, the video encoder may multiply the MIP matrix by the input vector. The video encoder may then apply an interpolation process to the prediction signal to determine values in a prediction block for the current block. The video encoder may generate residual samples for the current block based on differences between samples of the current block and corresponding samples of the prediction block for the current block.

A video decoder may obtain the MIP mode syntax element and the transpose flag from a bitstream. Additionally, the video decoder may determine an input vector based on neighboring samples for a current block of the video data. Based on the transpose flag, the video decoder may transpose the input vector. The video decoder may determine a prediction signal. As part of determining the prediction signal, the video decoder may multiply the MIP matrix by the input vector. The video decoder may then apply an interpolation process to the prediction signal to determine values in a prediction block for the current block. The video decoder may reconstruct the current block by adding samples of the prediction block for the current block to corresponding residual samples for the current block.

In one example, this disclosure describes a method of decoding video data, the method comprising: storing a plurality of Matrix Intra Prediction (MIP) matrices; obtaining, from a bitstream that includes an encoded representation of the video data, a MIP mode syntax element indicating a MIP mode index for a current block of the video data; obtaining a transpose flag from the bitstream; determining an input vector based on neighboring samples for the current block, wherein the transpose flag indicates whether the input vector is transposed; determining a prediction signal, wherein determining the prediction signal comprises multiplying a MIP matrix by the input vector, wherein the prediction signal comprises values corresponding to a first set of locations in a prediction block for the current block, the MIP matrix is one of the plurality of stored MIP matrices, and the MIP matrix corresponds to the MIP mode index; applying an interpolation process to the prediction signal to determine values corresponding to a second set of locations in the prediction block for the current block; and reconstructing the current block by adding samples of the prediction block for the current block to corresponding residual samples for the current block.

In another example, this disclosure describes a method of encoding video data, the method comprising: storing a plurality of Matrix Intra Prediction (MIP) matrices; determining an input vector based on neighboring samples for a current block of the video data; determining a MIP matrix from the plurality of stored MIP matrices; signaling, in a bitstream that includes an encoded representation of the video data, a MIP mode syntax element indicating a MIP mode index for the current block; signaling, in the bitstream, a transpose flag that indicates whether the input vector is transposed; determining a prediction signal, wherein determining the prediction signal comprises multiplying the determined MIP matrix by the input vector, wherein the prediction signal comprises values corresponding to a first set of locations in a prediction block for the current block, and the determined MIP matrix corresponds to the MIP mode index; applying an interpolation process to the prediction signal to determine values corresponding to a second set of locations in the prediction block for the current block; and generating residual samples for the current block based on differences between samples of the current block and corresponding samples of the prediction block for the current block.

In another example, this disclosure describes a device for decoding video data, the device comprising: a memory to store a plurality of Matrix Intra Prediction (MIP) matrices; and one or more processors implemented in circuitry, the one or more processors configured to: obtain, from a bitstream that includes an encoded representation of the video data, a MIP mode syntax element indicating a MIP mode index for a current block of the video data; obtain a transpose flag from the bitstream; determine an input vector based on neighboring samples for the current block, wherein the transpose flag indicates whether the input vector is transposed; determine a prediction signal, wherein the one or more processors are configured such that, as part of determining the prediction signal, the one or more processors multiply a MIP matrix by the input vector, wherein the prediction signal comprises values corresponding to a first set of locations in a prediction block for the current block, the MIP matrix is one of the plurality of stored MIP matrices, and the MIP matrix corresponds to the MIP mode index; apply an interpolation process to the prediction signal to determine values corresponding to a second set of locations in the prediction block for the current block; and reconstruct the current block by adding samples of the prediction block for the current block to corresponding residual samples for the current block.

In another example, this disclosure describes a device for encoding video data, the device comprising: a memory to store a plurality of Matrix Intra Prediction (MIP) matrices; and one or more processors implemented in circuitry, the one or more processors configured to: determine an input vector based on neighboring samples for a current block of the video data; determine a MIP matrix from the plurality of stored MIP matrices; signal, in a bitstream that includes an encoded representation of the video data, a MIP mode syntax element indicating a MIP mode index for the current block; signal, in the bitstream, a transpose flag that indicates whether the input vector is transposed; determine a prediction signal, wherein the one or more processors are configured such that, as part of determining the prediction signal, the one or more processors multiply the determined MIP matrix by the input vector, wherein the prediction signal comprises values corresponding to a first set of locations in a prediction block for the current block, and the determined MIP matrix corresponds to the MIP mode index; apply an interpolation process to the prediction signal to determine values corresponding to a second set of locations in the prediction block for the current block; and generate residual samples for the current block based on differences between samples of the current block and corresponding samples of the prediction block for the current block.

In another example, this disclosure describes a device for decoding video data, the device comprising: means for storing a plurality of Matrix Intra Prediction (MIP) matrices; means for obtaining, from a bitstream that includes an encoded representation of the video data, a MIP mode syntax element indicating a MIP mode index for a current block of the video data; means for obtaining a transpose flag from the bitstream; means for determining the input vector based on neighboring samples for the current block, wherein the transpose flag indicates whether the input vector is transposed; means for determining a prediction signal, wherein determining the prediction signal comprises multiplying a MIP matrix by the transposed input vector, wherein the prediction signal comprises values corresponding to a first set of locations in a prediction block for the current block, the MIP matrix is one of the plurality of stored MIP matrices, and the MIP matrix corresponds to the MIP mode index; means for applying an interpolation process to the prediction signal to determine values corresponding to a second set of locations in the prediction block for the current block; and means for reconstructing the current block by adding samples of the prediction block for the current block to corresponding residual samples for the current block.

In another example, this disclosure describes a device for encoding video data, the method comprising: means for storing a plurality of Matrix Intra Prediction (MIP) matrices; means for determining an input vector based on neighboring samples for a current block of the video data; means for determining a MIP matrix from the plurality of stored MIP matrices; means for signaling, in a bitstream that includes an encoded representation of the video data, a MIP mode syntax element indicating a MIP mode index for the current block; means for signaling, in the bitstream, a transpose flag that indicates whether the input vector is transposed; means for determining a prediction signal, wherein determining the prediction signal comprises multiplying the determined MIP matrix by the input vector, wherein the prediction signal comprises values corresponding to a first set of locations in a prediction block for the current block, and the determined MIP matrix corresponds to the MIP mode index; means for applying an interpolation process to the prediction signal to determine values corresponding to a second set of locations in the prediction block for the current block; and means for generating residual samples for the current block based on differences between samples of the current block and corresponding samples of the prediction block for the current block.

In another example, this disclosure describes a computer-readable storage medium having stored thereon instructions that, when executed, cause one or more processors to: store a plurality of Matrix Intra Prediction (MIP) matrices; obtain, from a bitstream that includes an encoded representation of the video data, a MIP mode syntax element indicating a MIP mode index for a current block of the video data; obtain a transpose flag from the bitstream; determining the input vector based on neighboring samples for the current block, wherein the transpose flag indicates whether the input vector is transposed; determine a prediction signal, wherein determining the prediction signal comprises multiplying a MIP matrix by the transposed input vector, wherein the prediction signal comprises values corresponding to a first set of locations in a prediction block for the current block, the MIP matrix is one of the plurality of stored MIP matrices, and the MIP matrix corresponds to the MIP mode index; apply an interpolation process to the prediction signal to determine values corresponding to a second set of locations in the prediction block for the current block; and reconstruct the current block by adding samples of the prediction block for the current block to corresponding residual samples for the current block.

In another example, this disclosure describes a computer-readable storage medium having stored thereon instructions that, when executed, cause one or more processors to: store a plurality of Matrix Intra Prediction (MIP) matrices; determine an input vector based on neighboring samples for a current block of the video data; determine a MIP matrix from the plurality of stored MIP matrices; signal, in a bitstream that includes an encoded representation of the video data, a MIP mode syntax element indicating a MIP mode index for the current block; signal, in the bitstream, a transpose flag that indicates whether the input vector is transposed; determine a prediction signal, wherein determining the prediction signal comprises multiplying the determined MIP matrix by the transposed input vector, wherein the prediction signal comprises values corresponding to a first set of locations in a prediction block for the current block, and the MIP matrix corresponds to the MIP mode index; apply an interpolation process to the prediction signal to determine values corresponding to a second set of locations in the prediction block for the current block; and generate residual samples for the current block based on differences between samples of the current block and corresponding samples of the prediction block for the current block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example matrix-weighted intra prediction process.

FIG. 3 is a block diagram illustrating an example video encoder that may perform the techniques of this disclosure.

FIG. 4 is a block diagram illustrating an example video decoder that may perform the techniques of this disclosure.

FIG. 5 is a conceptual diagram illustrating an example column combination with N=7 and N1=4, in accordance with one or more aspects of this disclosure.

FIG. 6 is a conceptual diagram illustrating an example column combination with N=8 and N1=4, in accordance with one or more aspects of this disclosure.

FIG. 7 is a conceptual diagram illustrating an example column combination with N=4 and N1=2, in accordance with one or more aspects of this disclosure.

FIG. 8 is a conceptual diagram illustrating an example row combination with K=16 and K1=8, in accordance with one or more aspects of this disclosure.

FIG. 9 is a conceptual diagram illustrating an example column combination of matrices having different sizes, in accordance with one or more aspects of this disclosure.

FIG. 10 is a conceptual diagram illustrating combinations of Matrix-weighted Intra Prediction (MIP) matrices in accordance with one or more techniques of this disclosure.

FIG. 11 is a flowchart illustrating an example method for encoding a current block.

FIG. 12 is a flowchart illustrating an example method for decoding a current block of video data.

FIG. 13 is a flowchart illustrating an example method for encoding data in accordance with one or more techniques of this disclosure.

FIG. 14 is a flowchart illustrating an example method for decoding data in accordance with one or more techniques of this disclosure.

### DETAILED DESCRIPTION

Matrix-weighted intra prediction (MIP) is a coding tool that may provide increased efficiency for coding video data. When using MIP, a video coder (e.g., a video encoder or a video decoder) may determine an input vector based on neighboring samples for a current block of the video data. Additionally, the video coder may determine a prediction signal, e.g., by multiplying a MIP matrix by the input vector and adding an offset vector. The prediction signal includes values corresponding to a first set of locations in a prediction block for the current block. The video coder may then apply an interpolation process to the prediction signal to determine values corresponding to a second set of locations in the prediction block for the current block.

The video coder may store a plurality of different MIP matrices in memory and use one of the MIP matrices when coding an individual block. The use of different MIP matrices may increase the efficiency of the MIP coding tool. However, considerable space in memory may be required to store the MIP matrices. Thus, there is a tradeoff between increasing coding efficiency by storing more MIP matrices and increased memory spaces required by more MIP matrices.

This disclosure describes techniques for MIP in video coding that may address such issues. As described herein, a video decoder may store a plurality of MIP matrices. A MIP mode syntax element that is signaled in a bitstream indicates a MIP mode index for a current block of video data. Additionally, a transpose flag that is signaled in the bitstream. The video decoder may determine the input vector based on neighboring samples for the current block. The transpose flag indicates whether the input vector is transposed. Furthermore, the video decoder may determine a prediction signal. The video decoder may determine the prediction signal at least in part by multiplying a MIP matrix by the input vector. The prediction signal includes values corresponding to a first set of locations in a prediction block for the current block. The MIP matrix is one of the plurality of stored MIP matrices and corresponds to the MIP mode index. The video decoder may apply an interpolation process to the prediction signal to determine values corresponding to a second set of locations in the prediction block for the current block. Transposing the input vector through the use of the transpose flag may have an effect equivalent to increasing the number of MIP matrices, but without increasing the amount of memory space required to store extra MIP matrices. In this way, the techniques of this disclosure may enable increased coding efficiency without increasing memory space requirements.

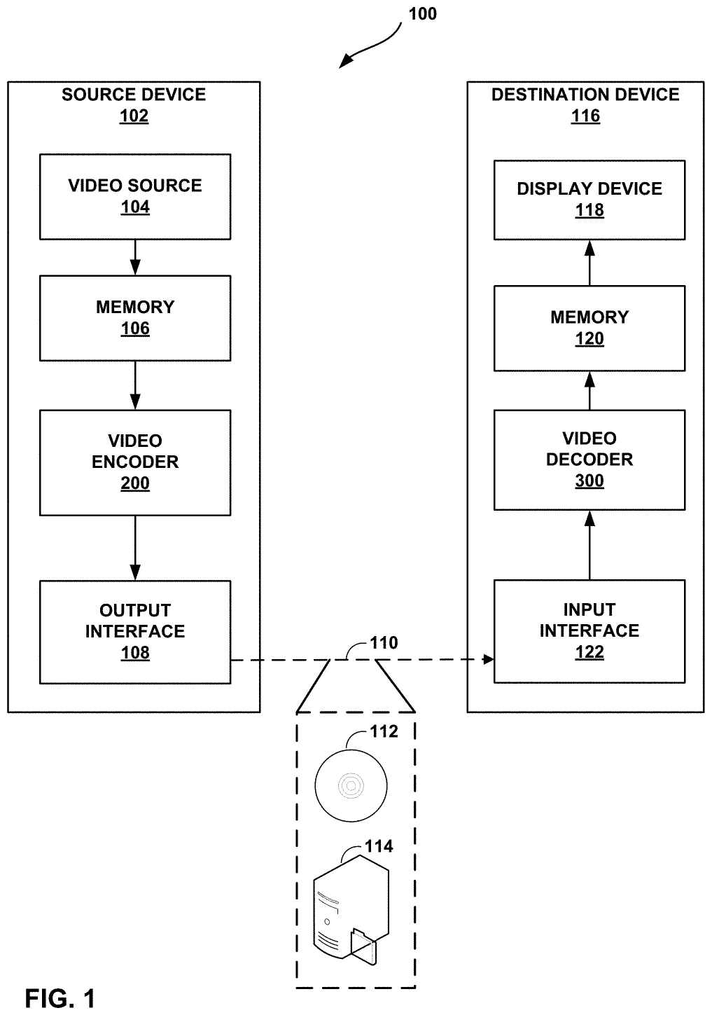

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may include any of a wide range of devices, including desktop computers, mobile devices (e.g., notebook (i.e., laptop) computers, tablet computers, telephone handsets such as smartphones, cameras, etc.), set-top boxes, broadcast receiver devices, televisions, display devices, digital media players, video gaming consoles, video streaming devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for matrix-weighted intra prediction described in this disclosure. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for matrix-weighted intra prediction described in this disclosure. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, computer-readable medium 110 may include storage device 112. Source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, computer-readable medium 110 may include file server 114 or another intermediate storage device that may store the encoded video data generated by source device 102. Source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may include an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A recent draft of the VVC standard is described in Bross, et al. “Versatile Video Coding (Draft 6),” Joint Video Experts Team (JVET) of ITU-T SG 16 WP 3 and ISO/IEC JTC 1/SC 29/WG 11, 15^{th} Meeting: Gothenburg, SE, 3-12 Jul. 2019, JVET-02001-vE (hereinafter “VVC Draft 6”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

As mentioned above, video encoder 200 and video decoder 300 may apply CABAC encoding and decoding to values of syntax elements. To apply CABAC encoding to a syntax element, video encoder 200 may binarize the value of the syntax element to form a series of one or more bits, which are referred to as “bins.” In addition, video encoder 200 may identify a coding context. The coding context may identify probabilities of bins having particular values. For instance, a coding context may indicate a 0.7 probability of coding a 0-valued bin and a 0.3 probability of coding a 1-valued bin. After identifying the coding context, video encoder 200 may divide an interval into a lower sub-interval and an upper sub-interval. One of the sub-intervals may be associated with the value 0 and the other sub-interval may be associated with the value 1. The widths of the sub-intervals may be proportional to the probabilities indicated for the associated values by the identified coding context. If a bin of the syntax element has the value associated with the lower sub-interval, the encoded value may be equal to the lower boundary of the lower sub-interval. If the same bin of the syntax element has the value associated with the upper sub-interval, the encoded value may be equal to the lower boundary of the upper sub-interval. To encode the next bin of the syntax element, video encoder 200 may repeat these steps with the interval being the sub-interval associated with the value of the encoded bit. When video encoder 200 repeats these steps for the next bin, video encoder 200 may use modified probabilities based on the probabilities indicated by the identified coding context and the actual values of bins encoded.

When video decoder 300 performs CABAC decoding on a value of a syntax element, video decoder 300 may identify a coding context. Video decoder 300 may then divide an interval into a lower sub-interval and an upper sub-interval. One of the sub-intervals may be associated with the value 0 and the other sub-interval may be associated with the value 1. The widths of the sub-intervals may be proportional to the probabilities indicated for the associated values by the identified coding context. If the encoded value is within the lower sub-interval, video decoder 300 may decode a bin having the value associated with the lower sub-interval. If the encoded value is within the upper sub-interval, video decoder 300 may decode a bin having the value associated with the upper sub-interval. To decode a next bin of the syntax element, video decoder 300 may repeat these steps with the interval being the sub-interval that contains the encoded value. When video decoder 300 repeats these steps for the next bin, video decoder 300 may use modified probabilities based on the probabilities indicated by the identified coding context and the decoded bins. Video decoder 300 may then de-binarize the bins to recover the value of the syntax element.

In some instances, video encoder 200 may encode bins using bypass CABAC coding, which may also be referred to as bypass coding. It may be computationally less expensive to perform bypass CABAC coding on a bin than to perform regular CABAC coding on the bin. Furthermore, performing bypass CABAC coding may allow for a higher degree of parallelization and throughput. Bins encoded using bypass CABAC coding may be referred to as “bypass bins.” Grouping bypass bins together may increase the throughput of video encoder 200 and video decoder 300. The regular CABAC coding engine may be able to code several bins in a single cycle, whereas the bypass CABAC coding engine may be able to code only a single bin in a cycle. The bypass CABAC coding engine may be simpler because the bypass CABAC coding engine does not select contexts and may assume a probability of ½ for both symbols (0 and 1). Consequently, in bypass CABAC coding, the intervals are split directly in half.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

During the 14^{th} JVET meeting in Geneva, Switzerland, the “Affine linear weighted intra prediction” or “ALWIP” tool was adopted into the VVC working draft version 5. See e.g., J. Pfaff, B. Stallenberger, M. Schafer, P. Merkle, P. Helle, T. Hinz, H. Schwarz, D. Marpe, T. Wiegand, “CE3: Affine linear weighted intra prediction,” 14th JVET Meeting, Geneva, Switzerland, March 2019, JVET-N0217 (hereinafter, “JVET-N0217”). The ALWIP tool is also referenced with the name “matrix intra prediction” or “MIP”. During the 15^{th} JVET meeting in Goteborg, Sweden, a modified design of MIP was adopted for VVC Draft 6, providing significant design simplification and storage saving. See e.g., J. Pfaff et al., “Non-CE3: Simplification of MIP”, 15th JVET Meeting, Gothenburg, Sweden, July 2019, JVET-00925 (hereinafter, “JVET-00925”).

As an introduction to the MIP coding tool, the first adopted version of MIP is reproduced below in this disclosure from J. Chen, Y. Ye and S.-H. Kim, “Algorithm description for Versatile Video Coding and Test Model 6 (VTM 6)”, 15^{th} JVET Meeting, Gothenburg, Sweden, July 2019, JVET-02002 (hereinafter, “WET-02002”), [0075] followed by a description of its simplified version adopted in VVC draft version 6. See JVET-00925.

Description of MIP in JVET-02002

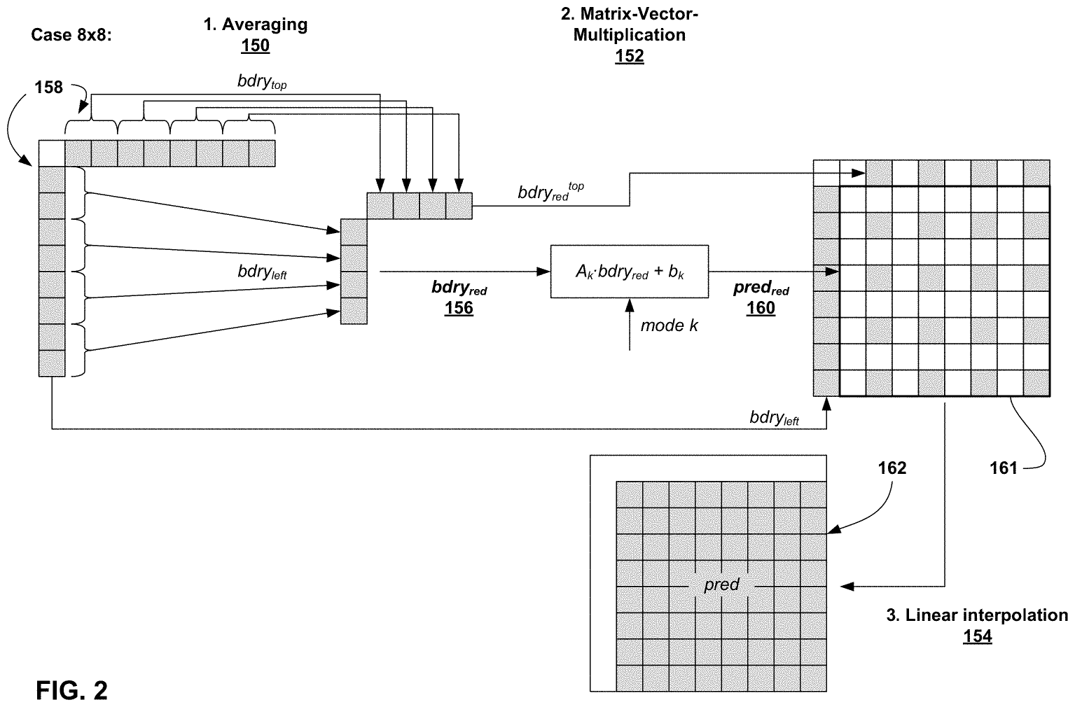

Matrix weighted intra prediction (MIP) method is a newly added intra prediction technique into VVC. For predicting the samples of a rectangular block of width W and height H, MIP takes one line of H reconstructed neighbouring boundary samples left of the block and one line of W reconstructed neighbouring boundary samples above the block as input. If the reconstructed samples are unavailable, the neighboring boundary samples are generated similar to what is done in the conventional intra prediction. In VVC draft 5, the exact method of generating the unavailable samples was slightly different from that used for intra prediction. FIG. 2 is a conceptual diagram illustrating an example matrix-weighted intra prediction process. The generation of the prediction block is based on the following three steps, which are averaging 150, matrix vector multiplication 152 and linear interpolation 154, as shown in FIG. 2.

Out of the boundary samples, four samples in the case of W=H=4 and eight samples in all other cases are extracted by averaging. Specifically, the input boundary vectors bdry^{top} and bdry^{left} are reduced to smaller boundary vectors bdry_{red}^{top} and bdry_{red}^{left} by averaging neighboring boundary samples according to a predefined rule that depends on block size. Then, the two reduced boundary vectors bdry_{red}^{top} and bdry_{red}^{left} are concatenated to a reduced boundary vector bdry_{red} which is thus of size four for blocks of shape 4×4 and of size eight for blocks of all other shapes. In the following equation, mode refers to the MIP mode and this concatenation may be defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6. \end{matrix} \qquad ( 1 )$$

A matrix vector multiplication, followed by addition of an offset, is carried out with the averaged samples as the input. The result is a prediction signal on a sub sampled set of samples in the original block. Because the prediction signal is on a subsampled set of samples of the original block instead of all of the samples in the original block, the prediction signal may be referred to herein as a reduced prediction signal. Out of the reduced input vector bdry_{red} a reduced prediction signal pred_{red}, which is a signal on the down-sampled block of width W_{red} and height H_{red}, is generated. Here, W_{red} and H_{red} are defined as follows:

$$\begin{matrix}{W}_{red} = \{ \begin{matrix}4 & for max ( W , H ) \leq 8 \\ min ( W , 8 ) & for max ( W , H ) > 8\end{matrix} & ( 2 ) \\ {H}_{red} = \{ \begin{matrix}4 & for max ( W , H ) \leq 8 \\ min ( H , 8 ) & for max ( W , H ) > 8\end{matrix} & ( 3 )\end{matrix}$$

The reduced prediction signal pred_{red} is computed by calculating a matrix vector product and adding an offset:

pred_{red}=A·bdry_{red}+b.

Here, A is a matrix that has W_{red}·H_{red} rows and 4 columns if W=H=4 and 8 columns in all other cases. b is a vector of size W_{red}·H_{red}. The matrix A and the offset vector b are taken from one of the three sets S₀, S₁, S₂; the set S_{idx} is chosen where the index idx=idx(W,H) is derived as follows:

$$idx ( W , H ) = \{ \begin{matrix}0 & for W = H = 4 \\ 1 & for max ( W , H ) = 8 \\ 2 & for max ( W , H ) > 8.\end{matrix} \qquad ( 4 )$$

The matrices and offset vectors that are needed to generate the prediction signal are taken from three sets S₀, S₁, S₂ of matrices and vectors. The set S₀ consists of 18 matrices A₀ⁱ, i∈{0, . . . , 17} each of which has 16 rows and 4 columns and 18 offset vectors b₀ⁱ, i∈{0, . . . , 17} each of size 16. Matrices and offset vectors of that set are used for blocks of size 4×4. The set S₁ consists of 10 matrices A₁ⁱ, i∈{0, . . . , 9}, each of which has 16 rows and 8 columns and 10 offset vectors b₂ⁱ, i∈{0, . . . , 9} each of size 16. Matrices and offset vectors of that set are used for blocks of sizes 4×8, 8×4 and 8×8. Finally, the set S₂ consists of 6 matrices A₂ⁱ, i∈{0, . . . , 5}, each of which has 64 rows and 7 columns and of 6 offset vectors b₂ⁱ, i∈{0, . . . , 5} of size 64.

The prediction signal at the remaining positions is generated from the prediction signal on the subsampled set by linear interpolation which is a single step linear interpolation in each direction.

Signaling of MIP mode and prediction mode: A flag specifying whether the MIP mode is used is signaled in the bitstream by the encoder for each Coding Unit (CU). If an MIP mode is to be applied, a Most Probable Mode (MPM) flag is signaled to indicate whether prediction mode is one of the MIP MPM modes or not. In MIP, 3 modes are considered for MPM and MPM mode indices are context coded with truncated binarization. Non-MPM mode indices are coded as fixed length code (FLC). The derivation of the MPMs is harmonized with conventional intra prediction mode by performing mode mapping between conventional intra prediction mode and MIP intra prediction mode based on predefined mapping tables which depend on block size (i.e., idx(W,H)∈{0,1,2}). The following are forward (convention mode to MIP mode) and inverse (MIP mode to conventional mode) mode mapping tables.

predmode_{ALWIP}=map_angular_to_alwip_{idx}[predmode_{Angular}] (5)

predmode_{Angular}=map_alwip_to_angular_{idx(PU)}[predmode_{ALWIP}] (6)

The number of supported MIP modes depends on block size. For example, 35 modes are available for blocks where max(W,H)<=8 && W*H<32. And 19 and 11 modes are used for max(W,H)=8 and max(W,H)>8, respectively. In addition, two modes share the same matrix and offset vector to reduce the memory requirement as follows:

$$m = \{ \begin{matrix}mode & for W = H = 4 and mode < 18 \\ mode - 17 & for W = H = 4 and mode \geq 18 \\ mode & for max ( W , H ) = 8 and mode < 10 \\ mode - 9 & for max ( W , H ) = 8 and mode \geq 10 \\ mode & for max ( W , H ) > 8 and mode < 6 \\ mode - 5 & for max ( W , H ) > 8 and mode \geq 6. \end{matrix} \qquad ( 7 )$$

MIP Simplifications in VVC Draft Version 6

VVC Draft 6 includes an 8-bit version of MIP that has less storage requirements and complexity. The enhancements are described in JVET-00925 and modifications are the following:
MIP parameters are in 8-bit precision.
The reference sample derivation for MIP is performed exactly as for the conventional intra prediction modes.
For the upsampling step used in the MIP-prediction, original boundary reference samples are used instead of downsampled ones.
The extra handling of negative values is removed from the upsampling.
Clipping is performed before upsampling and not after upsampling.
The mapping tables from MIP modes to conventional intra prediction modes are removed. Instead, MIP modes are always mapped to the planar mode.
For the coding of the MIP-modes, the MIP-MPMs are no longer used and the mapping from conventional intra prediction modes to MIP modes is removed. Instead, the MIP modes are coded using truncated binary code.

In the adopted MIP version, the prediction process is defined as described below. For predicting the samples of a rectangular block of width W and height H, MIP takes one line of H reconstructed neighbouring boundary samples left of the block and one line of W reconstructed neighbouring boundary samples above the block as input. Out of these boundary samples, the reduced boundary vector bdry_{red} is obtained by averaging exactly as described in Section 1.2 of JVET-N0217. Thus, bdry_{red} is of size size(bdry_{red})=4, if W=H=4 and of size size(bdry_{red})=8, else.

Next, putting

$$idx ( W , H ) = \{ \begin{matrix}0 & for W = H = 4 \\ 1 & for max ( W , H ) = 8 \\ 2 & for max ( W , H ) > 8 ,\end{matrix} \qquad ( 8 )$$

one defines the reduced input vector input_{red} as:

input_{red}[0]=bdry_{red}[0]−(1<<(bitDepth−1)), (9)

input_{red}[j]=bdry_{red}[j]−bdry_{red}[0], j=1, . . . ,size(bdry_{red})−1, (10)

if idx(W,H)=0 or idx(W,H)=1 and as,

input_{red}[j]=bdry_{red}[j+1]−bdry_{red}[0], j=0, . . . ,size(bdry_{red})−2, (11)

if idx(W,H)=2.

Here, bitDepth denotes the luma bit-depth. Thus, the size of input_{red}, inSize, is equal to size(bdry_{red}) for idx(W,H)=0 or idx(W,H)=1 and equal to size(bdry_{red})−1, if idx(W,H)=2. Exactly as in Section 1.3 of JVET-N0217, determined by the MIP-mode, a matrix A is selected. Thus, the matrix A belongs to one of three sets S₀, S₁, S₂ of matrices or is a matrix that belongs to the set S₂ with some columns left out. The set S₀ consists of 18 matrices A₀ⁱ, i∈{0, . . . , 17} each of which has 16 rows and 4 columns. Matrices of that set are used if idx(W,H)=0, i.e., for blocks of size 4×4. The set S₁ consists of 10 matrices A₁ⁱ, i∈{0, . . . , 9}, each of which has 16 rows and 8 columns. Matrices of that set are used if idx(W,H)=1, i.e., for blocks of sizes 4×8, 8×4 and 8×8. Finally, the set S₂ consists of 6 matrices A₂ⁱ, i∈{0, . . . , 5}, each of which has 64 rows and 7 columns. Matrices of that set or parts of these matrices are used idx(W,H)=2, i.e., for all other block-shapes. All entries of the matrices belonging to the sets S₀, S₁ and S₂ are stored in 7 bits as unsigned 7-bit numbers. Also, the factors fW are stored as 7-bit numbers.

If W_{red} and H_{red} denote the width and the height of the reduced prediction signal and if sW is the shift corresponding to the prediction mode, it is proposed to compute the reduced prediction signal pred_{red} as

pred_{red}[i]=(((Σⱼ₌₀^{inSize}(A[i][j]−fW)·input_{red}[j])+(1<<(sW−1)))>>sW)+bdry_{red}[0] (12)

where i∈{0, . . . , W_{red}·H_{red}−1}. The differences (A[i][j]−fW) can be stored in 8-bit precision. Using sW in the manner may allow the video coder to perform integer multiplication instead of floating-point multiplication.

One of the major drawbacks of MIP is the considerable memory requirement to store the matrix weights. To address this issue, several proposals have been submitted to the JVET standardization committee.

For example, approaches described in M. Salehifar, S. Kim (LGE), “CE3 Related: Low Memory and Computational Complexity Matrix Based Intra Prediction (MIP)”, 15^{th} JVET Meeting, Gothenburg, Sweden, July 2019, JVET-00139; C.-H. Yau, C.-C. Lin, C.-L. Lin (ITRI), “Non-CE3: MIP simplification”, 15^{th} JVET Meeting, Gothenburg, Sweden, July 2019, JVET-00345; and C. Rosewarne, J. Gan (Canon), “Non-CE3: MIP mode simplifications”, 15^{th} JVET Meeting, Gothenburg, Sweden, July 2019, JVET-00401 consist of disabling MIP mode for small blocks (4×4) and/or medium blocks (4×8, 8×8 and 8×4) to reduce storage. J. Choi, J. Heo, J. Lim, S. Kim (LGE), “Non-CE3: MIP mode reduction”, 15^{th} JVET Meeting, Gothenburg, Sweden, July 2019, JVET-00397 described reducing storage by selecting subsets of MIP matrices for each MIP mode. More specifically, a subset S₀ is defined that includes MIP matrices for blocks of size 4×4; a subset S₁ is defined that includes MIP matrices for blocks of size 8×8; and a subset S₂ is defined that includes MIP matrices for blocks of sizes greater than 8×8. This approach is simple and efficient in terms of storage reduction. Although these approaches show limited impact in typical bitrates, it may be problematic for high-bitrate use-cases where pictures are split further and where encoders use a lot of small blocks.

Y. Yasugi, T. Ikai (Sharp), “Non-CE3: MIP simplification”, 15th JVET Meeting, Gothenburg, Sweden, July 2019, JVET-00621 (hereinafter, “JVET-00621”) proposed to remove some of the largest MIP matrices and to derive other MIP matrices with linear combinations. However, the approach described in JVET-00621 introduces additional complexity since it requires interpolation to be performed for each weight in the derived matrices. The approach described in JVET-00621 may also not reduce the storage depending on how this approach is implemented. In the case of on-the-fly implementation, additional storage is not required as weights would be computed for each predicted sample. In case of precomputed weights, storage saving would be null.

MIP, as specified in VVC Draft 6, requires significant storage requirements despite efforts to reduce the storage from earlier versions. It has been noticed in the literature that removing MIP matrices without adding new modes can be harmful in terms of performance because doing so may degrade VVC efficiency in high bitrate applications.

A solution has been proposed to remove storage while keeping the same number of MIP modes, as described in JVET-00621. However, this approach has two drawbacks. First, the approach of JVET-00621 requires additional complexity because the approach of JVET-00621 requires computation of weights. Second, storage saving can be nil or negligible depending on the implementation. On-the-fly computation of weights would reduce storage requirements; however, this could reduce the throughput because the weights would be computed per predicted sample. A practical implementation would pre-compute the MIP weights and store them in the local memory for fast access, which does not reduce storage.

From the literature, it appears that there is a storage problem to solve regarding MIP implementation. It may be desirable to reduce storage with minimal impact on the coding efficiency; it may also be desirable to maintain a similar diversity of MIP matrices. The techniques of this disclosure address these problems and may overcome limitations of previously described solutions.

As described herein, video encoder 200 may determine and signal a MIP mode syntax element and a transpose flag when video encoder 200 encodes a block of video data using MIP. The MIP mode syntax element indicates a MIP mode index for the current block. The MIP mode index may correspond to a MIP matrix in a set of MIP matrices that corresponds to a size of the block. The transpose flag indicates whether an input vector produced as part of coding the block using MIP is transposed. In this disclosure, transposing the input vector comprises changing an order in which the top boundary pixel values and the left boundary pixel values are concatenated to determine the input vector. In other words, an order in which top boundary pixel values and left boundary pixel values are concatenated to each other is dependent on whether the input vector is transposed. The neighboring samples of the current block include the top boundary pixel values and the left boundary pixel values. For instance, transposing the input vector may correspond to concatenating the top boundary pixel values and the left boundary pixel values instead of vice versa. Transposing the input vector may effectively double the possibilities of how the input vector may be combined with a set of MIP matrices. Because of the increased number of possibilities, video encoder 200 may be able to select a combination of MIP matrix and transposed/non-transposed input vector that may otherwise not be available without signaling of the transpose flag. Thus, coding efficiency may be increased without increasing storage requirements associated with more MIP matrices.

Thus, in accordance with one or more techniques of this disclosure, video encoder 200 may store a plurality of MIP matrices. Video encoder 200 may determine an input vector (e.g., bdry_{red} 156 of FIG. 2) based on neighboring samples 158 for a current block of the video data. Video encoder 200 may determine a selected MIP matrix from the stored plurality of MIP matrices, based on, e.g., a rate-distortion optimization process. Video encoder 200 may determine the input vector such that the input vector is transposed or not transposed, e.g., based on a rate-distortion optimization process. Furthermore, video encoder 200 may signal, in a bitstream that includes an encoded representation of the video data, a MIP mode syntax element indicating a MIP mode index for the current block. Video encoder 200 may also signal, in the bitstream, a transpose flag that indicates whether the input vector is transposed. Video encoder 200 may determine a prediction signal (e.g., pred_{red} 160 of FIG. 2). As part of determining the prediction signal, video encoder 200 may multiply the determined MIP matrix (e.g., Aₖ) by the input vector. In some examples, video encoder 200 may then add an offset vector (e.g., bₖ). The prediction signal includes values corresponding to a first set of locations in a prediction block for the current block. In the example of FIG. 2, the first set of locations are shown in intermediate prediction block 161 as shaded squares inside intermediate prediction block 161. The determined MIP matrix may be in the plurality of stored MIP matrices and the determined MIP matrix corresponds to the MIP mode index. Furthermore, video encoder 200 may apply an interpolation process (e.g., linear interpolation 154 in FIG. 2) to the prediction signal to determine values corresponding to a second set of locations in the prediction block (e.g., prediction block 162 of FIG. 2) for the current block. Video encoder 200 may generate residual samples for the current block based on differences between samples of the current block and corresponding samples of the prediction block for the current block.

Similarly, video decoder 300 may store a plurality of MIP matrices. Video decoder 300 may obtain, from a bitstream that includes an encoded representation of the video data, a MIP mode syntax element indicating a MIP mode index for the current block. Video decoder 300 may also obtain a transpose flag from the bitstream. Video decoder 300 may determine an input vector based on neighboring samples for the current block. The transpose flag indicates whether the input vector is transposed. Furthermore, video decoder 300 may determine a prediction signal (e.g., pred_{red} 160 of FIG. 2). As part of determining the prediction signal, video decoder 300 may multiply a MIP matrix (e.g., Aₖ) by the input vector. In some examples, video decoder 300 may determine the prediction signal by multiplying the MIP matrix (e.g., Aₖ) by the transposed input vector and adding an offset vector (e.g., bₖ). The prediction signal includes values corresponding to a first set of locations in a prediction block for the current block, the MIP matrix is one of the plurality of stored MIP matrices, and the MIP matrix corresponds to the MIP mode index. Video decoder 300 may apply an interpolation process (e.g., linear interpolation 154 in FIG. 2) to the prediction signal to determine values corresponding to a second set of locations in the prediction block (e.g., locations in prediction block 162 of FIG. 2 corresponding to the white squares in intermediate prediction block 161) for the current block. Furthermore, video decoder 300 may reconstruct the current block by adding samples of the prediction block for the current block to corresponding residual samples for the current block.

In accordance with some techniques of this disclosure, a video coder (e.g., video encoder 200 or video decoder 300) may derive a new MIP matrix based on one or more MIP matrices. In this example, the video coder may determine an input vector based on neighbor samples for a current block of the video data. Additionally, the video coder may determine a prediction signal by multiplying the new MIP matrix by the input vector and adding an offset vector. The prediction signal includes values corresponding to a first set of locations in a prediction block for the current block. Furthermore, the video coder may apply an interpolation process to the prediction signal to determine values corresponding to a second set of locations in the prediction block for the current block. The video coder may code the current block using the prediction block for the current block. Furthermore, in some examples, a flag is signaled in a bitstream that includes an encoded representation of the video data, wherein the flag indicates whether the input vector is transposed.

In some examples, the video coder may derive the new MIP matrix in accordance with one of the following modes: deriving the new MIP matrix by transposing the MIP matrix, deriving the new MIP matrix by swapping one column of the MIP matrix with another column of the MIP matrix, or deriving the new MIP matrix by swapping one row of the MIP matrix with another row of the MIP matrix.

In some examples, the MIP matrix is a first MIP matrix and the video coder may derive the new MIP matrix based on the first MIP matrix and a second MIP matrix. Furthermore, in some such examples, the video coder may derive the new MIP matrix based on a subset of columns of the first MIP matrix and a subset of columns of the second MIP matrix. In some examples, the video coder may derive the new MIP matrix based on a subset of rows of the first MIP matrix and a subset of rows of the second MIP matrix. In some such examples, the first MIP matrix and the second MIP matrix are not of a same size.

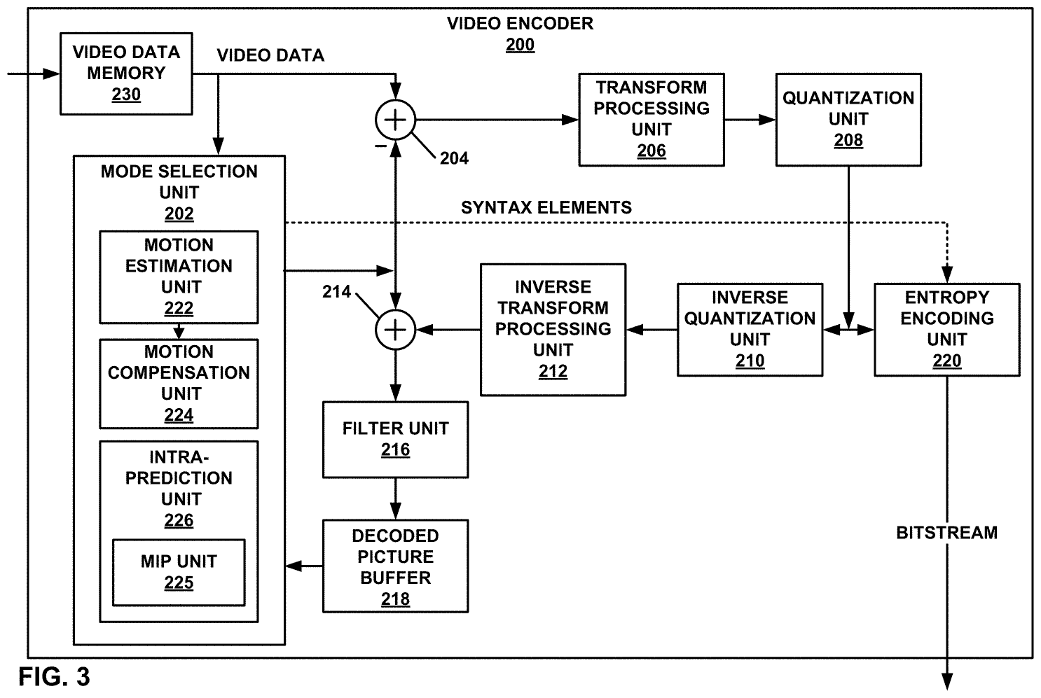

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 in the context of video coding standards such as the HEVC video coding standard and the VVC/H.266 video coding standard in development. However, the techniques of this disclosure are not limited to these video coding standards and are applicable generally to video encoding and decoding.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like. In the example of FIG. 3, intra-prediction unit 226 includes a MIP unit 225.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that define the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, if mode selection unit 202 makes a determination to perform intra prediction, intra-prediction unit 226 may use intra prediction to generate the prediction block from samples neighboring the current block. Intra-prediction unit 226 may use one of several different types of intra prediction modes to generate the prediction block. The intra prediction modes may include directional intra prediction modes, non-directional intra prediction modes, MIP modes, and so on. For directional intra prediction modes, intra-prediction unit 226 may generally mathematically combine values of neighboring samples and populate these calculated values in the defined direction across the current block to produce the prediction block. As another example, for DC mode (a non-directional intra prediction mode), intra-prediction unit 226 may calculate an average of the neighboring samples to the current block and generate the prediction block to include this resulting average for each sample of the prediction block. Planar mode is another example type of non-directional intra prediction mode. Mode selection unit 202 may evaluate the results of encoding the current block using two or more different intra prediction modes and may select the intra prediction mode that yields the best result, e.g., in terms of a rate-distortion metric.

MIP unit 225 of intra-prediction unit 226 may use a MIP mode to generate the prediction block. When encoding the current block, MIP unit 225 may generate prediction blocks using different MIP modes with and without transposing the input vector. Mode selection unit 202 may determine one of the MIP modes and determine whether or not to transpose the input vector based on results of encoding the current block using prediction blocks generated using the different MIP modes with and without transposing the input vector. In accordance with one or more techniques of this disclosure, for one or more MIP modes, MIP unit 225 may determine an input vector based on neighboring samples for a current block of the video data. In some instances, MIP unit 225 may determine the input vector such that the input vector is or is not transposed. MIP unit 225 may determine a prediction signal. Determining the prediction signal may include multiplying a MIP matrix by the input vector. The prediction signal includes values corresponding to a first set of locations in a prediction block for the current block, the determined MIP matrix is one of the plurality of stored MIP matrices, and the determined MIP matrix corresponds to the MIP mode index. Furthermore, MIP unit 225 may apply an interpolation process (e.g., linear interpolation 154 in FIG. 2) to the prediction signal to determine values corresponding to a second set of locations in the prediction block for the current block. Video encoder 200 may signal, in a bitstream, a MIP mode syntax element indicating a MIP mode index for the current block. Video encoder 200 may also signal, in the bitstream, a transpose flag that indicates whether the input vector is transposed and may also signal the MIP mode index corresponding to the determined MIP matrix.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PUs for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not context coded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and a reference picture for a luma coding block need not be repeated for identifying an MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

In some examples, video encoder 200 may represent an example of a device configured to encode video data including a memory configured to store video data, and one or more processing units implemented in circuitry and configured to derive a new MIP matrix based on a MIP matrix. In this example, the one or more processing units of video encoder 200 may determine an input vector based on neighbor samples for a current block of the video data. Additionally, the one or more processing units of video encoder 200 may determine a prediction signal by multiplying the new MIP matrix by the input vector and adding an offset vector. The prediction signal includes values corresponding to a first set of locations in a prediction block for the current block. Furthermore, the one or more processing units of video encoder 200 may apply an interpolation process to the prediction signal to determine values corresponding to a second set of locations in the prediction block for the current block. The one or more processing units of video encoder 200 may encode the current block using the prediction block for the current block. For instance, the one or more processing units of video encoder 200 may generate residual samples for the current block based on differences between samples of the current block and corresponding samples of the prediction block for the current block.

Furthermore, in some examples, video encoder 200 may represent an example of a device configured to encode video data including a memory configured to store a plurality of MIP matrices; and one or more processors configured to determine an input vector based on neighboring samples for a current block of the video data; determine a MIP matrix from the plurality of stored MIP matrices; signal, in a bitstream that includes an encoded representation of the video data, a MIP mode syntax element indicating a MIP mode index for the current block; signal a transpose flag in the bitstream that indicates whether the input vector is transposed; determine a prediction signal, wherein determining the prediction signal includes multiplying the determined MIP matrix by the input vector, wherein the prediction signal includes values corresponding to a first set of locations in a prediction block for the current block, and the determined MIP matrix corresponds to the MIP mode index; apply an interpolation process to the prediction signal to determine values corresponding to a second set of locations in the prediction block for the current block; and generate residual samples for the current block based on differences between samples of the current block and corresponding samples of the prediction block for the current block.

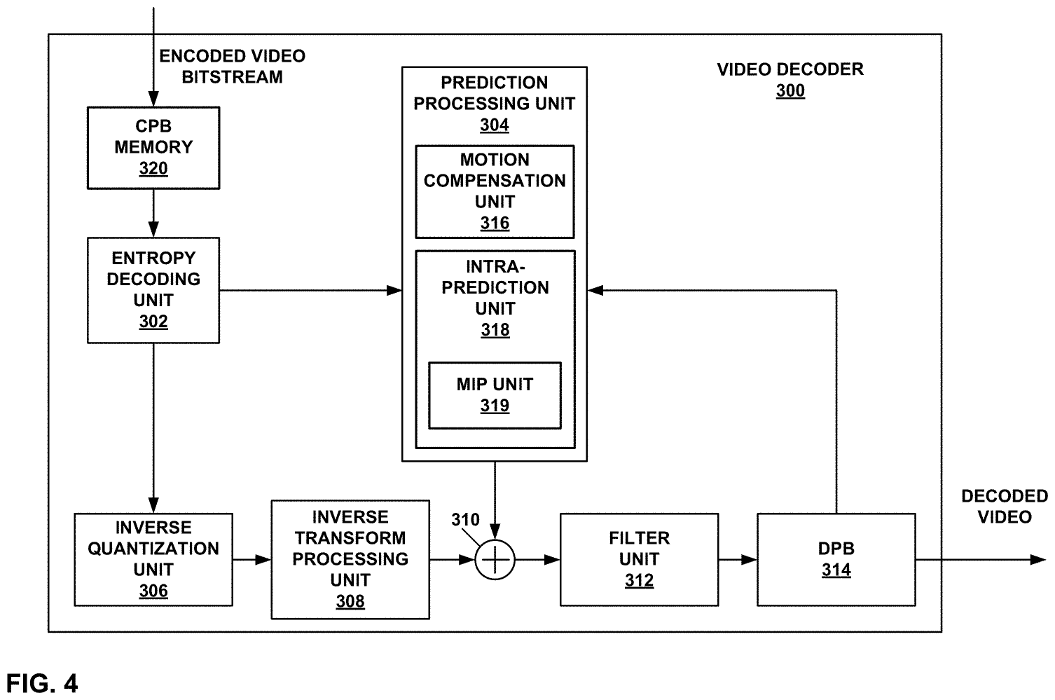

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of VVC, and HEVC. However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

In the example of FIG. 4, intra-prediction unit 318 may include a MIP unit 319 that may use a MIP mode to generate the prediction block. In accordance with one or more techniques of this disclosure, entropy decoding unit 302 may obtain, from the bitstream, a MIP mode syntax element indicating a MIP mode index for the current block. Additionally, entropy decoding unit 302 may obtain a transpose flag from the bitstream. MIP unit 319 may store a plurality of MIP matrices. MIP unit 319 may determine an input vector based on neighboring samples for a current block of the video data. The transpose flag indicates whether the input vector is transposed. Additionally, MIP unit 319 may determine a prediction signal. As part of determining the prediction signal, MIP unit 319 may multiply a MIP matrix by the input vector. For instance, in some examples, MIP unit 319 may determine the prediction signal by multiplying the MIP matrix by the input vector and adding an offset vector. The prediction signal may include values corresponding to a first set of locations in a prediction block for the current block. The MIP matrix is one of the plurality of stored MIP matrices. The MIP matrix corresponds to the MIP mode index. Furthermore, MIP unit 319 may apply an interpolation process to the prediction signal to determine values corresponding to a second set of locations in the prediction block for the current block.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 may represent an example of a video decoding device including a memory configured to store video data, and one or more processing units implemented in circuitry and configured to derive a new MIP matrix based on a MIP matrix. In this example, the one or more processing units of video decoder 300 may determine an input vector based on neighbor samples for a current block of the video data. Additionally, the one or more processing units of video decoder 300 may determine a prediction signal by multiplying the new MIP matrix by the input vector and adding an offset vector. The prediction signal includes values corresponding to a first set of locations in a prediction block for the current block. Furthermore, the one or more processing units of video decoder 300 may apply an interpolation process to the prediction signal to determine values corresponding to a second set of locations in the prediction block for the current block. The one or more processing units of video decoder 300 may encode the current block using the prediction block for the current block. For instance, the one or more processing units of video decoder 300 may generate residual samples for the current block based on differences between samples of the current block and corresponding samples of the prediction block for the current block.

In some examples, video decoder 300 may represent an example of a video decoding device including a memory configured to store video data, and one or more processing units implemented in circuitry and configured to store a plurality of MIP matrices; obtain, from a bitstream that includes an encoded representation of the video data, a MIP mode syntax element indicating a MIP mode index for a current block of the video data; obtain a transpose flag from the bitstream; determine an input vector based on neighboring samples for the current block, wherein the transpose flag indicates whether the input vector is transposed; determine a prediction signal, wherein determining the prediction signal may include multiplying a MIP matrix by the input vector, wherein the prediction signal includes values corresponding to a first set of locations in a prediction block for the current block, the MIP matrix is one of the plurality of stored MIP matrices, and the MIP matrix corresponds to the MIP mode index; apply an interpolation process to the prediction signal to determine values corresponding to a second set of locations in the prediction block for the current block; and reconstruct the current block by adding samples of the prediction block for the current block to corresponding residual samples for the current block.

Video encoder 200 and video decoder 300 may be configured to perform the examples below independently or apply one or more of the methods of one or more of the examples together. In some cases, video encoder 200 and video decoder 300 may be configured to apply one or more methods of one or more of the examples more than once.

In accordance with an example of this disclosure, for all matrices specified for MIP, a transposed input vector may be enabled, with a dedicated flag to signal whether transposition is on/off. In other words, a transpose flag may be signaled in the bitstream, where the transpose flag indicates whether to transpose the input vector, such as bdry_{red} 156 of FIG. 2.

In accordance some examples of this disclosure, for each matrix specified for MIP, a video coder (e.g., video encoder 200 or video decoder 300) may derive one or more MIP modes by one or more operations either in succession or in parallel. For instance, a video coding standard may specify one or more of:
a. a MIP mode where a MIP matrix is used without any modification.
b. a MIP mode where the MIP matrix is transposed.
c. a MIP mode where a new MIP matrix is derived by swapping one column of a MIP matrix with another column of the MIP matrix.
d. a MIP mode where a new MIP matrix is derived by swapping one row of a MIP matrix with another row of the MIP matrix.

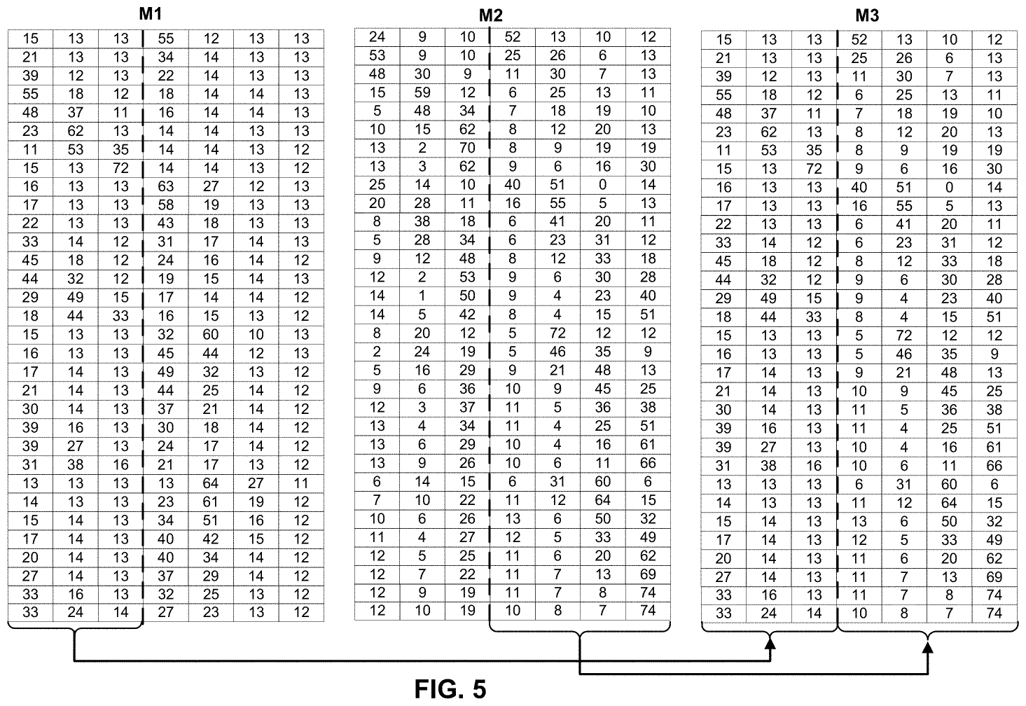

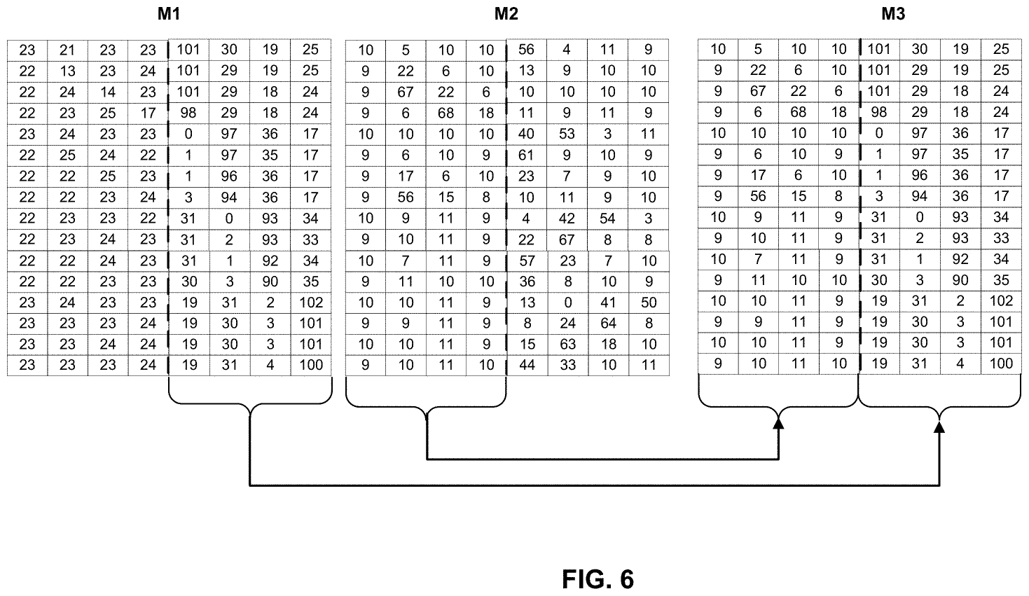

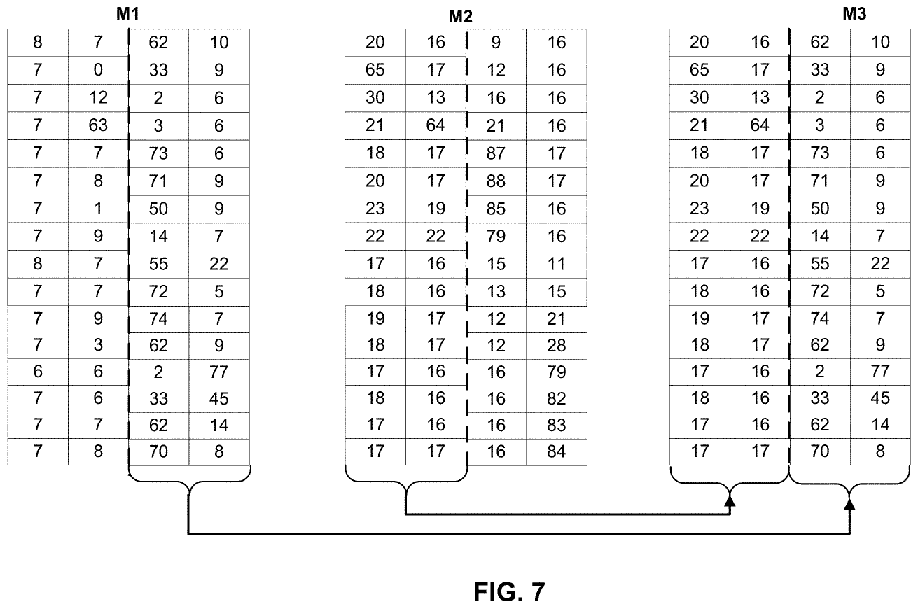

In accordance with some examples of this disclosure, for any two MIP matrices specified for MIP, a video coder (e.g., video encoder 200 or video decoder 300) may derive one or more MIP modes by performing one or more operations either in succession or in parallel on the two MIP matrices. For example, for two MIP matrices M1 and M2, the video coder may obtain a new MIP matrix/mode M3 by choosing N−N1 columns from M1 and N1 columns from M2, where N is the desired number of columns for M3. For instance, in this example, the video coder may obtain the new MIP matrix/mode M3 based on one of the following:
i. N=7, N1=4: (See FIG. 5)
ii. N=8, N1=4: (See FIG. 6)
iii. N=4, N1=2: (See FIG. 7)

FIG. 5 is a conceptual diagram illustrating an example column combination with N=7 and N1=4, in accordance with one or more aspects of this disclosure. FIG. 6 is a conceptual diagram illustrating an example column combination with N=8 and N1=4, in accordance with one or more aspects of this disclosure. FIG. 7 is a conceptual diagram illustrating an example column combination with N=4 and N1=2, in accordance with one or more aspects of this disclosure.

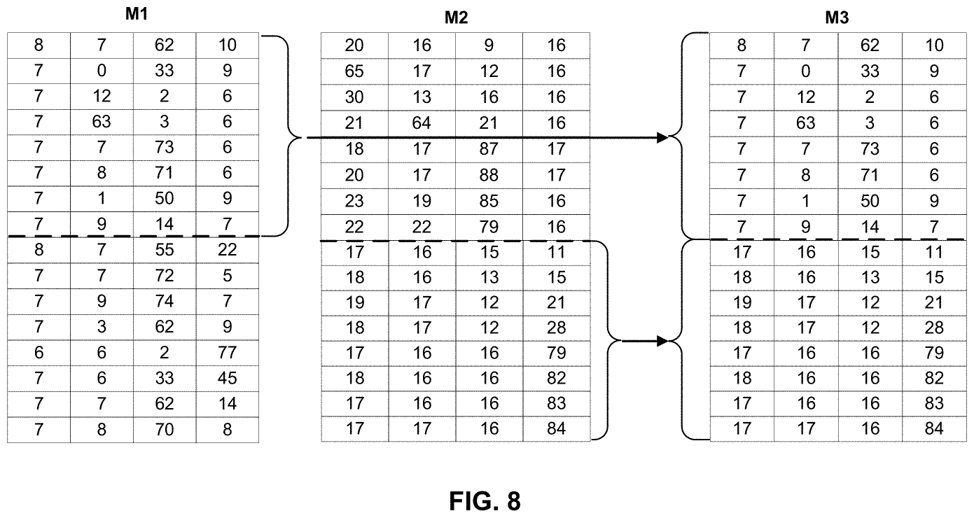

In some examples, for two MIP matrices M1 and M2, the video coder may obtain a new MIP matrix/mode M3 by choosing K1 rows from a MIP matrix M1 and K−K1 rows from a MIP matrix M2, where K is the desired number of rows for M1. For instance, in this example, the video coder may obtain the new MIP matrix/mode M3 based on the following:
i. K=16, K1=8: (See FIG. 8)
   FIG. 8 is a conceptual diagram illustrating an example row combination with K=16 and K1=8, in accordance with one or more aspects of this disclosure.

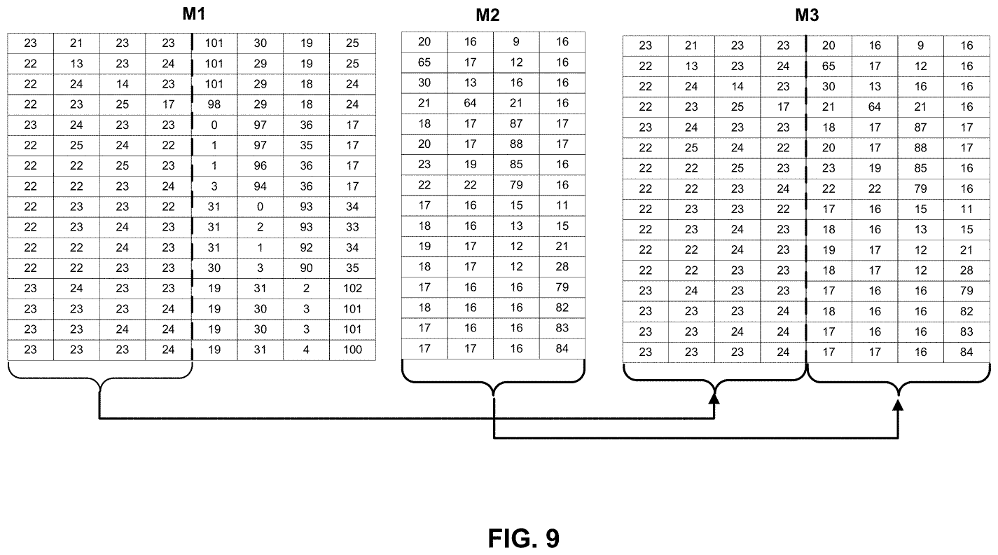

In some examples, when MIP matrix M1 and MIP matrix M2 are not of the same size, the video coder may modify one or both of M1 and M2 such that M1 16×8, M2 16×4, M3 16×8, e.g., as shown in FIG. 9. FIG. 9 is a conceptual diagram illustrating an example column combination of matrices having different sizes, in accordance with one or more aspects of this disclosure.

In some examples, a video coder (e.g., video encoder 200 or video decoder 300) may also apply one or more of the operations specified above on MIP matrices to the samples on which the MIP matrices are applied. For example, the video coder may swap one or more samples in reduced boundary samples (e.g., bdry_{red} 156 of FIG. 2) with other reduced boundary samples.

Although the description of the above examples is described with the design of MIP described in VVC Draft 6, the techniques of this disclosure may also apply to other MIP designs. For example, a video coder may apply MIP matrices to boundary samples without first down-sampling/reducing the boundary samples.

In some examples, an offset vector may also be present for the MIP, and one or more methods described above may also be applied on the offset vectors.

### MIP Symmetry Harmonization

It is observed in the section entitled, “Signaling of MIP mode and prediction mode” above that MIP proposes a transposed mode where the reduced boundary vector is swapped, which may enable video coders to add more diversity for a given number of MIP matrices since each MIP matrix can be used in two different ways. However, it is also noticed that this symmetric property is only enabled for MIP modes with mode indices greater than 0. In other words, the first MIP matrix (mode index 0) can only be used with non-swapped input vector. The symmetric property means a transpose of the input vector (swapping of top neighboring row and left neighboring column). This limits the diversity of the MIP matrices.

This disclosure describes extending the MIP transposition to all MIP matrices in order to allow more diversity and coding efficiency relative to the MIP design of VVC Draft 6. In relation with description of MIP mode in VVC Draft 6 (and reproduced elsewhere in this disclosure), the MIP mode derivation and input vector generation processes may be modified as follows. Throughout this disclosure, <i> . . . </i> tags indicate inserted text and <d> . . . </d> tags indicate deleted text.

$$m = \{ \begin{matrix}mode & for W = H = 4 and mode < 18 \\ mode - < i > 18 < \text{/} i > < d > 17 < \text{/} d > & for W = H = 4 and mode \geq 18 \\ mode & for max ( W , H ) = 8 and mode < 10 \\ mode - < i > 10 < \text{/} i > < d > 9 < \text{/} d > & for max ( W , H ) = 8 and mode \geq 10 \\ mode & for max ( W , H ) > 8 and mode < 6 \\ mode - < i > 6 < \text{/} i > < d > 5 < \text{/} d > & for max ( W , H ) > 8 and mode \geq 6. \end{matrix}$$

In the equation above, mode denotes the MIP mode index, W indicates a width of the block, H indicates a height of the block. With respect to the equation above, there may be a first plurality of MIP matrices for blocks with W=H=4; a second plurality of MIP matrices for blocks with W=H=8; and a third plurality of MIP matrices for blocks with a maximum of the width or height greater than 8 (i.e., max(W,H)>8). In accordance with a technique of this disclosure, when the width and height of the block are equal to 4 and mode is greater than or equal to 18, the video coder may use a transpose of the MIP matrix (in a set of MIP matrices for W=H=4) having a MIP mode index equal to mode minus 18. When the width and height of the block are equal to 8 and mode is greater than or equal to 10, the video coder may use a transpose of the MIP matrix (in a set of MIP matrices for W=H=8) having a MIP mode index equal to mode minus 10. The effect of this change is the increase of one MIP mode (due to being able to transpose the MIP matrix corresponding to MIP mode index 0), which a video coder can use for coding blocks without increase in storage requirements.

In some examples, video encoder 200 directly signals the transposition in the bitstream. This way, the MIP prediction process may be simplified because no logic is needed to handle the transposed input vector and mode derivation (e.g., as described with respect to the equation of the previous paragraph). The techniques of this disclosure may impact the VVC Draft 6 syntax because a new flag (i.e., a transpose flag) may be added, e.g., as shown in the table below:

| | | |
|---|---|---|
| | if( sps_mip_enabled_flag && | |
| | ( Abs( Log2( cbWidth ) − | |
| | Log2( cbHeight ) ) <= 2 ) | |
| | && cbWidth <= MaxTbSizeY && | |
| | cbHeight <= MaxTbSizeY ) | |
| | intra_mip_flag[ x0 ][ y0 ] | ae(v) |
| | if( intra_mip_flag[ x0 ][ y0 ] ) | |
| <i> | intra_mip_transposed[ x0 ][ y0 ]</i> | <i>ae(v)</i> |
| | intra_mip_mode[ x0 ][ y0 ] | ae(v) |

Furthermore, the techniques of this disclosure may involve the following semantic changes to section 7.4.9.5 of VVC Draft 6:

intra_mip_flag[x0][y0] equal to 1 specifies that the intra prediction type for luma samples is matrix-based intra prediction. intra_mip_flag[x0][y0] equal to 0 specifies that the intra prediction type for luma samples is not matrix-based intra prediction. When intra_mip_flag[x0][y0] is not present, it is inferred to be equal to 0.

<i>intra_mip_transposed[x0][y0] specifies whether the input vector for matrix-based intra prediction mode for luma samples is transposed or not.</i>

intra_mip_mode[x0][y0] specifies the matrix-based intra prediction mode for luma samples. The array indices x0, y0 specify the location (x0, y0) of the top-left luma sample of the considered coding block relative to the top-left luma sample of the picture.

The transpose flag value may be transmitted to the decoding process as follows (section 8.4.1 of VVC Draft 6):

2. The luma intra prediction mode is derived as follows:
If intra_mip_flag[xCb][yCb] is equal to 1, IntraPredModeY[x][y] with x=xCb . . . xCb+cbWidth−1 and y=yCb . . . yCb+cbHeight−1 is set to be equal to intra_mip_mode[xCb][yCb]<i> and isTransposed is set equal to intra_mip_transposed[xCb][yCb].</i>

The Matrix-based intra sample prediction process may be changed in section 8.4.5.2 of VVC Draft 6:

Inputs to this process are:
a sample location (xTbCmp, yTbCmp) specifying the top-left sample of the current transform block relative to the top-left sample of the current picture,
a variable predModeIntra specifying the intra prediction mode,
<i>a variable isTransposed specifying the required input reference vector order,</i>
a variable nTbW specifying the transform block width,
a variable nTbH specifying the transform block height.
   Outputs of this process are the predicted samples predSamples[x][y], with x=0 . . . nTbW−1, y=0 . . . nTbH−1.
   Variables numModes, boundarySize, predW, predH and predC are derived using MipSizeId[xTbCmp][yTbCmp] as specified in Table 8-4.

TABLE 8-4
Specification of number of prediction modes numModes, boundary size
boundarySize, and prediction sizes predW, predH and predC using MipSizeId

| MipSizeId | numModes | boundarySize | predW | predH | predC |
|---|---|---|---|---|---|
| 0 | <d>35</d><i>36</i> | 2 | 4 | 4 | 4 |
| 1 | <d>19</d><i>20</i> | 4 | 4 | 4 | 4 |
| 2 | <d>11</d><i>12</i> | 4 | Min( nTbW, 8 ) | Min( nTbH, 8 ) | 8 |

<d> The flag isTransposed is derived as follows:

isTransposed=(predModeIntra>(numModes/2))?TRUE:FALSE (8-55)</d>

The variable inSize is derived as follows:

inSize=(2*boundary Size)−(MipSizeId[xTbCmp][yTbCmp]==2)?1:0 (8-56)

The variables mipW and mipH are derived as follows:

mipW=isTransposed?predH:predW (8-57)

mipH=isTransposed?predW:predH (8-58)

For the generation of the reference samples refT[x] with x=0 . . . nTbW−1 and refL[y] with y=0 . . . nTbH−1, the following applies:
The reference sample availability marking process as specified in clause 8.4.5.2.7 is invoked with the sample location (xTbCmp, yTbCmp), reference line index equal to 0, the reference sample width nTbW, the reference sample height nTbH, colour component index equal to 0 as inputs, and the reference samples refUnfilt[x][y] with x=−1, y=−1 . . . nTbH−1 and x=0 . . . nTbW−1, y=−1 as output.
When at least one sample refUnfilt[x][y] with x=−1, y=−1 . . . nTbH−1 and x=0 . . . nTbW−1, y=−1 is marked as “not available for intra prediction”, the reference sample substitution process as specified in clause 8.4.5.2.8 is invoked with reference line index 0, the reference sample width nTbW, the reference sample height nTbH, the reference samples refUnfilt[x][y] with x=−1, y=−1 . . . nTbH−1 and x=0 . . . nTbW−1, y=−1, and colour component index 0 as inputs, and the modified reference samples refUnfilt[x][y] with x=−1, y=−1 . . . nTbH−1 and x=0 . . . nTbW−1, y=−1 as output.
The reference samples refT[x] with x=0 . . . nTbW−1 and refL[y] with y=0 . . . nTbH−1 are assigned as follows:

refT[x]=refUnfilt[x][−1] (8-59)

refL[y]=refUnfilt[−1][y] (8-60)

For the generation of the input samples p[x] with x=0 . . . 2*inSize−1, the following applies:
The MIP boundary downsampling process as specified in clause 8.4.5.2.2 is invoked for the top reference samples with the block size nTbW, the reference samples refT[x] with x=0 . . . nTbW−1, and the boundary size boundarySize as inputs, and reduced boundary samples redT[x] with x=0 . . . boundarySize−1 as outputs.
The MIP boundary downsampling process as specified in clause 8.4.5.2.2 is invoked for the left reference samples with the block size nTbH, the reference samples refL[y] with y=0 . . . nTbH−1, and the boundary size boundarySize as inputs, and reduced boundary samples redL[x] with x=0 . . . boundarySize−1 as outputs.
The reduced top and left boundary samples redT and redL are assigned to the boundary sample array pTemp[x] with x=0 . . . 2*boundarySize−1 as follows:
   If isTransposed is equal to 1, pTemp[x] is set equal to redL[x] with x=0 . . . boundarySize−1 and pTemp[x+boundarySize] is set equal to redT[x] with x=0 . . . boundarySize−1.
   Otherwise, pTemp[x] is set equal to redT[x] with x=0 . . . boundarySize−1 and pTemp[x+boundarySize] is set equal to redL[x] with x=0 . . . boundarySize−1.
The input values p[x] with x=0 . . . inSize−1 are derived as follows:
   If MipSizeId[xTbCmp][yTbCmp] is equal to 2, the following applies:

p[x]=pTemp[x+1]−pTemp[0] (8-61)
Otherwise (MipSizeId[xTbCmp][yTbCmp] is less than 2), the following applies:

p[0]=pTemp[0]−(1<<(BitDepth_{Y}−1))

p[x]=pTemp[x]−pTemp[0] for x=1 . . . inSize−1 (8-62)

. . .

For the intra sample prediction process according to predModeIntra, the following ordered steps may apply:
1. The matrix-based intra prediction samples predMip[x][y], with x=0 . . . mipW−1, y=0 . . . mipH−1 are derived as follows:
   <i> The variable modeId is set equal to predModeIntra </i>
   <d> The variable modeId is derived as follows:

modeId=predModeIntra−(isTransposed?numModes/2:0) (8-63)</d>
The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.

Additionally, the binarization may be impacted. The newly introduced flag (e.g., intra_mip_transposed) may be bypass coded, and the length of truncated binary codes used for mode index may be reduced in Tables 9.77 and 9.82 of VVC Draft 6:

| coding_unit( ) | cu_skip_flag[ ][ ] | FL | cMax = 1 | | | |
|---|---|---|---|---|---|---|
| | pred_mode_ibc_flag | FL | cMax = 1 | | | |
| | pred_mode_plt_flag | FL | cMax = 1 | | | |
| | pred_mode_flag | FL | cMax = 1 | | | |
| | intra_bdpcm_flag | FL | cMax = 1 | | | |
| | intra_bdpcm_dir_flag | FL | cMax = 1 | | | |
| | intra_mip_flag[ ][ ] | FL | cMax = 1 | | | |
| | <i>intra_mip_transposed | <i> | <i>cMax = 1</i> | | | |
| | [ ][ ]</i> | FL | | | | |
| | | <i> | | | | |
| | intra_mip_mode[ ][ ] | TB | cMax = (cbWidth = = 4 && cbHeight = = | | | |
| | | | 4) ? <d>34</d><i>35</i>: ( (cbWidth <= 8 | | | |
| | | | && cbHeight <= 8) ? <d>18</d><i>19</i>: | | | |
| | | | <d>10</d><i>11</i>) | | | |
| | intra_luma_ref_idx[ ][ ] | TR | cMax = 2, cRiceParam = 0 | | | |
| intra_mip_flag[ ][ ] | (Abs( Log2(cbWidth) - | na | na | na | na | na |
| | Log2(cbHeight) ) | | | | | |
| | > 1) ? | | | | | |
| | 3 : ( 0,1,2 | | | | | |
| | (clause 9.3.4.2.2) ) | | | | | |
| <i>intra_mip_transposed | <i>bypass</i> | <i> | <i> | <i> | <i> | <i> |
| [ ][ ]<i> | | bypass | bypass | bypass | bypass | bypass |
| | | </i> | </i> | </i> | </i> | </i> |
| intra_mip_mode[ ][ ] | bypass | bypass | bypass | bypass | bypass | bypass |

In a second example implementation, matrix sets are reduced to take advantage of the proposed signaling. Using 4 MIP matrices per set with full symmetry leads to use fixed-length coding. The impact on VVC Draft 6 is described below. The Matrix-based intra sample prediction process may be changed in section 8.4.5.2 of VVC Draft 6 as shown below:

Inputs to this process are:
a sample location (xTbCmp, yTbCmp) specifying the top-left sample of the current transform block relative to the top-left sample of the current picture, a variable predModeIntra specifying the intra prediction mode,
<i>a variable isTransposed specifying the required input reference vector order,</i>
a variable nTbW specifying the transform block width,
a variable nTbH specifying the transform block height.
   Outputs of this process are the predicted samples predSamples[x][y], with x=0 . . . nTbW−1, y=0 . . . nTbH−1.
   Variables numModes, boundarySize, predW, predH and predC are derived using MipSizeId[xTbCmp][yTbCmp] as specified in Table 8-4.

TABLE 8-4
Specification of number of prediction modes numModes, boundary size
boundarySize, and prediction sizes predW, predH and predC using MipSizeId

| MipSizeId | numModes | boundarySize | predW | predH | predC |
|---|---|---|---|---|---|
| 0 | <d>35</d><i>8</i> | 2 | 4 | 4 | 4 |
| 1 | <d>19</d><i>8</i> | 4 | 4 | 4 | 4 |
| 2 | <d>11</d><i>8</i> | 4 | Min( nTbW, 8 ) | Min( nTbH, 8 ) | 8 |

<d>The flag isTransposed is derived as follows:

isTransposed=(predModeIntra>(numModes/2))?TRUE:FALSE (8-55)</d>

. . .

For the intra sample prediction process according to predModeIntra, the following ordered steps may apply:
2. The matrix-based intra prediction samples predMip[x][y], with x=0 . . . mipW−1, y=0 . . . mipH−1 are derived as follows:
   <i>The variable modeId is set equal to predModeIntra</i>
   <d>The variable modeId is derived as follows:

modeId=predModeIntra−(isTransposed?numModes/2:0) (8-63)</d>
The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.

The binarization may also be impacted. The newly introduced flag (e.g., intra_mip_transposed) may be bypass coded, and the length of truncated binary code used for mode index may be reduced (Tables 9.77 and 9.82 of VVC Draft 6):

| coding_unit( ) | cu_skip_flag[ ][ ] | FL | cMax = 1 | | | |
|---|---|---|---|---|---|---|
| | pred_mode_ibc_flag | FL | cMax = 1 | | | |
| | pred_mode_plt_flag | FL | cMax = 1 | | | |
| | pred_mode_flag | FL | cMax = 1 | | | |
| | intra_bdpcm_flag | FL | cMax = 1 | | | |
| | intra_bdpcm_dir_flag | FL | cMax = 1 | | | |
| | intra_mip_flag[ ][ ] | FL | cMax = 1 | | | |
| | <i>intra_mip_transposed | <i>FL</i> | <i>cMax = 1</i> | | | |
| | [ ][ ]</i> | | | | | |
| | intra_mip_mode[ ][ ] | <d>TB</d><i> | cMax = <i>2</i><d>cbHeight = = 4 | | | |
| | | FL</i> | && cbHeight = = 4) ? 34 : ( (cbWidth | | | |
| | | | <= 8 && cbHeight <= 8) ? 18 : | | | |
| | | | 10)</d> | | | |
| | intra_luma_ref_idx[ ][ ] | TR | cMax = 2, cRiceParam = 0 | | | |
| intra_mip_flag[ ][ ] | (Abs( Log2(cbWidth) - | na | na | na | na | na |
| | Log2(cbHeight) ) | | | | | |
| | > 1) ? | | | | | |
| | 3 : ( 0,1,2 | | | | | |
| | (clause 9.3.4.2.2) ) | | | | | |
| <i>intra_mip_transposed | <i>bypass</i> | <i> | <i> | <i> | <i> | <i> |
| [ ][ ]</i> | | bypass</i> | bypass</i> | bypass</i> | bypass<i> | bypass</i> |
| intra_mip_mode[ ][ ] | bypass | bypass | bypass | bypass | bypass | bypass |

Combined MIP Matrices

To further address the problem, this disclosure describes techniques that combine existing matrices to create new ones. In a first example, a video coder (e.g., video encoder 200 or video decoder 300) only stores a reduced set of MIP matrices. In relation with the description in the section entitled “MIP simplifications in VVC draft version 6,” the set of stored MIP matrices for subset S₂ is defined as A₂ⁱ, i∈{0, . . . , 3}, where only 4 matrices are stored instead of 6. In this disclosure, notation of the form Aₖ^{i,j} denotes sub-matrix j of MIP matrix i of subset Sₖ. Each matrix is defined as the concatenation of two sub-matrices:

A₂⁰=[A₂^{0,0}A₂^{0,1}]

A₂¹=[A₂^{1,0}A₂^{1,1}]

A₂²=[A₂^{2,0}A₂^{2,1}]

A₂³=[A₂^{3,0}A₂^{3,1}]

where A₂^{i,0} and A₂^{i,1} are respectively the sub-matrices that contain weights that are multiplied with a first and second part of the input vector (i.e., samples from top and left reduced boundaries, respectively). To keep the same diversity as the MIP method in VVC where 6 MIP matrices are stored, it is proposed in this disclosure to add additional MIP matrices that are combinations of stored MIP matrices. For example, as defined below:

A₂⁴=[A₂^{2,0},A₂^{3,1}]

A₂⁵=[A₂^{3,0},A₂^{2,1}]

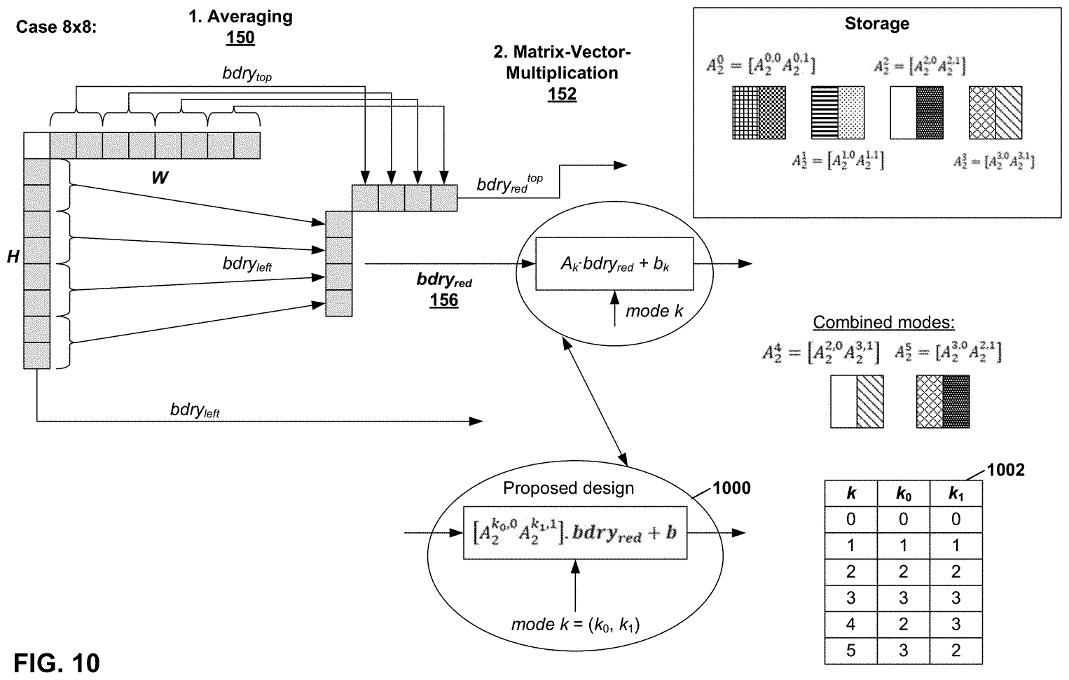

The techniques of this disclosure do not add more complexity because implementation may only require a read operation into the memory to get the weight values. An illustration of this example is provided in FIG. 10. FIG. 10 is a conceptual diagram illustrating combinations of MIP matrices in accordance with one or more techniques of this disclosure. In the example of FIG. 10, oval 1000 indicates that instead of using a single stored MIP matrix (denoted Aₖ in FIG. 10), a video coder may use a combination of rows or columns of stored MIP matrices to form a new MIP matrix, such as [A₂^{k}^{₀}^{,0}A₂^{k}^{₁}^{,1}].

As shown in table 1002 of FIG. 10, there may be four stored MIP matrices, the six MIP matrices for subset S₂ may be indexed by a value k, and the six MIP matrices for subset S₂ may be denoted A₂⁰, A₂¹, A₂², A₂³, A₂⁴, A₂⁵. The six MIP matrices for subset S₂ maybe formed by concatenating part of a first stored MIP matrix (the index of the first stored MIP matrix is denoted k₀) and part of a second stored MIP matrix (the index of the second stored MIP matrix is denoted k₁). For instance, the MIP matrix in subset S₂ with index k=5 may be formed by concatenating part of the stored MIP matrix with index k₀=3 and part of the stored MIP matrix with index k₁=2. Thus, table 1002 may be expanded as shown in the following table:

| K | K₀ | K₁ | A₂^{k}^{₀}^{,0} | A₂^{k}^{₁}^{,1} | A₂^{k} = [A₂^{k}^{₀}^{,0}, A₂^{k}^{₁}^{,1}] |
|---|---|---|---|---|---|
| 0 | 0 | 0 | A₂^{0,0} | A₂^{0,1} | A₂⁰ = [A₂^{0,0}, A₂^{0,1}] |
| 1 | 1 | 1 | A₂^{1,0} | A₂^{1,1} | A₂¹ = [A₂^{1,0}, A₂^{1,1}] |
| 2 | 2 | 2 | A₂^{2,0} | A₂^{2,1} | A₂² = [A₂^{2,0}, A₂^{2,1}] |
| 3 | 3 | 3 | A₂^{3,0} | A₂^{3,1} | A₂³ = [A₂^{3,0}, A₂^{3,1}] |
| 4 | 2 | 3 | A₂^{2,0} | A₂^{3,1} | A₂⁴ = [A₂^{2,0}, A₂^{3,1}] |
| 5 | 3 | 2 | A₂^{3,0} | A₂^{2,1} | A₂⁵ = [A₂^{3,0}, A₂^{2,1}] |

It is noted that to avoid combining MIP matrices having different offset values, weights of MIP matrices may be modified in a way that the offset values of the MIP matrices are aligned. Aligning the offset values refers to using the same offset value for different sub-MIP matrices when combining different sub-matrices to get the new MIP matrix. Equation (12), above, is translated in the VVC Draft 6 specification as follows:

The variables mipW and mipH are derived as follows:

mipW=isTransposed?predH:predW (8-57)

mipH=isTransposed?predW:predH (8-58)

. . .

oW=(1<<(sW−1))−sO*(Σᵢ₌₀^{inSize-1}p[i]) (8-64)

incW=(predC>mipW)?2:1 (8-65)

incH=(predC>mipH)?2:1 (8-66)

predMip[x][y]=(((Σᵢ₌₀^{inSize-1}mWeight[i][y*incH*predC+x*incW]*p[i])+oW)>>sW)+pTemp[0] (8-67)

In the equations above and elsewhere in this disclosure, sO is the offset value, sW indicates a shift weight, p[x] indicates the input samples, inSize is the input size, predH, predW, and predC are defined in Table 8-4 of VVC Draft 6, and mWeight is a weight matrix (i.e., a MIP matrix). In the case where MIP matrices with different offset values are combined, Equation (8-64) is no longer valid and the sum may be split into two parts, to separately handle each sub-matrix. This may add complexity to the specification text. One way to avoid this issue is to align the offset values of MIP matrices that are used in a combined way and to adjust weights. Accordingly, equation (8-67) may be reformulated for inSize=8 as follows:

$$predMip [ x ] [ y ] = ( ( {\sum }_{i = 0}^{7} mWeight [ i ] [ y * incH * predC + x * incW ] * p [ i ] - sO * {\sum }_{i = 0}^{7} p [ i ] + ( 1 \text{<<} ( sW - 1 ) ) ) \text{>>} sW ) + pTemp [ 0 ]$$

If it is considered that the prediction is achieved using two sub-matrices, the equation becomes:

$$predMip [ x ] [ y ] = ( ( {\sum }_{i = 0}^{3} ( mWeight 0 [ i ] [ y * incH * predC + x * incW ] - s {O}_{0} ) * p [ i ] + {\sum }_{i = 4}^{7} ( mWeight 1 [ i ] [ y * incH * predC + x * incW ] - {sO}_{1} ) * p [ i ] + ( 1 \text{<<} ( sW - 1 ) ) ) \text{>>} sW ) + pTemp [ 0 ]$$

To keep compact representation in the specification text, both sO₀ and sO₁ may be aligned, where sO₀ and sO₁ are offset values. Because the MIP matrices contain positive values that have 7-bit ranges, a video coder may perform alignment from a MIP matrix having the lowest offset value to the MIP matrix having the highest offset value, and the video coder may need to perform clipping if the updated weight is outside of the 7-bit range. For instance, in the case where sO₁>sO₀, the equation above can be written as:

$$predMip [ x ] [ y ] = ( ( {\sum }_{i = 0}^{3} ( ( mWeight 0 [ i ] [ y * incH * predC + x * incW ] - {sO}_{0} + {sO}_{1} ) - {sO}_{1} ) * p [ i ] + {\sum }_{i = 4}^{7} ( mWeight 1 [ i ] [ y * incH * predC + x * incW ] - {sO}_{1} ) * p [ i ] + ( 1 \text{<<} ( sW - 1 ) ) ) \text{>>} sW ) + pTemp [ 0 ]$$

$$mWeight {0}^{′} [ i ] [ j ] = {Clip}_{7 bit} ( mWeight 0 [ i ] [ j ] + ( {sO}_{1} - {sO}_{0} ) )$$

Above equations show that when combining different sub-matrices to make a new MIP matrix, if the offset value is to be unchanged, sO₁ is made equal to sO₀. The equation can then be rewritten in the following compact way:

$$predMip [ x ] [ y ] = ( ( {\sum }_{i = 0}^{3} ( mWeight {0}^{′} [ i ] [ y * incH * predC + x * incW ] - {sO}_{1} ) * p [ i ] + {\sum }_{i = 4}^{7} ( mWeight 1 [ i ] [ y * incH * predC + x * incW ] - {sO}_{1} ) * p [ i ] + ( 1 \text{<<} ( sW - 1 ) ) ) \text{>>} sW ) + pTemp [ 0 ]$$

Because VVC Draft 6 defines a sub-clause to derive mWeight[i][j] independently from (8-67), the equation can be written in its original way:

$$predMip [ x ] [ y ] = ( ( {\sum }_{i = 0}^{7} mWeight [ i ] [ y * incH * predC + x * incW ] * p [ i ] - sO * {\sum }_{i = 0}^{7} p [ i ] + ( 1 \text{<<} ( sW - 1 ) ) ) \text{>>} sW ) + pTemp [ 0 ]$$

$$with$$

$$mWeight [ i ] [ j ] = \{ \begin{matrix}mWeight {0}^{′} [ i ] [ j ] , & i < 4 \\ mWeight 1 [ i ] [ j ] , & i \geq 4\end{matrix} \\ sO = {sO}_{0} = {sO}_{1}$$

The use of this modification leads to changed matrix weights in the text of VVC Draft 6 as well as changes to the associated offset. If all MIP matrices are aligned to one with the largest offset in VVC, the specification can be significantly reduced, and a single offset value can be used. Aligning the MIP matrices refers to using the same offset value for different sub-MIP matrix when combining different sub-matrices to get the new MIP matrix. The following table can be removed from section 8.4.5.2.1 of VVC Draft 6 as shown below:

TABLE 8-6
<d> - Specification of offset factor sO depending on MipSizeId and modeId

| | modeId | | | | | | | | | | | | | | | | | |
|---|---|---|---|---|---|---|---|---|---|---|---|---|---|---|---|---|---|---|
| MipSizeId | 0 | 1 | 2 | 3 | 4 | 5 | 6 | 7 | 8 | 9 | 10 | 11 | 12 | 13 | 14 | 15 | 16 | 17 |
| 0 | 34 | 21 | 7 | 27 | 27 | 28 | 56 | 13 | 47 | 15 | 40 | 21 | 16 | 7 | 45 | 66 | 21 | 32 |
| 1 | 17 | 20 | 11 | 45 | 17 | 11 | 23 | 10 | 21 | 11 | | | | | | | | |
| 2 | 8 | 46 | 16 | 10 | 13 | 11 | | | | | | | | | | | | |

</d>

Additionally, the offset value can be fixed, e.g., as follows:

For the intra sample prediction process according to predModeIntra, the following ordered steps apply:
1. The matrix-based intra prediction samples predMip[x][y], with x=0 . . . mipW−1, y=0 . . . mipH−1 are derived as follows:
The variable modeId is set equal to predModeIntra.
The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.
The variable sW is derived using MipSizeId[xTbCmp][yTbCmp] and modeId as specified in Table 8-5.
<i>The variable sO is set equal to 46.</i>
The matrix-based intra prediction samples predMip[x][y], with x=0 . . . mipW−1, y=0 . . . mipH−1 are derived as follows:

oW=(1<<(sW−1))−sO*(Σᵢ₌₀^{inSize-1}p[i]) (8-11)

incW=(predC>mipW)?2:1 (8-12)

incH=(predC>mipH)?2:1 (8-13)

predMip[x][y]=(((Σᵢ₌₀^{inSize-1}mWeight[i][y*incH*predC+x*incW]*p[i])+oW)>>sW)+pTemp[0] (8-14)

In a second example, the offset value is selected as a power-of-two value. This way, multiplication can be avoided, and the process further simplified. For example, the offset value can be set as 64, which may lead to use of a shift operation instead of a multiplication operation for oW derivation. The use of a shift operation instead of a multiplication operation for oW derivation may lead to at least the following changes to section 8.4.5.2.1 of VVC Draft 6:

For the intra sample prediction process according to predModeIntra, the following ordered steps apply:
1. The matrix-based intra prediction samples predMip[x][y], with x=0 . . . mipW−1, y=0 . . . mipH−1 are derived as follows:
The variable modeId is set equal to predModeIntra.
The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.
The variable sW is derived using MipSizeId[xTbCmp][yTbCmp] and modeId as specified in Table 8-5.
The matrix-based intra prediction samples predMip[x][y], with x=0 . . . mipW−1, y=0 . . . mipH−1 are derived as follows:

oW=(1<<(sW−1))−<i>((Σᵢ₌₀^{inSize-1}p[i])<<6)</i> (8-15)

incW=(predC>mipW)?2:1 (8-16)

incH=(predC>mipH)?2:1 (8-17)

predMip[x][y]=(((Σᵢ₌₀^{inSize-1}mWeight[i][y*incH*predC+x*incW]*p[i])+oW)>>sW)+pTemp[0] (8-18)

In a third example, the offset value is defined as a function of the MipSizeId. For example, if the offset value is equal 2\hat{ }(6-MipSizeId), multiplication can be replaced by a 6-MipSizeId (i.e., 6 minus MipSizeId) shift. Replacing multiplication by a 6-MipSizeId shift would lead to following changes in section 8.4.5.2.1 of VVC Draft 6:

For the intra sample prediction process according to predModeIntra, the following ordered steps apply:
3. The matrix-based intra prediction samples predMip[x][y], with x=0 . . . mipW−1, y=0 . . . mipH−1 are derived as follows:
   The variable modeId is derived as follows:

modeId=predModeIntra−(isTransposed?numModes/2:0) (8-63)
The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.
The variable sW is derived using MipSizeId[xTbCmp][yTbCmp] and modeId as specified in Table 8-5.
<i>The variable sO is set equal to 6−MipSizeId[xTbCmp][yTbCmp].</i>
The matrix-based intra prediction samples predMip[x][y], with x=0 . . . mipW−1, y=0 . . . mipH−1 are derived as follows:

oW=(1<<(sW−1)−<i>((Σᵢ₌₀^{inSize-1}p[i])<<sO)</i> (8-64)

incW=(predC>mipW)?2:1 (8-65)

incH=(predC>mipH)?2:1 (8-66)

predMip[x][y]=(((Σᵢ₌₀^{inSize-1}mWeight[i][y*incH*predC+x*incW]*p[i])+oW)>>sW)+pTemp[0]

In a fourth example, the aspect of this disclosure related to combining MIP matrices is combined with the harmonization aspect described in the section of this disclosure entitled “MIP Symmetry Harmonization.” For example, a video coder (e.g., video encoder 200 or video decoder 300) may use the following configuration:
For S₀ subset, 6 matrices are stored A₀ⁱ, i∈{0, . . . , 5} without matrix combinations, which leads to 12 modes.
For S₁ subset, 6 matrices are stored A₁ⁱ, i∈{0, . . . , 5} without matrix combinations, which leads to 12 modes.
For S₂ subset, 4 matrices are stored A₀ⁱ, i∈{0, . . . , 3} with 2 additional modes that use matrix combinations, which leads to 12 modes.
Full symmetry is enabled, with optimized signalling, and single offset value.

In a fifth example, the aspect of the disclosure related to combinations of MIP matrices is combined with the harmonization aspect described in the section of this disclosure entitled “MIP Symmetry Harmonization”. In such examples, the following configuration may be used:
For S₀ subset, 4 matrices are stored A₀ⁱ, i∈{0, . . . , 3} with 2 additional modes that use matrices combination, which leads to 12 modes.
For S₁ subset, 4 matrices are stored A₁ⁱ, i∈{0, . . . , 3} with 2 additional modes that use matrices combination, which leads to 12 modes.
For S₂ subset, 4 matrices are stored A₀ⁱ, i∈{0, . . . , 3} with 2 additional modes that use matrices combination, which leads to 12 modes.
Full symmetry is enabled, with optimized signalling, and single offset value.

Because the fifth example may lead to a substantial number of changes to VVC Draft 6 and simplifications in the specification of VVC Draft 6, example modified portions of VVC Draft 6 implementing the fifth example are attached to this disclosure as Appendix A. Appendix A constitutes a portion of this disclosure.

In a sixth example, the fifth example can be used without MIP matrix combination. Because the sixth example may lead to a substantial number of changes and simplifications in VVC Draft 6, example modified portions of VVC Draft 6 implementing the sixth example are attached to this disclosure as Appendix B. Appendix B constitutes a portion of this disclosure.

In a seventh example, the aspects of this disclosure related to combined MIP matrices may be combined with the aspects of this disclosure related to MIP symmetry harmonization. For instance, in the seventh example, the following configuration may be used:
For S₀ subset, 3 matrices are stored A₀ⁱ, i∈{0, . . . , 2} with 1 additional mode that uses matrices combination, which leads to 8 modes.
For S₁ subset, 3 matrices are stored A₁ⁱ, i∈{0, . . . , 2} with 1 additional mode that uses matrices combination, which leads to 8 modes.
For S₂ subset, 3 matrices are stored A₀ⁱ, i∈{0, . . . , 2} with 1 additional mode that uses matrices combination, which leads to 8 modes.
Full symmetry is enabled, with optimized signalling, and single offset value.

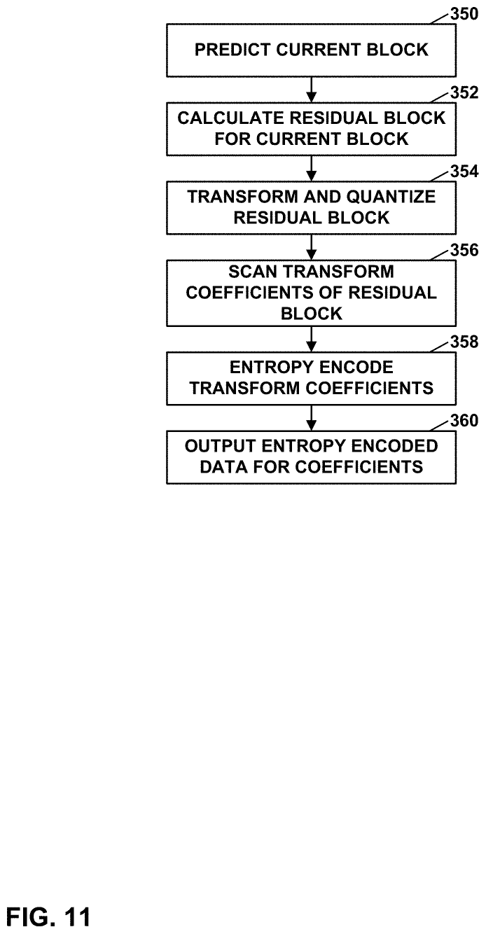

FIG. 11 is a flowchart illustrating an example method for encoding a current block. The current block may be or include a current CU. Although described with respect to video encoder 200 (FIGS. 1 and 3), it should be understood that other devices may be configured to perform a method similar to that of FIG. 11.

In this example, video encoder 200 initially predicts the current block (350). For example, video encoder 200 may form a prediction block for the current block. Video encoder 200 may then calculate a residual block for the current block (352). For instance, as part of predicting the current block, video encoder 200 may perform the techniques for MIP described in this disclosure. To calculate the residual block, video encoder 200 may calculate a difference between the original, unencoded block and the prediction block for the current block. Video encoder 200 may then transform and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

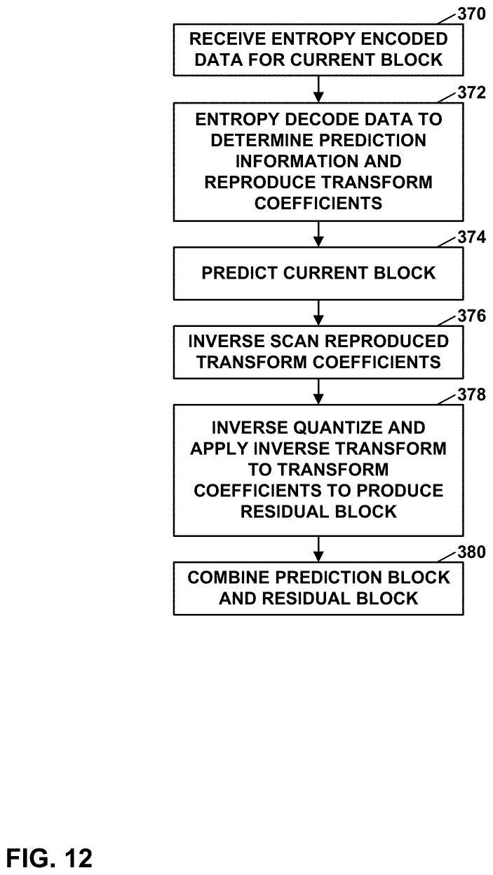

FIG. 12 is a flowchart illustrating an example method for decoding a current block of video data. The current block may be or include a current CU. Although described with respect to video decoder 300 (FIGS. 1 and 4), it should be understood that other devices may be configured to perform a method similar to that of FIG. 12.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. For instance, as part of predicting the current block, video decoder 300 may perform the techniques for MIP described in this disclosure. Video decoder 300 may then inverse scan the reproduced transform coefficients (376), to create a block of quantized transform coefficients. Video decoder 300 may then inverse quantize and apply an inverse transform to the transform coefficients to produce a residual block (378). Video decoder 300 may ultimately decode the current block by combining the prediction block and the residual block (380).

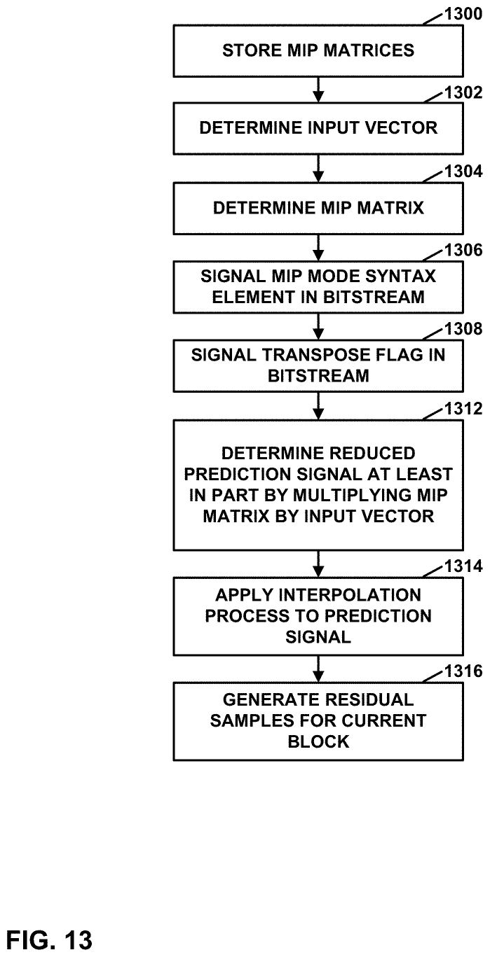

FIG. 13 is a flowchart illustrating an example method for encoding data in accordance with one or more techniques of this disclosure. In the example of FIG. 13, video encoder 200 may store a plurality of MIP matrices (1300). The plurality of MIP matrices may be, or may include, a set of MIP matrices for a specific block size (e.g., 4×4, 8×8, or other than 8×8).

Furthermore, in the example of FIG. 13, video encoder 200 (e.g., MIP unit 225 of video encoder 200) may determine an input vector based on neighboring samples for a current block of the video data (1302). For instance, consistent with the discussion of FIG. 2 above, video encoder 200 may determine the input vector by averaging sets of neighboring samples to determine reduced boundary vectors bdry_{red}^{top} and bdry_{red}^{left} and concatenating the reduced boundary vectors to form the input vector, which may be referred to as a reduced boundary vector bdry_{red}. As part of determining the input vector, video encoder 200 may determine whether to transpose the input vector. Depending on whether the input vector is transposed, video encoder 200 may generate the input vector by concatenating bdry_{red}^{top} to bdry_{red}^{left} or by concatenating bdry_{red}^{left} to bdry_{red}^{top}. Video encoder 200 may determine whether to transpose the input vector based on a rate-distortion optimization process.

In the example of FIG. 13, video encoder 200 may determine a MIP matrix from the plurality of stored MIP matrices (1304). For instance, video encoder 200 may determine the MIP matrix based on a rate-distortion analysis. Video encoder 200 may signal, in a bitstream that includes an encoded representation of the video data, a MIP mode syntax element (e.g., intra_mip_mode) indicating a MIP mode index for the current block (1306). The MIP mode index for the current block may correspond to the determined MIP matrix.

Additionally, video encoder 200 may signal, in the bitstream, a transpose flag (e.g., intra_mip_transposed) that indicates whether the input vector is transposed (1308). In some examples, video encoder 200 (e.g., entropy encoding unit 220 of video encoder 200) may perform bypass encoding on the MIP mode syntax element and separately perform bypass encoding on the transpose flag. In such examples, use of the transpose flag may reduce the number of bits needed to indicate a truncated binary code used as a binarization of the MIP mode syntax element because use of the transpose flag may reduce the maximum value that the MIP mode syntax element may need to encode.

In some examples, the MIP mode index is equal to 0. Thus, in contrast to previous implementations of MIP, the MIP matrix with a MIP mode index of 0 may be used when the input vector is transposed. This may increase the number of MIP matrices available for use and therefore may increase coding efficiency.

Furthermore, video encoder 200 (e.g., MIP unit 225) may determine a prediction signal at least in part by multiplying a MIP matrix by the (potentially transposed) input vector (1312). In some examples, video encoder 200 may determine the prediction signal by multiplying the MIP matrix by the (potentially transposed) input vector and adding an offset vector. The prediction signal includes values corresponding to a first set of locations in a prediction block for the current block (e.g., shaded squares in intermediate prediction block 161 of FIG. 2). The MIP matrix may be in the plurality of stored MIP matrices and may correspond to the MIP mode index indicated by the MIP mode syntax element.

Video encoder 200 (e.g., MIP unit 225) may apply an interpolation process to the prediction signal to determine values corresponding to a second set of locations in the prediction block for the current block (1314). For instance, video encoder 200 may perform linear interpolation operations on the shaded squares of intermediate prediction block 161 to determine values for the white squares of intermediate prediction block 161, thereby generating prediction block 162.

Video encoder 200 (e.g., residual generation unit 204 of video encoder 200) may generate residual samples for the current block based on differences between samples of the current block and corresponding samples of the prediction block for the current block (1316). For example, video encoder 200 may subtract samples of the prediction block from corresponding samples of the current block to determine the residual samples for the current block.

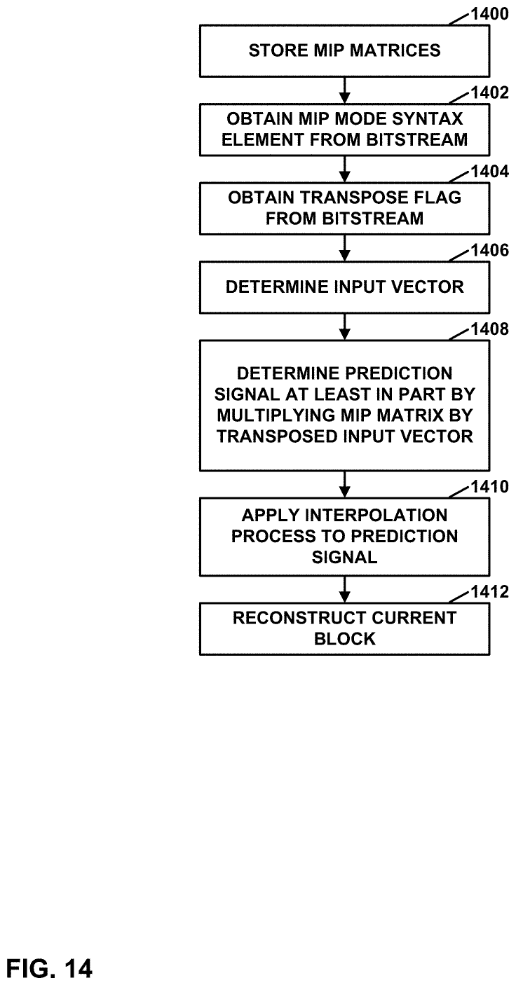

FIG. 14 is a flowchart illustrating an example method for decoding data in accordance with one or more techniques of this disclosure. In the example of FIG. 14, video decoder 300 may store a plurality of MIP matrices (1400). The plurality of MIP matrices may be, or may include, a set of MIP matrices for a specific block size (e.g., 4×4, 8×8, or other than 8×8).

Video decoder 300 (e.g., entropy decoding unit 302 of video decoder 300) may obtain, from a bitstream that includes an encoded representation of the video data, a MIP mode syntax element indicating a MIP mode index for a current block of the video data (1402). Additionally, video decoder 300 (e.g., entropy decoding unit 302) may obtain a transpose flag from the bitstream (1404). In some examples, the MIP mode index is equal to 0. Thus, in contrast to previous implementations of MIP, the MIP matrix with a MIP mode index of 0 may be used when the input vector is transposed. This may increase the number of MIP matrices available for use and therefore may increase coding efficiency.

Additionally, video decoder 300 (e.g., MIP unit 319 of video decoder 300) may determine an input vector based on neighboring samples for a current block of the video data (1406). For instance, consistent with the discussion of FIG. 2 above, video decoder 300 may determine the input vector by averaging sets of neighboring samples to determine reduced boundary vectors bdry_{red}^{top} and bdry_{red}^{left} and then concatenating the reduced boundary vectors to form the input vector, which may be referred to as a reduced boundary vector bdry_{red}. Depending on whether the input vector is transposed, video decoder 300 may generate the input vector by concatenating bdry_{red}^{top} to bdry_{red}^{left} or by concatenating bdry_{red}^{left} to bdry_{red}^{top}.

In some examples, video decoder 300 (e.g., entropy decoding unit 302 of video decoder 300) may perform bypass decoding on the MIP mode syntax element and separately perform bypass decoding on the transpose flag. In such examples, use of the transpose flag may reduce the number of bits needed to indicate a truncated binary code used as a binarization of the MIP mode syntax element because use of a transpose flag may reduce the maximum value that the MIP mode syntax element may need to encode.

Furthermore, video decoder 300 (e.g., MIP unit 319) may determine a prediction signal at least in part by multiplying a MIP matrix by the (potentially transposed) input vector (1408). The prediction signal includes values corresponding to a first set of locations in a prediction block for the current block, the MIP matrix is one of the plurality of stored MIP matrices, and the MIP matrix corresponds to the MIP mode index. In some examples, video decoder 300 may determine the prediction signal by multiplying a MIP matrix by the (potentially transposed) input vector and adding an offset vector. In some such examples, the offset vector may be an offset value and the offset value is defined as a function of a MIP size identifier for a transform unit of the current block, the MIP size identifier being an identifier of a size of the transform unit.

Video decoder 300 (e.g., MIP unit 319) may apply an interpolation process to the prediction signal to determine values corresponding to a second set of locations in the prediction block for the current block (1410). For instance, video decoder 300 may perform linear interpolation operations on the shaded squares of intermediate prediction block 161 (FIG. 2) to determine values for the white squares of intermediate prediction block 161, thereby generating prediction block 162.

Video decoder 300 (e.g., reconstruction unit 310 of video decoder 300) may reconstruct the current block by adding samples of the prediction block for the current block to corresponding residual samples for the current block (1412).

The following is a non-limiting list of examples that are in accordance with one or more techniques of this disclosure.

Example 1. A method of coding video data, the method including: deriving a new matrix based on a Matrix Intra Prediction (MIP) matrix; determining an input vector based on neighbor samples for a current block of the video data; determining a reduced prediction signal by multiplying the new matrix by the input vector and adding an offset vector, the reduced prediction signal including values corresponding to a first set of locations in a prediction block for the current block; applying an interpolation process to the reduced prediction signal to determine values corresponding to a second set of locations in the prediction block for the current block; and coding the current block using the prediction block for the current block.

Example 2. The method of example 1, wherein deriving the new matrix includes deriving the new matrix in accordance with one of the following modes: deriving the new matrix by transposing the MIP matrix, deriving the new matrix by swapping one column of the MIP matrix with another column of the MIP matrix, or deriving the new matrix by swapping one row of the MIP matrix with another row of the MIP matrix.

Example 3. The method of example 1, wherein the MIP matrix is a first MIP matrix and deriving the new matrix includes deriving the new matrix based on the first MIP matrix and a second MIP matrix.

Example 4. The method of example 3, wherein deriving the new matrix based on the first MIP matrix and the second MIP matrix includes: deriving the new matrix based on a subset of columns of the first MIP matrix and a subset of columns of the second MIP matrix.

Example 5. The method of example 3, wherein deriving the new matrix based on the first MIP matrix and the second MIP matrix includes: deriving the new matrix based on a subset of rows of the first MIP matrix and a subset of rows of the second MIP matrix.

Example 6. The method of any of examples 3-5, wherein the first MIP matrix and the second MIP matrix are not of a same size.

Example 7. The method of any of examples 1-6, wherein a flag is signaled in a bitstream that includes an encoded representation of the video data, wherein the flag indicates whether the input vector is transposed.

Example 8. The method of any of examples 1-7, further including determining the offset vector is an offset value and the offset value is defined as a function of a MipSizeId for a transform unit of the current block.

Example 9. The method of any of examples 1-8, wherein coding includes decoding.

Example 10. The method of example 9, wherein coding the current block includes reconstructing the current block by adding samples of the prediction block for the current block to corresponding residual samples for the current block.

Example 11. The method of any of examples 1-8, wherein coding includes encoding.

Example 12. The method of example 11, wherein coding the current block includes generating residual samples for the current block based on differences between samples of the current block and corresponding samples of the prediction block for the current block.

Example 13. A method in accordance with any of the examples of this disclosure.

Example 14. A device for coding video data, the device including one or more means for performing the method of any of examples 1-13.

Example 15. The device of example 14, wherein the one or more means include one or more processors implemented in circuitry.

Example 16. The device of any of examples 14 and 15, further including a memory to store the video data.

Example 17. The device of any of examples 14-16, further including a display configured to display decoded video data.

Example 18. The device of any of examples 14-17, wherein the device includes one or more of a camera, a computer, a mobile device, a broadcast receiver device, or a set-top box.

Example 19. The device of any of examples 14-18, wherein the device includes a video decoder.

Example 20. The device of any of examples 14-19, wherein the device includes a video encoder.

Example 21. A computer-readable storage medium having stored thereon instructions that, when executed, cause one or more processors to perform the method of any of examples 1-13.

Example 22. A method of decoding video data, the method comprising: storing a plurality of Matrix Intra Prediction (MIP) matrices; obtaining, from a bitstream that includes an encoded representation of the video data, a MIP mode syntax element indicating a MIP mode index for a current block of the video data; obtaining a transpose flag from the bitstream; determining an input vector based on neighboring samples for the current block, wherein the transpose flag indicates whether the input vector is transposed; determining a prediction signal, wherein determining the prediction signal comprises multiplying a MIP matrix by the input vector, wherein the prediction signal comprises values corresponding to a first set of locations in a prediction block for the current block, the MIP matrix is one of the plurality of stored MIP matrices, and the MIP matrix corresponds to the MIP mode index; applying an interpolation process to the prediction signal to determine values corresponding to a second set of locations in the prediction block for the current block; and reconstructing the current block by adding samples of the prediction block for the current block to corresponding residual samples for the current block.

Example 23. The method of example 22, wherein the MIP mode index is equal to 0.

Example 24. The method of any of examples claim 22-23, further comprising: bypass decoding the transpose flag; and bypass decoding the MIP mode syntax element.

Example 25. The method of any of examples 22-24, wherein determining the prediction signal further comprises adding an offset vector to a product of the multiplication of the MIP matrix by the input vector.

Example 26. The method of any of examples 22-25, wherein an order in which top boundary pixel values and left boundary pixel values are concatenated to each other is dependent on whether the input vector is transposed, the neighboring samples including the top boundary pixel values and the left boundary pixel values.

Example 27. A method of encoding video data, the method comprising: storing a plurality of Matrix Intra Prediction (MIP) matrices; determining an input vector based on neighboring samples for a current block of the video data; determining a MIP matrix from the plurality of stored MIP matrices; signaling, in a bitstream that includes an encoded representation of the video data, a MIP mode syntax element indicating a MIP mode index for the current block; signaling, in the bitstream, a transpose flag that indicates whether the input vector is transposed; determining a prediction signal, wherein determining the prediction signal comprises multiplying the determined MIP matrix by the input vector, wherein the prediction signal comprises values corresponding to a first set of locations in a prediction block for the current block, and the determined MIP matrix corresponds to the MIP mode index; applying an interpolation process to the prediction signal to determine values corresponding to a second set of locations in the prediction block for the current block; and generating residual samples for the current block based on differences between samples of the current block and corresponding samples of the prediction block for the current block.

Example 28. The method of example 27, wherein the MIP mode index is equal to 0.

Example 29. The method of any of examples 27-28, further comprising: bypass encoding the transpose flag; and bypass encoding the MIP mode syntax element.

Example 30. The method of any of examples 27-29, wherein determining the prediction signal further comprises adding an offset vector to a product of the multiplication of the MIP matrix by the input vector.

Example 31. The method of any of examples 27-30, further comprising determining whether to transpose the input vector.

Example 32. The method of any of examples 27-31, wherein an order in which top boundary pixel values and left boundary pixel values are concatenated to each other is dependent on whether the input vector is transposed, the neighboring samples including the top boundary pixel values and the left boundary pixel values.

Example 33. A device for decoding video data, the device comprising: a memory to store a plurality of Matrix Intra Prediction (MIP) matrices; and one or more processors implemented in circuitry, the one or more processors configured to: obtain, from a bitstream that includes an encoded representation of the video data, a MIP mode syntax element indicating a MIP mode index for a current block of the video data; obtain a transpose flag from the bitstream; determine an input vector based on neighboring samples for the current block, wherein the transpose flag indicates whether the input vector is transposed; determine a prediction signal, wherein the one or more processors are configured such that, as part of determining the prediction signal, the one or more processors multiply a MIP matrix by the input vector, wherein the prediction signal comprises values corresponding to a first set of locations in a prediction block for the current block, the MIP matrix is one of the plurality of stored MIP matrices, and the MIP matrix corresponds to the MIP mode index; apply an interpolation process to the prediction signal to determine values corresponding to a second set of locations in the prediction block for the current block; and reconstruct the current block by adding samples of the prediction block for the current block to corresponding residual samples for the current block.

Example 34. The device of example 32, wherein the MIP mode index is equal to 0.

Example 35. The device of any of examples 33-34, wherein the one or more processors are further configured to: bypass decode the transpose flag; and bypass decode the MIP mode syntax element.

Example 36. The device of any of examples 33-35, wherein the one or more processors are configured such that, as part of determining the prediction signal, the one or more processors add an offset vector to a product of the multiplication of the MIP matrix by the input vector.

Example 37. The device of any of examples 33-36, further comprising a display configured to display decoded video data.

Example 38. The device of any of examples 33-37, wherein the device comprises one or more of a camera, a computer, a mobile device, a broadcast receiver device, or a set-top box.

Example 39. The device of any of examples 33-38, wherein an order in which top boundary pixel values and left boundary pixel values are concatenated to each other is dependent on whether the input vector is transposed, the neighboring samples including the top boundary pixel values and the left boundary pixel values.

Example 40. A device for encoding video data, the device comprising: a memory to store a plurality of Matrix Intra Prediction (MIP) matrices; and one or more processors implemented in circuitry, the one or more processors configured to: determine an input vector based on neighboring samples for a current block of the video data; determine a MIP matrix from the plurality of stored MIP matrices; signal, in a bitstream that includes an encoded representation of the video data, a MIP mode syntax element indicating a MIP mode index for the current block; signal, in the bitstream, a transpose flag that indicates whether the input vector is transposed; determine a prediction signal, wherein the one or more processors are configured such that, as part of determining the prediction signal, the one or more processors multiply the determined MIP matrix by the input vector, wherein the prediction signal comprises values corresponding to a first set of locations in a prediction block for the current block, and the determined MIP matrix corresponds to the MIP mode index; apply an interpolation process to the prediction signal to determine values corresponding to a second set of locations in the prediction block for the current block; and generate residual samples for the current block based on differences between samples of the current block and corresponding samples of the prediction block for the current block.

Example 41. The device of example 40, wherein the MIP mode index is equal to 0.

Example 42. The device of any of examples 40-41, wherein the one or more processors are further configured to: bypass encode the transpose flag; and bypass encode the MIP mode syntax element.

Example 43. The device of any of examples 40-42, wherein the one or more processors are configured such that, as part of determining the prediction signal, the one or more processors add an offset vector to a product of the multiplication of the MIP matrix by the input vector.

Example 44. The device of any of examples 40-43, wherein the one or more processors are further configured to determine whether to transpose the input vector

Example 45. The device of any of examples 40-44, wherein an order in which top boundary pixel values and left boundary pixel values are concatenated to each other is dependent on whether the input vector is transposed, the neighboring samples including the top boundary pixel values and the left boundary pixel values.

Example 46. A device for decoding video data, the device comprising: means for storing a plurality of Matrix Intra Prediction (MIP) matrices; means for obtaining, from a bitstream that includes an encoded representation of the video data, a MIP mode syntax element indicating a MIP mode index for a current block of the video data; means for obtaining a transpose flag from the bitstream; means for determining the input vector based on neighboring samples for the current block, wherein the transpose flag indicates whether the input vector is transposed; means for determining a prediction signal, wherein determining the prediction signal comprises multiplying a MIP matrix by the transposed input vector, wherein the prediction signal comprises values corresponding to a first set of locations in a prediction block for the current block, the MIP matrix is one of the plurality of stored MIP matrices, and the MIP matrix corresponds to the MIP mode index; means for applying an interpolation process to the prediction signal to determine values corresponding to a second set of locations in the prediction block for the current block; and means for reconstructing the current block by adding samples of the prediction block for the current block to corresponding residual samples for the current block.

Example 47. A device for encoding video data, the method comprising: means for storing a plurality of Matrix Intra Prediction (MIP) matrices; means for determining an input vector based on neighboring samples for a current block of the video data; means for determining a MIP matrix from the plurality of stored MIP matrices; means for signaling, in a bitstream that includes an encoded representation of the video data, a MIP mode syntax element indicating a MIP mode index for the current block; means for signaling, in the bitstream, a transpose flag that indicates whether the input vector is transposed; means for determining a prediction signal, wherein determining the prediction signal comprises multiplying the determined MIP matrix by the input vector, wherein the prediction signal comprises values corresponding to a first set of locations in a prediction block for the current block, and the determined MIP matrix corresponds to the MIP mode index; means for applying an interpolation process to the prediction signal to determine values corresponding to a second set of locations in the prediction block for the current block; and means for generating residual samples for the current block based on differences between samples of the current block and corresponding samples of the prediction block for the current block.

Example 48. A computer-readable storage medium having stored thereon instructions that, when executed, cause one or more processors to: store a plurality of Matrix Intra Prediction (MIP) matrices; obtain, from a bitstream that includes an encoded representation of the video data, a MIP mode syntax element indicating a MIP mode index for a current block of the video data; obtain a transpose flag from the bitstream; determining the input vector based on neighboring samples for the current block, wherein the transpose flag indicates whether the input vector is transposed; determine a prediction signal, wherein determining the prediction signal comprises multiplying a MIP matrix by the transposed input vector, wherein the prediction signal comprises values corresponding to a first set of locations in a prediction block for the current block, the MIP matrix is one of the plurality of stored MIP matrices, and the MIP matrix corresponds to the MIP mode index; apply an interpolation process to the prediction signal to determine values corresponding to a second set of locations in the prediction block for the current block; and reconstruct the current block by adding samples of the prediction block for the current block to corresponding residual samples for the current block

Example 49. A computer-readable storage medium having stored thereon instructions that, when executed, cause one or more processors to: store a plurality of Matrix Intra Prediction (MIP) matrices; determine an input vector based on neighboring samples for a current block of the video data; determine a MIP matrix from the plurality of stored MIP matrices; signal, in a bitstream that includes an encoded representation of the video data, a MIP mode syntax element indicating a MIP mode index for the current block; signal, in the bitstream, a transpose flag that indicates whether the input vector is transposed; determine a prediction signal, wherein determining the prediction signal comprises multiplying the determined MIP matrix by the transposed input vector, wherein the prediction signal comprises values corresponding to a first set of locations in a prediction block for the current block, and the determined MIP matrix corresponds to the MIP mode index; apply an interpolation process to the prediction signal to determine values corresponding to a second set of locations in the prediction block for the current block; and generate residual samples for the current block based on differences between samples of the current block and corresponding samples of the prediction block for the current block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable, including programmable circuitry and fixed function circuitry, for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

### APPENDIX A

Coding unit syntax

| coding_unit( x0, y0, cbWidth, cbHeight, cqtDepth, treeType, modeType) { | Descriptor |
|---|---|
| chType = treeType = = DUAL_TREE_CHROMA? 1 : 0 | |
| if( slice_type != I \| \| sps_ibc_enabled_flag \| \| sps_palette_enabled_flag) { | |
| if( treeType != DUAL_TREE_CHROMA && | |
| !( ( ( cbWidth = = 4 && cbHeight = = 4 ) \| \| modeType = = | |
| MODE_TYPE_INTRA) | |
| && !sps_ibc_enabled_flag ) ) | |
| cu_skip_flag[ x0 ][ y0 ] | ae(v) |
| if( cu_skip_flag[ x0 ][ y0 ] = = 0 && slice_type != I | |
| && !( cbWidth = = 4 && cbHeight = = 4 ) && modeType = = | |
| MODE_TYPE_ALL ) | |
| pred_mode_flag | ae(v) |
| if( ( ( slice_type = = I && cu_skip_flag[ x0 ][ y0 ] = =0) \| \| | |
| ( slice_type != I && ( CuPredMode[ chType ][ x0 ][ y0 ] != | |
| MODE_INTRA \| \| | |
| ( cbWidth = = 4 && cbHeight = = 4 && cu_skip_flag[ x0 ][ y0 ] = = | |
| 0 ) ) ) ) && | |
| cbWidth <= 64 && cbHeight <= 64 && modeType != | |
| MODE_TYPE_INTER && | |
| sps_ibc_enabled_flag && treeType != DUAL_TREE_CHROMA ) | |
| pred_mode_ibc_flag | ae(v) |
| if( ( ( ( slice_type = = I \| \| ( cbWidth = = 4 && cbHeight = = 4) \| \| | |
| sps_ibc_enabled_flag ) && | |
| CuPredMode[ x0 ][ y0 ] = = MODE_NTRA) | |
| ( slice_type != I && !( cbWidth = = 4 && cbHeight = = 4) && | |
| !sps_ibc_enabled flag | |
| && CuPredMode[ x0 ][ y0 ] != MODE_INTRA ) ) && | |
| sps_palette_enabled_flag && | |
| cbWidth <= 64 && cbHeight <= 64 && && cu_skip_flag[ x0 ][ y0 ] = = | |
| 0 && | |
| modeType != MODE_INTER ) | |
| pred_mode_plt_flag | ae(v) |
| } | |
| if( CuPredMode[ chType ][ x0 ][ y0 ] = = MODE_INTRA \| \| | |
| CuPredMode[ chType ][ x0 ][ y0 ] = = MODE_PLT) { | |
| if( treeType = = SINGLE_TREE \| \| treeType = = DUAL_TREE_LUMA ) { | |
| if( pred_mode_plt_flag) { | |
| if( treeType = = DUAL_TREE_LUMA ) | |
| palette_coding( x0, y0, cbWidth, cbHeight, 0, 1) | |
| else /* SINGLE_TREE */ | |
| palette coding( x0, y0, cbWidth, cbHeight, 0, 3) | |
| } else { | |
| if( sps_bdpcm_enabled_flag && | |
| cbWidth <= MaxTsSize && cbHeight <= MaxTsSize ) | |
| intra_bdpcm_flag | ae(v) |
| if( intra_bdpcm_flag) | |
| intra_bdpcm_dir_flag | ae(v) |
| else { | |
| if( sps_mip_enabled_flag && | |
| ( Abs( Log2( cbWidth) − Log2( cbHeight) ) <= 2 ) && | |
| cbWidth <= MaxTbSizeY && cbHeight <= MaxTbSizeY ) | |
| intra_mip_flag[ x0 ][ y0 ] | ae(v) |
| if( intra_mip_flag[ x0 ][ y0 ] | |
| intra_mip_transposed[ x0 ][ y0 ] | ae(v) |
| intra_mip_mode[ x0 ][ y0 ] | ae(v) |
| else { | |
| if( sps_mrl_enabled_flag && ( ( y0 % CtbSizeY ) > 0 ) ) | |
| intra_luma_ref_idx [ x0 ][ y0 ] | ae(v) |
| if( sps_isp_enabled_flag && intra_luma_ref_idx[ x0 ][ y0 ] = = 0 | |
| && | |
| ( cbWidth <= MaxTbSizeY && cbHeight <= MaxTbSizeY ) && | |
| ( cbWidth * cbHeight > MinTbSizeY * MinTbSizeY ) ) | |
| intra_subpartitions_mode_flag[ x0 ][ y0 ] | ae(v) |
| if( intra_subpartitions_mode_flag[ x0 ][ y0 ] = = 1 ) | |
| intra_subpartitions_split_flag[ x0 ][ y0 ] | ae(v) |
| if( intra_luma_ref_idx[ x0 ][ y0 ] = = 0) | |
| intra_luma_mpm_flag[ x0 ][ y0 ] | ae(v) |
| if( intra_luma_mpm_flag[ x0 ][ y0 ] ) { | |
| if( intra_luma_ref_idx[ x0 ][ y0 ] = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainded[ x0 ][ y0 ] | ae(v) |
| } | |
| } | |
| } | |
| } | |
| if( ( treeType = = SINGLE_TREE \| \| treeType = = DUAL_TREE_CHROMA ) | |
| && | |
| ChromaArrayType != 0) { | |
| if ( pred mode_plt_flag && treeType = = DUAL_TREE_CHROMA ) | |
| palette_coding( x0, y0, cbWidth / SubWidthC, cbHeight / SubHeightC, 1, | |
| 2 ) | |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |
| } else if( treeType != DUAL_TREE_CHROMA ) { /* MODE_INTER or | |
| MODE_IBC */ | |
| if( cu_skip_flag[ x0 ][ y0 ] = = 0) | |
| general_merge_flag[ x0 ][ y0 ] | ae(v) |
| if( general_merge_flag[ x0 ][ y0 ]) { | |
| merge_data( x0, y0, cbWidth, cbHeight, chType ) | |
| } else if ( CuPredMode[ chType ][ x0 ][ y0 ] = = MODE_IBC) { | |
| mvd_coding( x0, y0, 0, 0 ) | |
| if( MaxNumIbcMergeCand > 1 ) | |
| mvp_10_flag[ x0 ][ y0 ] | ae(v) |
| if( sps_amvr_enabled_flag && | |
| ( MvdL0[ x0 ][ y0 ][ 0 ] != 0 \| \| MvdL0[ x0 ][ y0 ][ 1 ] != 0 ) ) { | |
| amvr_precision_idx[ x0 ][ y0 ] | ae(v) |
| } | |
| } else { | |
| if( slice_type = = B) | |
| inter_pred_idc[ x0 ][ y0 ] | ae(v) |
| if( sps_affine_enabled_flag && cbWidth >= 16 && cbHeight >= 16 ) { | |
| inter_affine_flag[ x0 ][ y0 ] | ae(v) |
| if( sps_affine_type_flag && inter_affine_flag[ x0 ][ y0 ] ) | |
| cu_affine_type_flag[ x0 ][ y0 ] | ae(v) |
| } | |
| if( sps_smvd_enabled flag && !mvd_l1_zero_flag && | |
| inter_pred_idc[ x0 ][ y0 ] = = PRED_BI && | |
| !inter_affine_flag[ x0 ][ y0 ] && RefIdxSymL0 > −1 && RefIdxSymL1 | |
| > −1 ) | |
| sym_mvd_flag[ x0 ][ y0 ] | ae(v) |
| if( inter_pred_idc[ x0 ][ y0 ] != PRED_L1) { | |
| if( NumRefIdxActive [ 0 ] > 1 && !sym_mvd_flag[ x0 ][ y0 ] ) | |
| ref_idx_l0[ x0 ][ y0 ] | ae(v) |
| mvd_coding( x0, y0, 0, 0 ) | |
| if( MotionModelIdc[ x0 ][ y0 ] > 0 ) | |
| mvd_coding( x0, y0, 0, 1 ) | |
| if(MotionModelIdc[ x0 ][ y0 ] > 1 ) | |
| mvd_coding( x0, y0, 0, 2 ) | |
| mvp_10_flag[ x0 ][ y0 ] | ae(v) |
| } else { | |
| MvdL0[ x0 ][ y0 ][ 0 ] = 0 | |
| MvdL0[ x0 ][ y0 ][ 1 ] = 0 | |
| } | |
| if( inter_pred idc[ x0 ][ y0 ] != PRED_L0 ) { | |
| if( NumRefIdxActive[ 1 ] > 1 && !sym_mvd_flag[ x0 ][ y0 ] ) | |
| ref_idx_l1[ x0 ][ y0 ] | ae(v) |
| if( mvd_l1_zero_flag && inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| MvdCpL1[ x0 ][ y0 ][ 0 ][ 0 ] = 0 | |
| MvdCpL1[ x0 ][ y0 ][ 0 ][ 1 ] = 0 | |
| MvdCpL1[ x0 ][ y0 ][ 1 ][ 0 ] = 0 | |
| MvdCpL1[ x0 ][ y0 ][ 1 ][ 1 ] = 0 | |
| MvdCpL1[ x0 ][ y0 ][ 2 ][ 0 ] = 0 | |
| MvdCpL1[ x0 ][ y0 ][ 2 ][ 1 ] = 0 | |
| } else { | |
| if( sym_mvd_flag[ x0 ][ y0 ] ) { | |
| MvdLl[ x0 ][ y0 ][ 0 ] = −MvdL0[ x0 ][ y0 ][ 0 ] | |
| MvdLl[ x0 ][ y0 ][ 1 ] = −MvdL0[ x0 ][ y0 ][ 1 ] | |
| }else | |
| mvd_coding( x0, y0, 1, 0 ) | |
| if(MotionModelIdc[ x0 ][ y0 ] > 0 ) | |
| mvd_coding( x0, y0, 1, 1) | |
| if(MotionModelIdc[ x0 ][ y0 ] > 1 ) | |
| mvd_coding( x0, y0, 1, 2 ) | |
| mvp_l1_flag[ x0 ][ y0 ] | ae(v) |
| } | |
| }else { | |
| MvdL1[ x0 ][ y0 ][ 0 ] = 0 | |
| MvdL1[ x0 ][ y0 ][ 1 ] = 0 | |
| } | |
| if( ( sps_amvr_enabled_flag && inter_affine_flag[ x0 ][ y0 ] = = 0 && | |
| ( MvdL0[ x0 ][ y0 ][ 0 ] != 0 \| \| MvdL0[ x0 ][ y0 ][ 1 ] != 0 \| \| | |
| MvdL1[ x0 ][ y0 ][ 0 ] != 0 \| \| MvdL1[ x0 ][ y0 ][ 1 ] != 0 ) ) \| \| | |
| ( sps_affine_amvr_enabled_flag && inter_affine_flag[ x0 ][ y0 ] = = 1 | |
| && | |
| ( MvdCpL0[ x0 ][ y0 ][ 0 ][ 0 ] != 0 \| \| MvdCpL0[ x0 ][ y0 ][ 0 ][ 1 ] != | |
| 0 \| \| | |
| MvdCpL1[ x0 ][ y0 ][ 0 ][ 0 ] != 0 \| \| MvdCpL1[ x0 ][ y0 ][ 0 ][ 1 ] != | |
| 0 \| \| | |
| MvdCpL0[ x0 ][ y0 ][ 1 ][ 0 ] != 0 \| \| MvdCpL0[ x0 ][ y0 ][ 1 ][ 1 ] != | |
| 0 \| \| | |
| MvdCpL1[ x0 ][ y0 ][ 1 ][ 0 ] != 0 \| \| MvdCpL1[ x0 ][ y0 ][ 1 ][ 1 ] != | |
| 0 \| \| | |
| MvdCpL0[ x0 ][ y0 ][ 2 ][ 0 ] != 0 \| \| MvdCpL0[ x0 ][ y0 ][ 2 ][ 1 ] != | |
| 0 \| \| | |
| MvdCpL1[ x0 ][ y0 ][ 2 ][ 0 ] != 0 \| \| MvdCpL1[ x0 ][ y0 ][ 2 ][ 1 ] != | |
| 0 ) ) { | |
| amvr_flag[ x0 ][ y0 ] | ae(v) |
| if( amvr_flag[ x0 ][ y0 ] ) | |
| amvr_precision_idx[ x0 ][ y0 ] | ae(v) |
| } | |
| if( sps_bcw_enabled_flag && inter_pred idc[ x0 ][ y0 ] = = PRED_BI | |
| && | |
| luma_weight_10_flag[ref_idx_l0 [ x0 ][ y0 ] ] = = 0 && | |
| luma_weight_11_flag[ref_idx_l1 [ x0 ][ y0 ] ] = = 0 && | |
| chroma_weight_l0_flag[ref_idx_l0 [ x0 ][ y0 ] ] = = 0 && | |
| chroma_weight_l1_flag[ ref_idx_l1 [ x0 ][ y0 ] ] = = 0 && | |
| cbWidth * cbHeight >= 256) | |
| bcw_idx[ x0 ][ y0 ] | ae(v) |
| } | |
| } | |
| if( CuPredMode[chType ][ x0 ][ y0 ] != MODE_INTRA | |
| && !pred_mode_plt_flag && | |
| general_merge_flag[ x0 ][ y0 ] = = 0 ) | |
| cu_cbf | ae(v) |
| if( cu_cbf ) { | |
| if( CuPredMode[ chType ][ x0 ][ y0 ] = = MODE _INTER && | |
| sps_sbt_enabled_flag | |
| && !clip_flag[ x0 ][ y0 ] && !MergeTriangleFlag[ x0 ][ y0 ] ) { | |
| if( cbWidth <= MaxSbtSize && cbHeight <= MaxSbtSize ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH \| \| allowSbtVerQ \| \| | |
| allowSbtHorQ ) | |
| cu_sbt_flag | ae(v) |
| } | |
| if( cu_sbt_flag ) { | |
| if( ( allowSbtVerH \| \| allowSbtHorH) && ( allowSbtVerQ \| \| | |
| allowSbtHorQ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| cu_sbt_pos_flag | ae(v) |
| } | |
| } | |
| LfnstDcOnly = 1 | |
| LfnstZeroOutSigCoeffFlag = 1 | |
| transform_tree( x0, y0, cbWidth, cbHeight, treeType ) | |
| lfnstWidth = ( treeType = = | |
| DUAL_TREE_CHROMA ) ? cbWidth / SubWidthC | |
| : cbWidth | |
| lfnstHeight = ( treeType = = | |
| DUAL_TREE_CHROMA ) ? cbHeight / SubHeightC | |
| : cbHeight | |
| if( Min( lfnstWidth, lfnstHeight ) >= 4 && sps_lfnst_enabled_flag = = 1 | |
| && | |
| CuPredMode[ chType ][ x0 ][ y0 ] = = MODE_INTRA && | |
| IntraSubPartitionsSplitType = = ISP_NO_SPLIT && | |
| ( !intra mip flag[ x0 ][ y0 ] \| \| Min( lfnstWidth, lfnstHeight ) >= 16 ) && | |
| tu_mts_idx[ x0 ][ y0 ] = = 0 && Max( cbWidth, cbHeight ) <= | |
| MaxTbSizeY) { | |
| if( LfnstDcOnly = = 0 && LfnstZeroOutSigCoeffFlag = = 1) | |
| lfnst_idx[ x0 ][ y0 ] | ae(v) |
| } | |
| } | |

Coding Unit Semantics

The following assignments are made for x=x0 . . . x0+cbWidth−1 and y=y0 . . . y0+cbHeight−1:

CbPosX[chType][x][y]=x0 (7-134)

CbPosY[chType][x][y]=y0 (7-135)

CbWidth[chType][x][y]=cbWidth (7-136)

CbHeight[chType][x][y]=cbHeight (7-137)

CqtDepth[chType][x][y]=cqtDepth (7-138)

The variable CclmEnabled is derived by invoking the cross-component chroma intra prediction mode checking process specified in clause 8.4.4 with the luma location (xCb, yCb) set equal to (x0, y0) as input.

cu_skip_flag[x0][y0] equal to 1 specifies that for the current coding unit, when decoding a P or B slice, no more syntax elements except one or more of the following are parsed after cu_skip_flag[x0][y0]: the IBC mode flag pred_mode_ibc_flag[x0][y0], and the merge_data( ) syntax structure; when decoding an I slice, no more syntax elements except merge_idx[x0][y0] are parsed after cu_skip_flag[x0][y0]. cu_skip_flag[x0][y0] equal to 0 specifies that the coding unit is not skipped. The array indices x0, y0 specify the location (x0, y0) of the top-left luma sample of the considered coding block relative to the top-left luma sample of the picture.

When cu_skip_flag[x0][y0] is not present, it is inferred to be equal to 0.

pred_mode_flag equal to 0 specifies that the current coding unit is coded in inter prediction mode. pred_mode_flag equal to 1 specifies that the current coding unit is coded in intra prediction mode.

When pred_mode_flag is not present, it is inferred as follows:
If cbWidth is equal to 4 and cbHeight is equal to 4, pred_mode_flag is inferred to be equal to 1.
Otherwise, if modeType is equal to MODE_TYPE_INTRA, pred_mode_flag is inferred to be equal to 1.
Otherwise, if modeType is equal to MODE_TYPE_INTER, pred_mode_flag is inferred to be equal to 0.
Otherwise, pred_mode_flag is inferred to be equal to 1 when decoding an I slice, and equal to 0 when decoding a P or B slice, respectively.

The variable CuPredMode[chType][x][y] is derived as follows for x=x0 . . . x0+cbWidth−1 and y=y0 . . . y0+cbHeight−1:
If pred_mode_flag is equal to 0, CuPredMode[chType][x][y] is set equal to MODE INTER.
Otherwise (pred_mode_flag is equal to 1), CuPredMode[chType][x][y] is set equal to MODE INTRA.

pred_mode_ibc_flag equal to 1 specifies that the current coding unit is coded in IBC prediction mode. pred_mode_ibc_flag equal to 0 specifies that the current coding unit is not coded in IBC prediction mode.

When pred_mode_ibc_flag is not present, it is inferred as follows:
If cu_skip_flag[x0][y0] is equal to 1, and cbWidth is equal to 4, and cbHeight is equal to 4, pred_mode_ibc_flag is inferred to be equal 1.
Otherwise, if both cbWidth and cbHeight are equal to 128, pred_mode_ibc_flag is inferred to be equal to 0.
Otherwise, if modeType is equal to MODE_TYPE_INTER, pred_mode_ibc_flag is inferred to be equal to 0.
Otherwise, if treeType is equal to DUAL TREE CHROMA, pred_mode_ibc_flag is inferred to be equal to 0.
Otherwise, pred_mode_ibc_flag is infered to be equal to the value of sps_ibc_enabled_flag when decoding an I slice, and 0 when decoding a P or B slice, respectively.

When pred_mode_ibc_flag is equal to 1, the variable CuPredMode[chType][x][y] is set to be equal to MODE_IBC for x=x0 . . . x0+cbWidth−1 and y=y0 . . . y0+cbHeight−1.

pred_mode_plt_flag specifies the use of palette mode in the current coding unit. pred_modeplt_flag equal to 1 indicates that palette mode is applied in the current coding unit. pred_mode_plt_flag equal to 0 indicates that palette mode is not applied in the current coding unit. When pred_mode_plt_flag is not present, it is inferred to be equal to 0.

When pred_mode_plt_flag is equal to 1, the variable CuPredMode[x][y] is set to be equal to MODE_PLT for x=x0 . . . x0+cbWidth−1 and y=y0 . . . y0+cbHeight−1.

intra_bdpcm_flag equal to 1 specifies that BDPCM is applied to the current luma coding block at the location (x0, y0), i.e. the transform is skipped, the intra luma prediction mode is specified by intra_bdpcm_dir_flag. intra_bdpcm_flag equal to 0 specifies that BDPCM is not applied to the current luma coding block at the location (x0, y0).

When intra_bdpcm_flag is not present it is inferred to be equal to 0.

The variable BdpcmFlag[x][y] is set equal to intra_bdpcm_flag for x=x0 . . . x0+cbWidth−1 and y=y0 . . . y0+cbHeight−1.

intra_bdpcm_dir_flag equal to 0 specifies that the BDPCM prediction direction is horizontal. intra_bdpcm_dir_flag equal to 1 specifies that the BDPCM prediction direction is vertical.

The variable BdpcmDir[x][y] is set equal to intra_bdpcm_dir_flag for x=x0 . . . x0+cbWidth−1 and y=y0 . . . y0+cbHeight−1.

intra_mip_flag[x0][y0] equal to 1 specifies that the intra prediction type for luma samples is matrix-based intra prediction. intra_mip_flag[x0][y0] equal to 0 specifies that the intra prediction type for luma samples is not matrix-based intra prediction.

When intra_mip_flag[x0][y0] is not present, it is inferred to be equal to 0.

intra_mip_transposed[x0][y0] specifies whether the input vector for matrix-based intra prediction mode for luma samples is transposed or not.

intra_mip_mode[x0][y0] specifies the matrix-based intra prediction mode for luma samples. The array indices x0, y0 specify the location (x0, y0) of the top-left luma sample of the considered coding block relative to the top-left luma sample of the picture.

intra_luma_ref_idx[x0][y0] specifies the intra prediction reference line index IntraLumaRefLineIdx[x][y] for x=x0 . . . x0+cbWidth−1 and y=y0 . . . y0+cbHeight−1 as specified in Table 7-15.

When intra_luma_ref_idx[x0][y0] is not present it is inferred to be equal to 0.

TABLE 7-15

| Specification of IntraLumaRefLineIdx[x][y] | |
|---|---|
| based on intra_luma_ref_idx[x0][y0]. | |
| | IntraLumaRefLineIdx[x][y] |
| | x = x0. . x0 + cbWidth − 1 |
| intra_luma_ref_idx[x0][y0] | y = y0. . y0 + cbHeight − 1 |
| 0 | 0 |
| 1 | 1 |
| 2 | 3 |

intra_subpartitions_mode_flag[x0][y0] equal to 1 specifies that the current intra coding unit is partitioned into NumIntraSubPartitions[x0][y0] rectangular transform block subpartitions. intra_subpartitions_mode_flag[x0][y0] equal to 0 specifies that the current intra coding unit is not partitioned into rectangular transform block subpartitions.

When intra_subpartitions_mode_flag[x0][y0] is not present, it is inferred to be equal to 0.

intra_subpartitions_split_flag[x0][y0] specifies whether the intra subpartitions split type is horizontal or vertical. When intra subpartitions split flag[x0][y0] is not present, it is inferred as follows:
If cbHeight is greater than MaxTbSizeY, intra_subpartitions_split_flag[x0][y0] is inferred to be equal to 0.
Otherwise (cbWidth is greater than MaxTbSizeY), intra_subpartitions_split_flag[x0][y0] is inferred to be equal to 1.

The variable IntraSubPartitionsSplitType specifies the type of split used for the current luma coding block as illustrated in Table 7-16. IntraSubPartitionsSplitType is derived as follows:
If intra_subpartitions_mode_flag[x0][y0] is equal to 0, IntraSubPartitionsSplitType is set equal to 0.
Otherwise, the IntraSubPartitionsSplitType is set equal to 1+intra_subpartitions_split_flag[x0][y0].

TABLE 7-16
Name association to IntraSubPartitionsSplitType

| IntraSubPartitionsSplitType | Name of IntraSubPartitionsSplitType |
|---|---|
| 0 | ISP_NO_SPLIT |
| 1 | ISP_HOR_SPLIT |
| 2 | ISP_VER_SPLIT |

The variable NumIntraSubPartitions specifies the number of transform block subpartitions into which an intra luma coding block is divided. NumIntraSubPartitions is derived as follows:
If IntraSubPartitionsSplitType is equal to ISP_NO_SPLIT, NumIntraSubPartitions is set equal to 1.
Otherwise, if one of the following conditions is true, NumIntraSubPartitions is set equal to 2:
   cbWidth is equal to 4 and cbHeight is equal to 8,
   cbWidth is equal to 8 and cbHeight is equal to 4.
Otherwise, NumIntraSubPartitions is set equal to 4.

The syntax elements intra_luma_mpm_flag[x0][y0], intra_luma_not_planar_flag[x0][y0], intra_luma_mpm_idx[x0][y0] and intra_luma_mpm_remainder[x0][y0] specify the intra prediction mode for luma samples. The array indices x0, y0 specify the location (x0, y0) of the top-left luma sample of the considered coding block relative to the top-left luma sample of the picture. When intra_luma_mpm_flag[x0][y0] is equal to 1, the intra prediction mode is inferred from a neighbouring intra-predicted coding unit according to clause 8.4.2.

When intra_luma_mpm_flag[x0][y0] is not present, it is inferred to be equal to 1.

When intra_luma_not_planar_flag[x0][y0] is not present, it is inferred to be equal to 1.

cclm_mode_flag equal to 1 specifies that one of the INTRA_LT_CCLM, INTRA_L_CCLM and INTRA_T_CCLM intra chroma prediction modes is applied. cclm_mode_flag equal to 0 specifies that none of the INTRA_LT_CCLM, INTRA_L_CCLM and INTRA_T_CCLM intra chroma prediction modes is applied.

When cclm_mode_flag is not present, it is inferred to be equal to 0.

cclm_mode_idx specifies which one of the INTRA_LT_CCLM, INTRA_L_CCLM and INTRA_T_CCLM intra chroma prediction modes is applied.

intra_chroma_pred_mode specifies the intra prediction mode for chroma samples. When intra_chroma_pred_mode is not present, it is inferred to be equal to 0.

general_merge_flag[x0][y0] specifies whether the inter prediction parameters for the current coding unit are inferred from a neighbouring inter-predicted partition. The array indices x0, y0 specify the location (x0, y0) of the top-left luma sample of the considered coding block relative to the top-left luma sample of the picture.

When general merge flag[x0][y0] is not present, it is inferred as follows:
If cu_skip_flag[x0][y0] is equal to 1, general merge flag[x0][y0] is inferred to be equal to 1.
Otherwise, general_merge_flag[x0][y0] is inferred to be equal to 0.

mvp_l0_flag[x0][y0] specifies the motion vector predictor index of list 0 where x0, y0 specify the location (x0, y0) of the top-left luma sample of the considered coding block relative to the top-left luma sample of the picture.

When mvp_l0_flag[x0][y0] is not present, it is inferred to be equal to 0.

mvp_l1_flag[x0][y0] has the same semantics as mvp_l0_flag, with l0 and list 0 replaced by l1 and list 1, respectively.

inter_pred_idc[x0][y0] specifies whether list0, list1, or bi-prediction is used for the current coding unit according to Table 7-17. The array indices x0, y0 specify the location (x0, y0) of the top-left luma sample of the considered coding block relative to the top-left luma sample of the picture.

TABLE 7-17
Name association to inter prediction mode

| | Name of inter_pred_idc | | |
|---|---|---|---|
| inter_pred_idc | (cbWidth + cbHeight ) >12 | ( cbWidth + cbHeight ) = = 12 | ( cbWidth + cbHeight ) = = 8 |
| 0 | PRED_L0 | PRED_L0 | n. a. |
| 1 | PRED_L1 | PRED_L1 | n. a. |
| 2 | PRED_B1 | n. a. | n. a. |

When inter_pred_idc[x0][y0] is not present, it is inferred to be equal to PRED_L0.

sym_mvd_flag[x0][y0] equal to 1 specifies that the syntax elements ref_idx_l0[x0][y0] and ref_idx_l1[x0][y0], and the mvd_coding(x0, y0, refList, cpIdx) syntax structure for refList equal to 1 are not present. The array indices x0, y0 specify the location (x0, y0) of the top-left luma sample of the considered coding block relative to the top-left luma sample of the picture.

When sym_mvd_flag[x0][y0] is not present, it is inferred to be equal to 0.

ref_idx_l0[x0][y0] specifies the list 0 reference picture index for the current coding unit. The array indices x0, y0 specify the location (x0, y0) of the top-left luma sample of the considered coding block relative to the top-left luma sample of the picture.

When ref_idx_l0[x0][y0] is not present it is inferred as follows:
If sym_mvd_flag[x0][y0] is equal to 1, ref_idx_l0[x0][y0] is inferred to be equal to RefIdxSymL0.
Otherwise (sym_mvd_flag[x0][y0] is equal to 0), ref_idx_l0[x0][y0] is inferred to be equal to 0.

ref_idx_l1[x0][y0] has the same semantics as ref_idx_l0, with l0, L0 and list 0 replaced by l1, L1 and list 1, respectively.

inter_affine_flag[x0][y0] equal to 1 specifies that for the current coding unit, when decoding a P or B slice, affine model based motion compensation is used to generate the prediction samples of the current coding unit. inter affine flag[x0][y0] equal to 0 specifies that the coding unit is not predicted by affine model based motion compensation. When inter affine flag[x0][y0] is not present, it is inferred to be equal to 0.

cu_affine_type_flag[x0][y0] equal to 1 specifies that for the current coding unit, when decoding a P or B slice, 6-parameter affine model based motion compensation is used to generate the prediction samples of the current coding unit. cu_affine_type_flag[x0][y0] equal to 0 specifies that 4-parameter affine model based motion compensation is used to generate the prediction samples of the current coding unit.

MotionModelIdc[x][y] represents motion model of a coding unit as illustrated in Table 7-18. The array indices x, y specify the luma sample location (x, y) relative to the top-left luma sample of the picture.

The variable MotionModelIdc[x][y] is derived as follows for x=x0 . . . x0+cbWidth−1 and y=y0 . . . y0+cbHeight−1:
If general_merge_flag[x0][y0] is equal to 1, the following applies:

MotionModelIdc[x][y]=merge_subblock_flag[x0][y0] (7-139)
Otherwise (general_merge_flag[x0][y0] is equal to 0), the following applies:

MotionModelIdc[x][y]=inter_affine_flag[x0][y0]+cu_affine_type_flag[x0][y0] (7-140)

TABLE 7-18
Interpretation of MotionModelIdc[x0][y0]

| | Motion model for |
|---|---|
| MotionModelIdc[x][y] | motion compensation |
| 0 | Translational motion |
| 1 | 4-parameter affine motion |
| 2 | 6-parameter affine motion |

amvr_flag[x0][y0] specifies the resolution of motion vector difference. The array indices x0, y0 specify the location (x0, y0) of the top-left luma sample of the considered coding block relative to the top-left luma sample of the picture. amvr_flag[x0][y0] equal to 0 specifies that the resolution of the motion vector difference is ¼ of a luma sample. amvr_flag[x0][y0] equal to 1 specifies that the resolution of the motion vector difference is further specified by amvr_precision_flag[x0][y0].

When amvr_flag[x0][y0] is not present, it is inferred as follows:
If CuPredMode[chType][x0][y0] is equal to MODE_IBC, amvr_flag[x0][y0] is inferred to be equal to 1.
Otherwise (CuPredMode[chType][x0][y0] is not equal to MODE_IBC), amvr_flag[x0][y0] is inferred to be equal to 0.

amvr_precision_idx[x0][y0] equal to 0 specifies that the resolution of the motion vector difference with AmvrShift as defined in Table 7-19. The array indices x0, y0 specify the location (x0, y0) of the top-left luma sample of the considered coding block relative to the top-left luma sample of the picture.

When amvr_precision_flag[x0][y0] is not present, it is inferred to be equal to 0.

The motion vector differences are modified as follows:
If inter_affine_flag[x0][y0] is equal to 0, the variables MvdL0[x0][y0][0], MvdL0[x0][y0][1], MvdL1[x0][y0][0], MvdL1[x0][y0][1] are modified as follows:

MvdL0[x0][y0][0]=MvdL0[x0][y0][0]<<AmvrShift (7-141)

MvdL0[x0][y0][1]=MvdL0[x0][y0][1]<<AmvrShift (7-142)

MvdL1[x0][y0][0]=MvdL1[x0][y0][0]<<AmvrShift (7-143)

MvdL1[x0][y0][1]=MvdL1[x0][y0][1]<<AmvrShift (7-144)
Otherwise (inter_affine_flag[x0][y0] is equal to 1), the variables MvdCpL0[x0][y0][0][0], MvdCpL0[x0][y0][0][1], MvdCpL0[x0][y0][1][0], MvdCpL0[x0][y0][1][1], MvdCpL0[x0][y0][2][0] and MvdCpL0[x0][y0][2][1] are modified as follows:

MvdCpL0[x0][y0][0][0]=MvdCpL0[x0][y0][0][0]<<AmvrShift (7-145)

MvdCpL1[x0][y0][0][1]=MvdCpL1[x0][y0][0][1]<<AmvrShift (7-146)

MvdCpL0[x0][y0][1][0]=MvdCpL0[x0][y0][1][0]<<AmvrShift (7-147)

MvdCpL1[x0][y0][1][1]=MvdCpL1[x0][y0][1][1]<<AmvrShift (7-148)

MvdCpL0[x0][y0][2][0]=MvdCpL0[x0][y0][2][0]<<AmvrShift (7-149)

MvdCpL1[x0][y0][2][1]=MvdCpL1[x0][y0][2][1]<<AmvrShift (7-150)

TABLE 7-19
Specification of Amyl-Shift.

| | | AmvrShift | | |
|---|---|---|---|---|
| | | | | inter_affine_flag = = 0 |
| | | | | & & |
| | | | CuPredMode[chType][x0] | CuPredMode[chType][x0] |
| amvr_flag | amvr_precision_idx | inter_affine_flag = = 1 | [y0] = = MODE_IBC) | [y0] ! = MODE_IBC |
| 0 | — | 2 (1/4 luma sample) | — | 2 (1/4 luma sample) |
| 1 | 0 | 0 (1/16 luma sample) | 4 (1 luma sample) | 3 (1/2 luma sample) |
| 1 | 1 | 4 (1 luma sample) | 6 (4 luma samples) | 4 (1 luma sample) |
| 1 | 2 | — | — | 6 (4 luma samples) |

bcw_idx[x0][y0] specifies the weight index of bi-prediction with CU weights. The array indices x0, y0 specify the location (x0, y0) of the top-left luma sample of the considered coding block relative to the top-left luma sample of the picture.

When bcw_idx[x0][y0] is not present, it is inferred to be equal to 0.

cu_cbf equal to 1 specifies that the transform_tree( ) syntax structure is present for the current coding unit. cu_cbf equal to 0 specifies that the transform_tree( ) syntax structure is not present for the current coding unit.

When cu_cbf is not present, it is inferred as follows:
If cu_skip_flag[x0][y0] is equal to 1 or pred_modeplt_flag is equal to 1, cu_cbf is inferred to be equal to 0.
Otherwise, cu_cbf is inferred to be equal to 1.

cu_sbt_flag equal to 1 specifies that for the current coding unit, subblock transform is used. cu_sbt_flag equal to 0 specifies that for the current coding unit, subblock transform is not used.

When cu_sbt_flag is not present, its value is inferred to be equal to 0.
NOTE—: When subblock transform is used, a coding unit is split into two transform units; one transform unit has residual data, the other does not have residual data.

cu_sbt_quad_flag equal to 1 specifies that for the current coding unit, the subblock transform includes a transform unit of ¼ size of the current coding unit. cu_sbt_quad_flag equal to 0 specifies that for the current coding unit the subblock transform includes a transform unit of ½ size of the current coding unit.

When cu_sbt_quad_flag is not present, its value is inferred to be equal to 0.

cu_sbt_horizontal_flag equal to 1 specifies that the current coding unit is split horizontally into 2 transform units. cu_sbt_horizontal_flag[x0][y0] equal to 0 specifies that the current coding unit is split vertically into 2 transform units.

When cu_sbt_horizontal_flag is not present, its value is derived as follows:
If cu_sbt_quad_flag is equal to 1, cu_sbt_horizontal_flag is set to be equal to allowSbtHorQ.
Otherwise (cu_sbt_quad_flag is equal to 0), cu_sbt_horizontal_flag is set to be equal to allowSbtHorH.

cu_sbt_pos_flag equal to 1 specifies that the tu_cbf_luma, tu_cbf_cb and tu_cbf_cr of the first transform unit in the current coding unit are not present in the bitstream. cu_sbt_pos_flag equal to 0 specifies that the tu_cbf_luma, tu_cbf_cb and tu_cbf_cr of the second transform unit in the current coding unit are not present in the bitstream.

The variable SbtNumFourthsTb0 is derived as follows:

sbtMinNumFourths=cu_sbt_quad_flag?1:2 (7-151)

SbtNumFourthsTb0=cu_sbt_pos_flag?(4−sbtMinNumFourths):sbtMinNumFourths (7-152)

lfnst_idx[x0][y0] specifies whether and which one of the two low frequency non-separable transform kernels in a selected transform set is used. lfnst_idx[x0][y0] equal to 0 specifies that the low frequency non-separable transform is not used. The array indices x0, y0 specify the location (x0, y0) of the top-left sample of the considered transform block relative to the top-left sample of the picture.

When lfnst_idx[x0][y0] is not present, it is inferred to be equal to 0.

When ResetIbcBuf is equal to 1, the following applies:
For x=0 . . . IbcBufWidthY−1 and y=0 . . . CtbSizeY−1, the following assignments are made:

IbcVirBuf[0][x][y]=−1 (7-153)
The variable ResetIbcBuf is set equal to 0.

When x0% VSize is equal to 0 and y0% VSize is equal to 0, the following assignments are made for x=x0 . . . x0+VSize−1 and y=y0 . . . y0+VSize−1:

IbcVirBuf[0][x % IbcBufWidthY][y % CtbSizeY]=−1 (7-154)

Decoding Process for Coding Units Coded in Intra Prediction Mode

General Decoding Process for Coding Units Coded in Intra Prediction Mode

Inputs to this process are:
a luma location (xCb, yCb) specifying the top-left sample of the current coding block relative to the top-left luma sample of the current picture,
a variable cbWidth specifying the width of the current coding block in luma samples,
a variable cbHeight specifying the height of the current coding block in luma samples,
a variable treeType specifying whether a single or a dual tree is used and if a dual tree is used, it specifies whether the current tree corresponds to the luma or chroma components.

Output of this process is a modified reconstructed picture before in-loop filtering.

The derivation process for quantization parameters as specified in clause 8.7.1 is invoked with the luma location (xCb, yCb), the width of the current coding block in luma samples cbWidth and the height of the current coding block in luma samples cbHeight, and the variable treeType as inputs.

When treeType is equal to SINGLE TREE or treeType is equal to DUAL TREE LUMA, the decoding process for luma samples is specified as follows:
If pred_modeplt_flag is equal to 1, the following applies:
   The general decoding process for palette blocks as specified in clause 8.4.5.3 is invoked with the luma location (xCb, yCb), the variable startComp set equal to 0, the variable cIdx set to 0, the variable nCbW set equal to cbWidth, the variable nCbH set equal to cbHeight.
Otherwise (pred_modeplt_flag is equal to 0), the following applies:
   1. The variable MipSizeId[x][y] for x=xCb . . . xCb+cbWidth−1 and y=yCb . . . yCb+cbHeight−1 is derived as follows:
      If both cbWidth and cbHeight are equal to 4, MipSizeId[x][y] is set equal to 0.
      Otherwise, if both cbWidth and cbHeight are less than or equal to 8, MipSizeId[x][y] is set equal to 1.
      Otherwise, MipSizeId[x][y] is set equal to 2.
   2. The luma intra prediction mode is derived as follows:
      If intra_mip_flag[xCb][yCb] is equal to 1, IntraPredModeY[x][y] with x=xCb . . . xCb+cbWidth−1 and y=yCb . . . yCb+cbHeight−1 is set to be equal to intra_mip_mode[xCb][yCb] and isTransposed is set equal to intra_mip_transposed[xCb][yCb].
      Otherwise, the derivation process for the luma intra prediction mode as specified in clause 8.4.2 is invoked with the luma location (xCb, yCb), the width of the current coding block in luma samples cbWidth and the height of the current coding block in luma samples cbHeight as input.
   3. The variable predModeIntra is set equal to IntraPredModeY[xCb][yCb].
   4. The general decoding process for intra blocks as specified in clause 8.4.5.1 is invoked with the sample location (xTb0, yTb0) set equal to the luma location (xCb, yCb), the variable nTbW set equal to cbWidth, the variable nTbH set equal to cbHeight, predModeIntra, and the variable cIdx set equal to 0 as inputs, and the output is a modified reconstructed picture before in-loop filtering.

When treeType is equal to SINGLE_TREE or treeType is equal to DUAL_TREE_CHROMA, and when ChromaArrayType is not equal to 0, the decoding process for chroma samples is specified as follows:
If pred_mode_plt_flag is equal to 1, the following applies:
   The general decoding process for palette blocks as specified in clause 8.4.5.3 is invoked with the luma location (xCb, yCb), the variable startComp set equal to 0, the variable cIdx set to 1, the variable nCbW set equal to (cbWidth/SubWidthC), the variable nCbH set equal to (cbHeight/SubHeightC).
   The general decoding process for palette blocks as specified in clause 8.4.5.3 is invoked with the luma location (xCb, yCb), the variable startComp set equal to 0, the variable cIdx set to 2, the variable nCbW set equal to (cbWidth/SubWidthC), the variable nCbH set equal to (cbHeight/SubHeightC).
Otherwise (pred_modeplt_flag is equal to 0), the following applies:
   1. The derivation process for the chroma intra prediction mode as specified in clause 8.4.3 is invoked with the luma location (xCb, yCb), the width of the current coding block in luma samples cbWidth and the height of the current coding block in luma samples cbHeight as input.
   2. The general decoding process for intra blocks as specified in clause 8.4.5.1 is invoked with the sample location (xTb0, yTb0) set equal to the chroma location (xCb/SubWidthC, yCb/SubHeightC), the variable nTbW set equal to (cbWidth/SubWidthC), the variable nTbH set equal to (cbHeight/SubHeightC), the variable predModeIntra set equal to IntraPredModeC[xCb][yCb], and the variable cIdx set equal to 1, and the output is a modified reconstructed picture before in-loop filtering.
   3. The general decoding process for intra blocks as specified in clause 8.4.5.1 is invoked with the sample location (xTb0, yTb0) set equal to the chroma location (xCb/SubWidthC, yCb/SubHeightC), the variable nTbW set equal to (cbWidth/SubWidthC), the variable nTbH set equal to (cbHeight/SubHeightC), the variable predModeIntra set equal to IntraPredModeC[xCb][yCb], and the variable cIdx set equal to 2, and the output is a modified reconstructed picture before in-loop filtering.

Matrix-Based Intra Sample Prediction

Inputs to this process are:
a sample location (xTbCmp, yTbCmp) specifying the top-left sample of the current transform block relative to the top-left sample of the current picture,
a variable predModeIntra specifying the intra prediction mode,
a variable isTransposed specifying the required input reference vector order,
a variable nTbW specifying the transform block width,
a variable nTbH specifying the transform block height.

Outputs of this process are the predicted samples predSamples[x][y], with x=0 . . . nTbW−1, y=0 . . . nTbH−1.

Variables numModes, boundarySize, predW, predH and predC are derived using MipSizeId[xTbCmp][yTbCmp] as specified in Table 8-4.

TABLE 8-4
Specification of number of prediction modes
numModes, boundary size boundarySize, and
prediction sizes predW, predH and predC using MipSizeId

| MipSizeId | numModes | boundarySize | predW | predH | predC |
|---|---|---|---|---|---|
| 0 | 12 | 2 | 4 | 4 | 4 |
| 1 | 12 | 4 | 4 | 4 | 4 |
| 2 | 12 | 4 | Min | Min | 8 |
| | | | (nTbW, 8) | (nTbH, 8) | |

The variable inSize is derived as follows:

inSize=(2*boundary Size)−(MipSizeId[xTbCmp][yTbCmp]==2)?1:0 (8-22)

The variables mipW and mipH are derived as follows:

mipW=isTransposed?predH:predW (8-23)

mipH=isTransposed?predW:predH (8-24)

For the generation of the reference samples refT[x] with x=0 . . . nTbW−1 and refL[y] with y=0 . . . nTbH−1, the following applies:
The reference sample availability marking process as specified in clause 8.4.5.2.7 is invoked with the sample location (xTbCmp, yTbCmp), reference line index equal to 0, the reference sample width nTbW, the reference sample height nTbH, colour component index equal to 0 as inputs, and the reference samples refUnfilt[x][y] with x=−1, y=−1 . . . nTbH−1 and x=0 . . . nTbW−1, y=−1 as output.
When at least one sample refUnfilt[x][y] with x=−1, y=−1 . . . nTbH−1 and x=0 . . . nTbW−1, y=−1 is marked as “not available for intra prediction”, the reference sample substitution process as specified in clause 8.4.5.2.8 is invoked with reference line index 0, the reference sample width nTbW, the reference sample height nTbH, the reference samples refUnfilt[x][y] with x=−1, y=−1 . . . nTbH−1 and x=0 . . . nTbW−1, y=−1, and colour component index 0 as inputs, and the modified reference samples refUnfilt[x][y] with x=−1, y=−1 . . . nTbH−1 and x=0 . . . nTbW−1, y=−1 as output.
The reference samples refT[x] with x=0 . . . nTbW−1 and refL[y] with y=0 . . . nTbH−1 are assigned as follows:

refT[x]=refUnfilt[x][−1] (8-25)

refL[y]=refUnfilt[−1][y] (8-26)

For the generation of the input samples p[x] with x=0 . . . 2*inSize−1, the following applies:
The MIP boundary downsampling process as specified in clause 8.4.5.2.2 is invoked for the top reference samples with the block size nTbW, the reference samples refT[x] with x=0 . . . nTbW−1, and the boundary size boundarySize as inputs, and reduced boundary samples redT[x] with x=0 . . . boundarySize−1 as outputs.
The MIP boundary downsampling process as specified in clause 8.4.5.2.2 is invoked for the left reference samples with the block size nTbH, the reference samples refL[y] with y=0 . . . nTbH−1, and the boundary size boundarySize as inputs, and reduced boundary samples redL[x] with x=0 . . . boundarySize−1 as outputs.
The reduced top and left boundary samples redT and redL are assigned to the boundary sample array pTemp[x] with x=0 . . . 2*boundarySize−1 as follows:
   If isTransposed is equal to 1, pTemp[x] is set equal to redL[x] with x=0 . . . boundarySize−1 and pTemp[x+boundarySize] is set equal to redT[x] with x=0 . . . boundarySize−1.
   Otherwise, pTemp[x] is set equal to redT[x] with x=0 . . . boundarySize−1 and pTemp[x+boundarySize] is set equal to redL[x] with x=0 . . . boundarySize−1.
The input values p[x] with x=0 . . . inSize−1 are derived as follows:
   If MipSizeId[xTbCmp][yTbCmp] is equal to 2, the following applies:

p[x]=pTemp[x+1]−pTemp[0] (8-27)
Otherwise (MipSizeId[xTbCmp][yTbCmp] is less than 2), the following applies:

p[0]=pTemp[0]−(1<<(BitDepth_{Y}−1))

p[x]=pTemp[x]−pTemp[0] for x=1 . . . inSize−1 (8-28)

For the intra sample prediction process according to predModeIntra, the following ordered steps apply:
1. The matrix-based intra prediction samples predMip[x][y], with x=0 . . . mipW−1, y=0 . . . mipH−1 are derived as follows:
   The variable modeId is set equal to predModeIntra.
   The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.
   The variable sW is derived using MipSizeId[xTbCmp][yTbCmp] and modeId as specified in Table 8-5.
   The variable sO is set equal to 46.
   The matrix-based intra prediction samples predMip[x][y], with x=0 . . . mipW−1, y=0 . . . mipH−1 are derived as follows:

oW=(1<<(sW−1))−sO*(Σᵢ₌₀^{inSize-1}p[i]) (8-29)

incW=(predC>mipW)?2:1 (8-30)

incH=(predC>mipH)?2:1 (8-31)

predMip[x][y]=(((Σᵢ₌₀^{inSize-1}mWeight[i][y*incH*predC+x*incW]*p[i])+oW)>>sW)+pTemp[0] (8-32)
2. The matrix-based intra prediction samples predMip[x][y], with x=0 . . . mipW−1, y=0 . . . mipH−1 are clipped as follows:

predMip[x][y]=Clip1_{Y}(predMip[x][y]) (8-33)
3. When isTransposed is equal to TRUE, the predH×predW array predMip[x][y] with x=0 . . . predH−1, y=0 . . . predW−1 is transposed as follows:

predTemp[y][x]=predMip[x][y] (8-34)

predMip=predTemp (8-35)
4. The predicted samples predSamples[x][y], with x=0 . . . nTbW−1, y=0 . . . nTbH−1 are derived as follows:
   If nTbW is greater than predW or nTbH is greater than predH, the MIP prediction upsampling process as specified in clause 8.4.5.2.4 is invoked with the input block width predW, the input block height predH, matrix-based intra prediction samples predMip[x][y] with x=0 . . . predW−1, y=0 . . . predH−1, the transform block width nTbW, the transform block height nTbH, the top reference samples refT[x] with x=0 . . . nTbW−1, and the left reference samples refL[y] with y=0 . . . nTbH−1 as inputs, and the output is the predicted sample array predSamples.
   Otherwise, predSamples[x][y], with x=0 . . . nTbW−1, y=0 . . . nTbH−1 is set equal to predMip[x][y].

TABLE 8-5
Specification of weight shift sW depending on MipSizeId
and modeId

| | modeId | | | | | |
|---|---|---|---|---|---|---|
| MipSizeId | 0 | 1 | 2 | 3 | 4 | 5 |
| 0 | 6 | 6 | 6 | 6 | 6 | 6 |
| 1 | 6 | 6 | 7 | 6 | 6 | 6 |
| 2 | 7 | 5 | 6 | 6 | 6 | 6 |

MIP Boundary Sample Downsampling Process

Inputs to this process are:
a variable nTbS specifying the transform block size,
reference samples refS[x] with x=0 . . . nTbS−1,
a variable boundarySize specifying the downsampled boundary size.

Outputs of this process are the reduced boundary samples redS[x] with x=0 . . . boundarySize−1 and upsampling boundary samples upsBdryS[x] with x=0 . . . upsBdrySize−1.

The reduced boundary samples redS[x] with x=0 . . . boundarySize−1 are derived as follows:
If boundarySize is less than nTbs, the following applies:

bDwn=nTbs/boundarySize (8-36)

redS[x]=(Σᵢ₌₀^{bDown-1}refS[x*bDwn+i]+(1<<(Log 2(bDwn)−1)))>>Log 2(bDwn) (8-37)
Otherwise (boundarySize is equal to nTbs), redS[x] is set equal to refS[x].

MIP Weight Matrix Derivation Process

Inputs to this process are:
a variable mipSizeId,
a variable modeId.

Output of this process is the MIP weight matrix mWeight[x][y].

The MIP weight matrix mWeight[x][y] is derived depending on mipSizeId and modeId as follows:
If mipSizeId is equal to 0 and modeId is equal to 0, the following applies:

mWeight[x][y]=mWeight00[x][y] (8-38)
with mWeight00 defined as:

$$mWeight00 [ x ] [ y ] = \{ \{ 47 , 46 , 101 , 49 \} , \{ 46 , 39 , 72 , 48 \} , \{ 46 , 51 , 41 , 45 \} , \{ 46 , 102 , 42 , 45 \} , \{ 46 , 46 , 112 , 45 \} , \{ 46 , 47 , 110 , 48 \} , \{ 46 , 40 , 89 , 48 \} , \{ 46 , 48 , 53 , 46 \} , \{ 47 , 46 , 94 , 61 \} , \{ 46 , 46 , 111 , 44 \} , \{ 46 , 48 , 113 , 46 \} , \{ 46 , 42 , 101 , 48 \} , \{ 45 , 45 , 41 , 116 \} , \{ 46 , 45 , 72 , 84 \} , \{ 46 , 46 , 101 , 53 \} , \{ 46 , 47 , 109 , 47 \} \} , \qquad ( 8 \text{-} 39 )$$

Otherwise, if mipSizeId is equal to 0 and modeId is equal to 1, the following applies:

mWeight[x][y]=mWeight01[x][y] (8-40)
with mWeight01 defined as:

$$mWeight01 [ x ] [ y ] = \{ \{ 47 , 70 , 116 , 31 \} , \{ 46 , 80 , 73 , 70 \} , \{ 44 , 61 , 53 , 97 \} , \{ 44 , 49 , 50 , 105 \} , \{ 43 , 50 , 55 , 104 \} , \{ 44 , 42 , 44 , 114 \} , \{ 44 , 43 , 49 , 109 \} , \{ 44 , 46 , 50 , 106 \} , \{ 45 , 46 , 45 , 109 \} , \{ 45 , 47 , 50 , 106 \} , \{ 44 , 48 , 49 , 106 \} , \{ 43 , 48 , 49 , 106 \} , \{ 45 , 47 , 50 , 106 \} , \{ 44 , 47 , 49 , 107 \} , \{ 44 , 47 , 49 , 107 \} , \{ 43 , 47 , 50 , 106 \} \} , \qquad ( 8 \text{-} 41 )$$

Otherwise, if mipSizeId is equal to 0 and modeId is equal to 2, the following applies:

mWeight[x][y]=mWeight02[x][y] (8-42)
with mWeight02 defined as:

$$mWeight02 [ x ] [ y ] = \{ \{ 46 , 43 , 106 , 45 \} , \{ 46 , 36 , 87 , 48 \} , \{ 46 , 33 , 62 , 47 \} , \{ 46 , 55 , 46 , 46 \} , \{ 46 , 46 , 113 , 43 \} , \{ 45 , 47 , 119 , 40 \} , \{ 44 , 44 , 117 , 41 \} , \{ 45 , 36 , 101 , 44 \} , \{ 46 , 45 , 63 , 92 \} , \{ 45 , 43 , 78 , 76 \} , \{ 44 , 44 , 96 , 59 \} , \{ 42 , 44 , 108 , 48 \} , \{ 43 , 43 , 39 , 116 \} , \{ 41 , 42 , 39 , 116 \} , \{ 40 , 41 , 42 , 111 \} , \{ 35 , 38 , 54 , 96 \} \} , \qquad ( 8 \text{-} 76 )$$

Otherwise, if mipSizeId is equal to 0 and modeId is equal to 3, the following applies:

mWeight[x][y]=mWeight03[x][y] (8-44)
with mWeight03 defined as:

$$mWeight03 [ x ] [ y ] = \{ \{ 46 , 44 , 105 , 33 \} , \{ 46 , 73 , 87 , 46 \} , \{ 44 , 93 , 50 , 73 \} , \{ 48 , 76 , 30 , 95 \} , \{ 47 , 50 , 84 , 82 \} , \{ 47 , 52 , 53 , 106 \} , \{ 49 , 47 , 45 , 113 \} , \{ 52 , 47 , 47 , 112 \} , \{ 48 , 47 , 41 , 114 \} , \{ 50 , 48 , 44 , 113 \} , \{ 51 , 50 , 46 , 111 \} , \{ 53 , 51 , 46 , 111 \} , \{ 50 , 48 , 48 , 110 \} , \{ 52 , 49 , 47 , 111 \} , \{ 53 , 50 , 46 , 112 \} , \{ 54 , 50 , 46 , 112 \} \} , \qquad ( 8 \text{-} 45 )$$

Otherwise, if mipSizeId is equal to 0 and modeId is equal to 4, the following applies:
   If y<4, a subset of mWeight00 matrix is used (see Equation mWeight00[x][y]=(8-39mWeight00[x][y]=(8-39)):

mWeight[x][y]=mWeight00[x][y] (8-46)
Otherwise, a subset of mWeight03 matrix is used (see Equation mWeight03[x][y]=(8-)):

mWeight[x][y]=mWeight03[x][y] (8-47)
Otherwise, if mipSizeId is equal to 0 and modeId is equal to 5, the following applies:
   If y<4, a subset of mWeight00 matrix is used (see Equation mWeight00[x][y]=(8-39mWeight00[x][y]=(8-39)):

mWeight[x][y]=mWeight00[x][y] (8-48)
Otherwise, a subset of mWeight02 matrix is used (see Equation mWeight02[x][y]=(8-76)):

mWeight[x][y]=mWeight02[x][y] (8-49)
Otherwise, if mipSizeId is equal to 1 and modeId is equal to 0, the following applies:

mWeight[x][y]=mWeight10[x][y] (8-50)
with mWeight10 defined as:

$$mWeight10 [ x ] [ y ] = \{ \{ 47 , 54 , 45 , 47 , 116 , 49 , 45 , 46 \} , \{ 47 , 61 , 50 , 45 , 114 , 41 , 47 , 46 \} , \{ 46 , 51 , 66 , 47 , 104 , 37 , 49 , 45 \} , \{ 46 , 48 , 43 , 79 , 89 , 38 , 49 , 45 \} , \{ 46 , 46 , 47 , 46 , 36 , 118 , 48 , 44 \} , \{ 46 , 47 , 47 , 47 , 46 , 118 , 39 , 47 \} , \{ 46 , 50 , 46 , 48 , 59 , 112 , 35 , 47 \} , \{ 46 , 49 , 48 , 51 , 73 , 98 , 37 , 47 \} , \{ 46 , 47 , 46 , 46 , 49 , 37 , 117 , 47 \} , \{ 46 , 48 , 47 , 47 , 45 , 49 , 114 , 40 \} , \{ 46 , 47 , 47 , 48 , 41 , 64 , 105 , 38 \} , \{ 46 , 47 , 46 , 51 , 38 , 80 , 90 , 39 \} , \{ 46 , 47 , 46 , 47 , 45 , 47 , 36 , 119 \} , \{ 46 , 48 , 46 , 47 , 47 , 43 , 48 , 111 \} , \{ 46 , 47 , 47 , 48 , 49 , 38 , 64 , 99 \} , \{ 46 , 48 , 45 , 52 , 50 , 35 , 80 , 84 \} \} , \qquad ( 8 \text{-} 51 )$$

Otherwise, if mipSizeId is equal to 1 and modeId is equal to 1, the following applies:

mWeight[x][y]=mWeight11[x][y] (8-52)
with mWeight11 defined as:

$$mWeight11 [ x ] [ y ] = \{ \{ 46 , 41 , 46 , 46 , 92 , 40 , 47 , 45 \} , \{ 45 , 58 , 42 , 46 , 49 , 45 , 46 , 46 \} , \{ 45 , 103 , 58 , 42 , 46 , 46 , 46 , 46 \} , \{ 45 , 42 , 104 , 54 , 47 , 45 , 47 , 45 \} , \{ 46 , 46 , 46 , 46 , 76 , 89 , 39 , 47 \} , \{ 45 , 42 , 46 , 45 , 97 , 45 , 46 , 45 \} , \{ 45 , 53 , 42 , 46 , 59 , 43 , 45 , 46 \} , \{ 45 , 92 , 51 , 44 , 46 , 47 , 45 , 46 \} , \{ 46 , 45 , 47 , 45 , 40 , 78 , 90 , 39 \} , \{ 45 , 46 , 47 , 45 , 58 , 103 , 44 , 44 \} , \{ 46 , 43 , 47 , 45 , 93 , 59 , 43 , 46 \} , \{ 45 , 47 , 46 , 46 , 72 , 44 , 46 , 45 \} , \{ 46 , 46 , 47 , 45 , 49 , 36 , 77 , 86 \} , \{ 45 , 45 , 47 , 45 , 44 , 60 , 100 , 44 \} , \{ 46 , 46 , 47 , 45 , 51 , 99 , 54 , 46 \} , \{ 45 , 46 , 47 , 46 , 80 , 69 , 46 , 47 \} \} , \qquad ( 8 \text{-} 53 )$$

Otherwise, if mipSizeId is equal to 1 and modeId is equal to 2, the following applies:

mWeight[x][y]=mWeight12[x][y] (8-54)
with mWeight12 defined as:

$$mWeight12 [ x ] [ y ] = \{ \{ 49 , 50 , 53 , 50 , 86 , 103 , 74 , 58 \} , \{ 50 , 39 , 45 , 55 , 57 , 111 , 86 , 62 \} , \{ 50 , 51 , 36 , 52 , 48 , 113 , 90 , 64 \} , \{ 50 , 48 , 59 , 35 , 47 , 111 , 90 , 62 \} , \{ 50 , 43 , 45 , 49 , 45 , 101 , 107 , 60 \} , \{ 51 , 47 , 43 , 49 , 47 , 94 , 110 , 62 \} , \{ 52 , 48 , 44 , 47 , 48 , 93 , 110 , 63 \} , \{ 53 , 49 , 43 , 48 , 49 , 95 , 106 , 64 \} , \{ 50 , 45 , 46 , 47 , 47 , 77 , 114 , 76 \} , \{ 53 , 49 , 43 , 49 , 48 , 80 , 114 , 74 \} , \{ 54 , 49 , 43 , 49 , 47 , 79 , 116 , 73 \} , \{ 55 , 50 , 45 , 49 , 48 , 80 , 113 , 71 \} , \{ 50 , 46 , 47 , 48 , 48 , 59 , 108 , 97 \} , \{ 53 , 50 , 43 , 48 , 50 , 63 , 124 , 78 \} , \{ 56 , 49 , 45 , 49 , 51 , 64 , 120 , 80 \} , \{ 56 , 51 , 44 , 50 , 52 , 68 , 113 , 81 \} \} , \qquad ( 8 \text{-} 55 )$$

Otherwise, if mipSizeId is equal to 1 and modeId is equal to 3, the following applies:

mWeight[x][y]=mWeight13[x][y] (8-56)
with mWeight13 defined as:

$$mWeight13 [ x ] [ y ] = \{ \{ 45 , 61 , 44 , 45 , 89 , 63 , 39 , 48 \} , \{ 45 , 97 , 57 , 42 , 60 , 66 , 40 , 46 \} , \{ 44 , 37 , 102 , 52 , 44 , 59 , 51 , 43 \} , \{ 44 , 47 , 29 , 114 , 40 , 46 , 62 , 44 \} , \{ 45 , 47 , 48 , 46 , 38 , 85 , 85 , 38 \} , \{ 44 , 48 , 49 , 45 , 42 , 59 , 102 , 41 \} , \{ 44 , 49 , 49 , 47 , 42 , 42 , 100 , 57 \} , \{ 45 , 47 , 45 , 55 , 41 , 37 , 83 , 76 \} , \{ 46 , 45 , 46 , 46 , 46 , 39 , 83 , 80 \} , \{ 47 , 46 , 45 , 47 , 45 , 44 , 57 , 102 \} , \{ 47 , 47 , 44 , 47 , 45 , 49 , 43 , 112 \} , \{ 48 , 48 , 46 , 47 , 44 , 50 , 43 , 111 \} , \{ 47 , 46 , 45 , 47 , 46 , 47 , 36 , 119 \} , \{ 48 , 47 , 45 , 48 , 45 , 46 , 40 , 116 \} , \{ 49 , 47 , 45 , 49 , 46 , 44 , 44 , 113 \} , \{ 50 , 48 , 45 , 51 , 46 , 44 , 47 , 110 \} \} , \qquad ( 8 \text{-} 57 )$$

Otherwise, if mipSizeId is equal to 1 and modeId is equal to 4, the following applies:
   If y<4, a subset of mWeight13 matrix is used (see Equation mWeight13[x][y]=(8-57)mWeight00[x][y]=(8-39)):

mWeight[x][y]=mWeight13[x][y] (8-58)
Otherwise, a subset of mWeight10 matrix is used (see Equation mWeight10[x][y]=(8-)):

mWeight[x][y]=mWeight10[x][y] (8-59)
Otherwise, if mipSizeId is equal to 1 and modeId is equal to 5, the following applies:
   If y<4, a subset of mWeight12 matrix is used (see Equation mWeight12[x][y]=(8-55)mWeight00[x][y]=(8-39)):

mWeight[x][y]=mWeight12[x][y] (8-60)
Otherwise, a subset of mWeight13 matrix is used (see Equation mWeight13[x][y]=(8-57)):

mWeight[x][y]=mWeight13[x][y] (8-61)
Otherwise, if mipSizeId is equal to 2 and modeId is equal to 0, the following applies:

mWeight[x][y]=mWeight20[x][y] (8-62)
with mWeight20 defined as:

$$mWeight20 [ x ] [ y ] = \{ \{ 84 , 45 , 52 , 127 , 61 , 58 , 48 \} , \{ 70 , 60 , 55 , 90 , 88 , 63 , 50 \} , \{ 39 , 74 , 59 , 65 , 99 , 68 , 52 \} , \{ 38 , 68 , 65 , 55 , 99 , 70 , 55 \} , \{ 51 , 50 , 75 , 51 , 97 , 73 , 56 \} , \{ 52 , 51 , 76 , 49 , 94 , 76 , 56 \} , \{ 48 , 65 , 67 , 47 , 93 , 77 , 55 \} , \{ 48 , 65 , 70 , 45 , 91 , 76 , 55 \} , \{ 46 , 55 , 52 , 53 , 127 , 65 , 51 \} , \{ 40 , 54 , 56 , 46 , 122 , 76 , 53 \} , \{ 42 , 50 , 60 , 45 , 114 , 82 , 55 \} , \{ 46 , 46 , 63 , 45 , 110 , 84 , 56 \} , \{ 46 , 46 , 64 , 46 , 107 , 84 , 57 \} , \{ 48 , 49 , 61 , 47 , 106 , 85 , 55 \} , \{ 48 , 49 , 61 , 46 , 105 , 85 , 56 \} , \{ 48 , 50 , 64 , 47 , 102 , 81 , 58 \} , \{ 45 , 48 , 54 , 49 , 124 , 75 , 55 \} , \{ 45 , 47 , 56 , 47 , 111 , 85 , 58 \} , \{ 46 , 46 , 59 , 47 , 105 , 88 , 60 \} , \{ 45 , 47 , 60 , 47 , 104 , 88 , 60 \} , \{ 45 , 47 , 61 , 46 , 105 , 86 , 60 \} , \{ 46 , 47 , 62 , 46 , 105 , 86 , 59 \} , \{ 46 , 47 , 64 , 46 , 104 , 87 , 58 \} , \{ 47 , 46 , 67 , 46 , 102 , 86 , 58 \} , \{ 46 , 46 , 54 , 46 , 107 , 94 , 57 \} , \{ 44 , 47 , 55 , 46 , 102 , 93 , 63 \} , \{ 45 , 46 , 57 , 46 , 100 , 91 , 65 \} , \{ 45 , 46 , 59 , 46 , 99 , 90 , 66 \} , \{ 45 , 47 , 60 , 45 , 100 , 90 , 63 \} , \{ 45 , 47 , 61 , 44 , 100 , 91 , 62 \} , \{ 46 , 45 , 64 , 44 , 100 , 90 , 61 \} , \{ 46 , 46 , 66 , 44 , 99 , 89 , 60 \} , \{ 45 , 47 , 52 , 45 , 87 , 112 , 61 \} , \{ 45 , 45 , 55 , 45 , 89 , 103 , 68 \} , \{ 45 , 46 , 56 , 44 , 91 , 95 , 71 \} , \{ 45 , 46 , 58 , 43 , 94 , 95 , 69 \} , \{ 45 , 46 , 60 , 44 , 94 , 95 , 67 \} , \{ 46 , 46 , 61 , 43 , 95 , 95 , 65 \} , \{ 46 , 45 , 64 , 43 , 95 , 94 , 64 \} , \{ 46 , 44 , 65 , 43 , 95 , 93 , 63 \} , \{ 45 , 46 , 52 , 44 , 74 , 103 , 85 \} , \{ 45 , 45 , 56 , 43 , 82 , 97 , 82 \} , \{ 45 , 45 , 57 , 43 , 85 , 97 , 78 \} , \{ 45 , 45 , 58 , 43 , 88 , 97 , 73 \} , \{ 46 , 44 , 60 , 43 , 89 , 96 , 71 \} , \{ 46 , 43 , 63 , 43 , 89 , 97 , 68 \} , \{ 45 , 44 , 64 , 43 , 89 , 97 , 67 \} , \{ 47 , 44 , 65 , 43 , 88 , 97 , 66 \} , \{ 45 , 46 , 52 , 44 , 65 , 82 , 114 \} , \{ 44 , 46 , 54 , 43 , 76 , 95 , 91 \} , \{ 44 , 45 , 57 , 42 , 82 , 101 , 78 \} , \{ 45 , 44 , 59 , 42 , 85 , 100 , 75 \} , \{ 46 , 44 , 60 , 42 , 85 , 100 , 73 \} , \{ 46 , 44 , 62 , 43 , 84 , 102 , 70 \} , \{ 46 , 44 , 64 , 43 , 84 , 101 , 69 \} , \{ 46 , 44 , 66 , 44 , 83 , 100 , 68 \} , \{ 46 , 45 , 53 , 44 , 60 , 81 , 119 \} , \{ 44 , 46 , 54 , 43 , 70 , 102 , 89 \} , \{ 46 , 46 , 57 , 43 , 75 , 104 , 79 \} , \{ 47 , 43 , 59 , 42 , 79 , 105 , 74 \} , \{ 46 , 45 , 60 , 43 , 80 , 103 , 73 \} , \{ 46 , 44 , 63 , 44 , 80 , 102 , 72 \} , \{ 47 , 43 , 65 , 45 , 81 , 101 , 70 \} , \{ 47 , 43 , 67 , 46 , 78 , 98 , 72 \} \} , \qquad ( 8 \text{-} 63 )$$

Otherwise, if mipSizeId is equal to 2 and modeId is equal to 1, the following applies:

mWeight[x][y]=mWeight21[x][y] (8-64)
with mWeight21 defined as:

$$mWeight21 [ x ] [ y ] = \{ \{ 50 , 47 , 46 , 61 , 50 , 45 , 46 \} , \{ 59 , 49 , 47 , 57 , 51 , 45 , 46 \} , \{ 64 , 52 , 48 , 55 , 51 , 46 , 46 \} , \{ 58 , 61 , 50 , 53 , 51 , 46 , 46 \} , \{ 52 , 66 , 53 , 52 , 51 , 46 , 46 \} , \{ 48 , 62 , 62 , 50 , 51 , 46 , 46 \} , \{ 47 , 49 , 76 , 49 , 51 , 46 , 46 \} , \{ 45 , 33 , 92 , 49 , 52 , 46 , 46 \} , \{ 50 , 48 , 46 , 57 , 63 , 45 , 46 \} , \{ 55 , 52 , 48 , 55 , 63 , 45 , 46 \} , \{ 57 , 56 , 50 , 53 , 63 , 45 , 46 \} , \{ 55 , 60 , 53 , 51 , 63 , 46 , 46 \} , \{ 51 , 60 , 59 , 51 , 63 , 46 , 46 \} , \{ 48 , 55 , 69 , 49 , 63 , 46 , 46 \} , \{ 46 , 42 , 84 , 48 , 62 , 46 , 46 \} , \{ 43 , 28 , 99 , 48 , 61 , 47 , 46 \} , \{ 49 , 49 , 47 , 48 , 73 , 47 , 46 \} , \{ 52 , 52 , 49 , 47 , 73 , 48 , 46 \} , \{ 52 , 55 , 53 , 47 , 72 , 48 , 46 \} , \{ 51 , 56 , 58 , 46 , 72 , 48 , 46 \} , \{ 48 , 54 , 65 , 46 , 71 , 48 , 46 \} , \{ 46 , 47 , 76 , 45 , 71 , 49 , 46 \} , \{ 44 , 34 , 91 , 44 , 70 , 49 , 46 \} , \{ 41 , 23 , 104 , 45 , 68 , 50 , 46 \} , \{ 48 , 48 , 48 , 44 , 68 , 59 , 45 \} , \{ 50 , 51 , 51 , 43 , 69 , 58 , 45 \} , \{ 49 , 52 , 56 , 43 , 68 , 58 , 45 \} , \{ 48 , 52 , 62 , 42 , 68 , 58 , 45 \} , \{ 45 , 48 , 71 , 42 , 68 , 58 , 45 \} , \{ 43 , 38 , 84 , 41 , 68 , 59 , 45 \} , \{ 41 , 27 , 98 , 41 , 67 , 59 , 45 \} , \{ 38 , 19 , 109 , 42 , 66 , 59 , 45 \} , \{ 47 , 47 , 49 , 44 , 52 , 74 , 45 \} , \{ 48 , 48 , 53 , 43 , 54 , 74 , 45 \} , \{ 47 , 48 , 60 , 43 , 55 , 73 , 45 \} , \{ 45 , 46 , 68 , 43 , 55 , 73 , 45 \} , \{ 43 , 40 , 78 , 42 , 56 , 72 , 45 \} , \{ 41 , 30 , 91 , 42 , 57 , 72 , 45 \} , \{ 38 , 20 , 105 , 41 , 57 , 71 , 45 \} , \{ 36 , 13 , 114 , 41 , 57 , 70 , 46 \} , \{ 46 , 47 , 50 , 45 , 43 , 77 , 51 \} , \{ 46 , 46 , 56 , 44 , 44 , 78 , 51 \} , \{ 45 , 43 , 64 , 43 , 45 , 77 , 51 \} , \{ 43 , 39 , 73 , 43 , 45 , 77 , 51 \} , \{ 40 , 31 , 85 , 42 , 46 , 77 , 51 \} , \{ 38 , 22 , 98 , 42 , 46 , 77 , 51 \} , \{ 35 , 12 , 111 , 42 , 47 , 76 , 51 \} , \{ 33 , 7 , 119 , 41 , 48 , 75 , 52 \} , \{ 46 , 46 , 51 , 45 , 44 , 57 , 71 \} , \{ 45 , 43 , 59 , 44 , 44 , 58 , 70 \} , \{ 43 , 37 , 68 , 43 , 45 , 58 , 70 \} , \{ 40 , 31 , 80 , 43 , 45 , 58 , 70 \} , \{ 33 , 5 , 117 , 42 , 47 , 58 , 70 \} , \{ 31 , 2 , 123 , 42 , 48 , 57 , 71 \} , \{ 45 , 41 , 55 , 45 , 51 , 24 , 96 \} , \{ 44 , 36 , 64 , 44 , 52 , 23 , 97 \} , \{ 42 , 29 , 75 , 43 , 53 , 23 , 97 \} , \{ 39 , 22 , 86 , 43 , 52 , 24 , 97 \} , \{ 37 , 14 , 98 , 43 , 53 , 24 , 97 \} , \{ 34 , 7 , 109 , 42 , 53 , 25 , 97 \} , \{ 32 , 1 , 118 , 41 , 53 , 25 , 97 \} , \{ 30 , 0 , 123 , 41 , 53 , 26 , 96 \} \} , \qquad ( 8 \text{-} 65 )$$

Otherwise, if mipSizeId is equal to 2 and modeId is equal to 2, the following applies:

mWeight[x][y]=mWeight22[x][y] (8-66)
with mWeight22 defined as:

$$mWeight22 [ x ] [ y ] = \{ \{ 48 , 46 , 46 , 88 , 45 , 46 , 46 \} , \{ 54 , 46 , 46 , 67 , 47 , 46 , 46 \} , \{ 72 , 45 , 46 , 55 , 47 , 46 , 46 \} , \{ 88 , 51 , 45 , 51 , 47 , 47 , 46 \} , \{ 81 , 70 , 44 , 49 , 47 , 47 , 46 \} , \{ 56 , 95 , 46 , 47 , 47 , 46 , 46 \} , \{ 44 , 86 , 68 , 47 , 47 , 46 , 45 \} , \{ 48 , 46 , 105 , 47 , 47 , 46 , 45 \} , \{ 49 , 46 , 46 , 96 , 60 , 45 , 46 \} , \{ 50 , 46 , 46 , 91 , 52 , 46 , 46 \} , \{ 55 , 46 , 46 , 76 , 51 , 46 , 46 \} , \{ 66 , 47 , 45 , 64 , 50 , 47 , 46 \} , \{ 78 , 51 , 45 , 57 , 49 , 47 , 45 \} , \{ 77 , 65 , 45 , 52 , 48 , 47 , 46 \} , \{ 62 , 82 , 48 , 50 , 47 , 47 , 45 \} , \{ 51 , 77 , 66 , 49 , 48 , 46 , 45 \} , \{ 48 , 46 , 46 , 65 , 93 , 43 , 46 \} , \{ 49 , 46 , 46 , 78 , 77 , 45 , 46 \} , \{ 50 , 47 , 46 , 82 , 65 , 46 , 45 \} , \{ 54 , 47 , 46 , 77 , 58 , 47 , 45 \} , \{ 63 , 47 , 46 , 70 , 54 , 47 , 45 \} , \{ 72 , 49 , 46 , 63 , 51 , 47 , 45 \} , \{ 72 , 60 , 46 , 57 , 50 , 47 , 45 \} , \{ 64 , 71 , 49 , 54 , 50 , 46 , 45 \} , \{ 46 , 46 , 46 , 46 , 97 , 60 , 44 \} , \{ 47 , 46 , 46 , 56 , 94 , 52 , 45 \} , \{ 48 , 47 , 46 , 67 , 84 , 49 , 45 \} , \{ 50 , 47 , 46 , 73 , 75 , 48 , 45 \} , \{ 53 , 47 , 46 , 73 , 67 , 47 , 45 \} , \{ 60 , 47 , 46 , 70 , 62 , 47 , 45 \} , \{ 66 , 49 , 46 , 65 , 58 , 46 , 45 \} , \{ 66 , 57 , 47 , 60 , 56 , 46 , 45 \} , \{ 46 , 46 , 46 , 46 , 66 , 94 , 42 \} , \{ 46 , 46 , 46 , 48 , 80 , 77 , 43 \} , \{ 47 , 46 , 46 , 53 , 87 , 64 , 44 \} , \{ 48 , 46 , 46 , 60 , 86 , 56 , 44 \} , \{ 49 , 47 , 46 , 65 , 82 , 51 , 45 \} , \{ 52 , 47 , 46 , 67 , 76 , 48 , 45 \} , \{ 57 , 47 , 46 , 67 , 70 , 47 , 45 \} , \{ 61 , 50 , 46 , 64 , 65 , 47 , 45 \} , \{ 46 , 47 , 46 , 48 , 43 , 104 , 53 \} , \{ 46 , 46 , 46 , 48 , 55 , 99 , 46 \} , \{ 47 , 46 , 46 , 48 , 70 , 86 , 44 \} , \{ 47 , 46 , 46 , 51 , 80 , 73 , 44 \} , \{ 47 , 46 , 46 , 56 , 85 , 62 , 44 \} , \{ 55 , 48 , 46 , 63 , 75 , 50 , 45 \} , \{ 46 , 46 , 46 , 47 , 45 , 67 , 90 \} , \{ 46 , 46 , 46 , 48 , 47 , 83 , 71 \} , \{ 46 , 46 , 46 , 48 , 54 , 91 , 56 \} , \{ 47 , 46 , 46 , 49 , 65 , 87 , 49 \} , \{ 46 , 46 , 46 , 51 , 74 , 78 , 46 \} , \{ 46 , 47 , 46 , 54 , 80 , 69 , 45 \} , \{ 47 , 47 , 46 , 57 , 82 , 61 , 45 \} , \{ 50 , 47 , 46 , 59 , 79 , 57 , 45 \} , \{ 46 , 46 , 46 , 46 , 52 , 33 , 118 \} , \{ 46 , 46 , 46 , 46 , 53 , 45 , 105 \} , \{ 46 , 46 , 46 , 48 , 53 , 63 , 86 \} , \{ 46 , 46 , 46 , 49 , 56 , 77 , 68 \} , \{ 46 , 47 , 45 , 50 , 62 , 80 , 57 \} , \{ 46 , 47 , 46 , 51 , 69 , 77 , 51 \} , \{ 46 , 47 , 46 , 53 , 74 , 71 , 49 \} , \{ 48 , 47 , 47 , 55 , 75 , 66 , 48 \} \} , \qquad ( 8 \text{-} 67 )$$

Otherwise, if mipSizeId is equal to 2 and modeId is equal to 3, the following applies:

mWeight[x][y]=mWeight23[x][y] (8-68)
with mWeight23 defined as:

$$mWeight23 [ x ] [ y ] = \{ \{ 59 , 44 , 45 , 87 , 48 , 45 , 47 \} , \{ 88 , 44 , 45 , 60 , 61 , 41 , 48 \} , \{ 83 , 65 , 44 , 46 , 65 , 42 , 48 \} , \{ 50 , 94 , 47 , 41 , 60 , 48 , 46 \} , \{ 40 , 83 , 69 , 42 , 53 , 54 , 45 \} , \{ 45 , 50 , 97 , 43 , 47 , 55 , 48 \} , \{ 48 , 37 , 105 , 43 , 44 , 54 , 54 \} , \{ 48 , 38 , 97 , 44 , 41 , 51 , 65 \} , \{ 60 , 49 , 45 , 75 , 86 , 35 , 49 \} , \{ 55 , 63 , 46 , 51 , 90 , 40 , 48 \} , \{ 43 , 73 , 53 , 41 , 76 , 55 , 46 \} , \{ 40 , 63 , 69 , 41 , 58 , 66 , 47 \} , \{ 44 , 47 , 83 , 43 , 47 , 68 , 53 \} , \{ 47 , 37 , 88 , 44 , 41 , 65 , 63 \} , \{ 49 , 36 , 85 , 44 , 39 , 58 , 75 \} , \{ 49 , 40 , 77 , 43 , 39 , 50 , 86 \} , \{ 43 , 55 , 47 , 40 , 107 , 47 , 47 \} , \{ 37 , 59 , 54 , 40 , 81 , 70 , 44 \} , \{ 40 , 51 , 64 , 44 , 56 , 83 , 48 \} , \{ 44 , 41 , 71 , 45 , 44 , 80 , 60 \} , \{ 47 , 38 , 72 , 46 , 40 , 71 , 73 \} , \{ 48 , 39 , 69 , 46 , 39 , 60 , 86 \} , \{ 48 , 41 , 64 , 45 , 39 , 51 , 96 \} , \{ 48 , 44 , 61 , 45 , 41 , 46 , 101 \} , \{ 41 , 49 , 50 , 41 , 66 , 95 , 41 \} , \{ 42 , 45 , 57 , 46 , 47 , 99 , 50 \} , \{ 45 , 41 , 61 , 48 , 41 , 85 , 67 \} , \{ 46 , 39 , 62 , 47 , 40 , 68 , 84 \} , \{ 47 , 40 , 60 , 46 , 41 , 55 , 97 \} , \{ 47 , 42 , 57 , 46 , 42 , 48 , 104 \} , \{ 47 , 44 , 54 , 46 , 42 , 43 , 109 \} , \{ 47 , 45 , 54 , 45 , 43 , 42 , 109 \} , \{ 45 , 44 , 51 , 47 , 41 , 102 , 55 \} , \{ 46 , 41 , 55 , 48 , 40 , 81 , 76 \} , \{ 46 , 40 , 56 , 47 , 42 , 61 , 94 \} , \{ 46 , 42 , 54 , 47 , 44 , 49 , 105 \} , \{ 46 , 43 , 53 , 46 , 45 , 43 , 110 \} , \{ 46 , 44 , 51 , 46 , 45 , 40 , 113 \} , \{ 47 , 50 , 50 , 46 , 45 , 39 , 115 \} , \{ 46 , 45 , 50 , 45 , 45 , 39 , 113 \} , \{ 46 , 44 , 50 , 47 , 43 , 69 , 89 \} , \{ 46 , 42 , 52 , 46 , 45 , 51 , 104 \} , \{ 46 , 42 , 52 , 46 , 46 , 42 , 111 \} , \{ 46 , 43 , 51 , 46 , 46 , 39 , 115 \} , \{ 45 , 45 , 49 , 46 , 46 , 38 , 116 \} , \{ 46 , 45 , 48 , 46 , 47 , 37 , 117 \} , \{ 46 , 45 , 48 , 46 , 47 , 37 , 117 \} , \{ 46 , 46 , 48 , 45 , 47 , 38 , 115 \} , \{ 46 , 44 , 49 , 46 , 46 , 43 , 112 \} , \{ 46 , 43 , 49 , 46 , 47 , 38 , 116 \} , \{ 46 , 44 , 49 , 46 , 47 , 36 , 118 \} , \{ 45 , 45 , 48 , 46 , 47 , 37 , 118 \} , \{ 45 , 46 , 47 , 46 , 47 , 37 , 117 \} , \{ 45 , 46 , 47 , 46 , 47 , 38 , 117 \} , \{ 46 , 46 , 46 , 46 , 47 , 38 , 116 \} , \{ 46 , 46 , 46 , 46 , 48 , 40 , 114 \} , \{ 46 , 45 , 48 , 46 , 48 , 37 , 117 \} , \{ 46 , 44 , 48 , 46 , 48 , 38 , 118 \} , \{ 46 , 45 , 47 , 46 , 48 , 37 , 117 \} , \{ 45 , 46 , 47 , 46 , 47 , 38 , 116 \} , \{ 45 , 46 , 47 , 46 , 47 , 39 , 115 \} , \{ 45 , 46 , 46 , 46 , 47 , 40 , 115 \} , \{ 46 , 46 , 46 , 46 , 48 , 40 , 114 \} , \{ 46 , 46 , 46 , 46 , 47 , 41 , 112 \} \} , \qquad ( 8 \text{-} 69 )$$

Otherwise, if mipSizeId is equal to 2 and modeId is equal to 4, the following applies:
   If y<3, a subset of mWeight22 matrix is used (see Equation mWeight22[x][y]=(8-67)mWeight00[x][y]=(8-39)):

mWeight[x][y]=mWeight22[x][y] (8-70)
Otherwise, a subset of mWeight23 matrix is used (see Equation mWeight23[x][y]=(8-69)):

mWeight[x][y]=mWeight23[x][y] (8-71)
Otherwise (mipSizeId is equal to 2 and modeId is equal to 5), the following applies:
   If y<3, a subset of mWeight23 matrix is used (see Equation mWeight23[x][y]=(8-69)mWeight00[x][y]=(8-39)):

mWeight[x][y]=mWeight23[x][y] (8-72)
Otherwise, a subset of mWeight22 matrix is used (see Equation mWeight22[x][y]=(8-67)):

mWeight[x][y]=mWeight22[x][y] (8-73)

MIP Prediction Upsampling Process

Inputs to this process are:
a variable predW specifying the input block width,
a variable predH specifying the input block height,
matrix-based intra prediction samples predMip[x][y], with x=0 . . . predW−1, y=0 . . . predH−1,
a variable nTbW specifying the transform block width,
a variable nTbH specifying the transform block height,
top reference samples refT[x] with x=0 . . . nTbW−1,
left reference samples refL[y] with y=0 . . . nTbH−1.

Outputs of this process are the predicted samples predSamples[x][y], with x=0 . . . nTbW−1, y=0 . . . nTbH−1.

The sparse predicted samples predSamples[m][n] are derived from predMip[x][y], with x=0 . . . predW−1, y=0 . . . predH−1 as follows:

upHor=nTbW/predW (8-107)

upVer=nTbH/predH (8-108)

predSamples[(x+1)*upHor−1][(y+1)*upVer−1]=predMip[x][y] (8-109)

The top reference samples refT[x] are assigned to predSamples[x][−1] with x=0 . . . nTbW−1.

The left reference samples refL[y] are assigned to predSamples[−1][y] with y=0 . . . nTbH−1.

The predicted samples predSamples[x][y], with x=0 . . . nTbW−1, y=0 . . . nTbH−1 are derived as follows:
If nTbH is greater than nTbW, the following ordered steps apply:
   1. When upHor is greater than 1, horizontal upsampling for all sparse positions (xHor, yHor)=(m*upHor−1, n*upVer−1) with m=0 . . . predW−1, n=1 . . . predH is applied with dX=1 . . . upHor−1 as follows:

sum=(upHor−dX)*predSamples[xHor][yHor]+dX*predSamples[xHor+upHor][yHor] (8-110)

predSamples[xHor+dX][yHor]=(sum+upHor/2)/upHor (8-111)
2. Vertical upsampling for all sparse positions (xVer, yVer)=(m, n*upVer−1) with m=0 . . . nTbW−1, n=0 . . . predH−1 is applied with dY=1 . . . upVer−1 as follows:

sum=(upVer−dY)*predSamples[xVer][yVer]+dY*predSamples[xVer][yVer+upVer] (8-112)

predSamples[xVer][yVer+dY]=(sum+upVer/2)/upVer (8-113)
Otherwise, the following ordered steps apply:
   1. When upVer is greater than 1, vertical upsampling for all sparse positions (xVer, yVer)=(m*upHor−1, n*upVer−1) with m=1 . . . predW, n=0 . . . predH−1 is applied with dY=1 . . . upVer−1 as follows:

sum=(upVer−dY)*predSamples[xVer][yVer]+dY*predSamples[xVer][yVer+upVer] (8-114)

predSamples[xVer][yVer+dY]=(sum+upVer/2)/upVer (8-115)
2. Horizontal upsampling for all sparse positions (xHor, yHor)=(m*upHor−1, n) with m=0 . . . predW−1, n=0 . . . nTbH−1 is applied with dX=1 . . . upHor−1 as follows:

sum=(upHor−dX)*predSamples[xHor][yHor]+dX*predSamples[xHor+upHor][yHor] (8-116)

predSamples[xHor+dX][yHor]=(sum+upHor/2)/upHor (8-117)

Binarization Process

General

Input to this process is a request for a syntax element.

Output of this process is the binarization of the syntax element.

Table 9-77 specifies the type of binarization process associated with each syntax element and corresponding inputs.

The specification of the truncated Rice (TR) binarization process, the truncated binary (TB) binarization process, the k-th order Exp-Golomb (EGk) binarization process and the fixed-length (FL) binarization process are given in clauses 9.3.3.3 through 9.3.3.7, respectively.

TABLE 9-77
Syntax elements and associated binarizations

| Syntax | | Binarization | |
|---|---|---|---|
| structure | Syntax element | Process | Input parameters |
| slice_data( ) | end_of_brick_one_bit | FL | cMAX = 1 |
| coding_tree_unit( ) | alf_ctb_flag[ ][ ][ ] | FL | cMAX = 1 |
| | alf_ctb_use_first_aps_flag | FL | cMAX = 1 |
| | alf_use_aps_flag | FL | cMAX = 1 |
| | alf_luma_fixed_filter_idx | TB | cMAX = 15 |
| | alf_luma_prev_filter_idx_minus1 | TB | cMax = slice_num_alf_aps_ids_luma − 2 |
| | alf_ctb_filter_alt_idx[ ][ ][ ] | TR | cMax = alf_chroma_num_alt_filters_minus1, |
| | | | cRiceParam = 0 |
| sao( ) | sao_merge_left_flag | FL | cMax = 1 |
| | sao_merge_up_flag | FL | cMax = 1 |
| | sao_type_idx_luma | TR | cMax = 2, cRiceParam = 0 |
| | sao_type_idx_chroma | TR | cMax = 2, cRiceParam = 0 |
| | sao_offset_abs[ ][ ][ ][ ] | TR | cMax = ( 1 << ( Min( bitDepth, 10 ) − 5 ) ) − 1, |
| | | | cRiceParam = 0 |
| | sao_offset_sign[ ][ ][ ][ ] | FL | cMax = 1 |
| | sao_band_position[ ][ ][ ] | FL | cMax = 31 |
| | sao_eo_class_luma | FL | cMax = 3 |
| | sao_eo_class_chroma | FL | cMax = 3 |
| coding_tree( ) | split_cu_flag | FL | cMax = 1 |
| | split_qt_flag | FL | cMax = 1 |
| | mtt_split_cu_vertical_flag | FL | cMax = 1 |
| | mtt_split_cu_binary_flag | FL | cMax = 1 |
| | mode_constraint_flag | FL | cMax = 1 |
| coding_unit( ) | cu_skip_flag[ ][ ] | FL | cMax = 1 |
| | pred_mode_ibc_flag | FL | cMax = 1 |
| | pred _mode_plt_flag | FL | cMax = 1 |
| | pred_mode_flag | FL | cMax = 1 |
| | intra_bdpcm_flag | FL | cMax = 1 |
| | intra_bdpcm_dir_flag | FL | cMax = 1 |
| | intra_mip_flag[ ][ ] | FL | cMax = 1 |
| | intra_mip_transposed[ ][ ] | FL | cMax = 1 |
| | intra_mip_mode[ ][ ] | FL | cMax = 2 |
| | intra_luma_ref_idx[ ][ ] | TR | cMax = 2, cRiceParam = 0 |
| | intra_subpartitions_mode_flag | FL | cMax = 1 |
| | intra_subpartitions_split_flag | FL | cMax = 1 |
| | intra_luma_mpm_flag [ ][ ] | FL | cMax = 1 |
| | intra_luma_not_planar_flag[ ][ ] | FL | cMax = 1 |
| | intra_luma_mpm_idx[ ][ ] | TR | cMax = 4, cRiceParam = 0 |
| | intra_luma_mpm_remainder[ ][ ] | TB | cMax = 60 |
| | cclm_mode_flag | FL | cMax = 1 |
| | cclm_mode_idx | TR | cMax = 2, cRiceParam = 0 |
| | intra_chroma_pred_mode | 9.3.3.8 | — |
| | general_merge_flag[ ][ ] | FL | cMax = 1 |
| | inter_pred_idc[ x0 ][ y0] | 9.3.3.9 | cbWidth, cbHeight |
| | inter_affine_flag[ ][ ] | FL | cMax = 1 |
| | cu_affine_type_flag[ ][ ] | FL | cMax = 1 |
| | sym_mvd_flag[ ][ ] | FL | cMax = 1 |
| | ref_idx_10[ ][ ] | TR | cMax = NumRefIdxActive[ 0 ] − 1, |
| | | | cRiceParam = 0 |
| | mvp_10_flag[ ][ ] | FL | cMax = 1 |
| | ref_idx_11[ ][ ] | TR | cMax = NumRefIdxActive[ 1 ] − 1, |
| | | | cRiceParam = 0 |
| | mvp_11_flag[ ][ ] | FL | cMax = 1 |
| | avmr_flag[ ][ ] | FL | cMax = 1 |
| | amvr_precision_idx[ ][ ] | FL | cMax = (inter_affine_flag = = 0 && |
| | | | CuPredMode[ 0 ][ x0 ][ y0 ] ! = |
| | | | MODE_IBC ) ? 2 : 1, cRiceParam = 0 |
| | bcw_idx[ ][ ] | TR | cMax = NoBackvvardPredFlag ? 4: 2 |
| | cu_cbf | FL | cMax = 1 |
| | cu_sbt_flag | FL | cMax = 1 |
| | cu_sbt_quad_flag | FL | cMax = 1 |
| | cu_sbt_horizontal_flag | FL | cMax = 1 |
| | cu_sbt_pos_flag | FL | cMax = 1 |
| | lfnst_idx[ ][ ] | TR | cMax = 2, cRiceParam = 0 |
| | palette_predictor_run | EG0 | — |
| | num_signalled_palette_entries | EG0 | — |
| | new_palette_entries | FL | cMax = cldx = = 0 ? ( ( 1 << BitDepth_{Y} ) − 1 ) : |
| | | | ( (1 << BitDepth_{C} ) − 1 ) |
| | palette_escape_val_present_flag | FL | cMax = 1 |
| | num_palette_indices_minus1 | 9.5.3.13 | MaxPalettelndex |
| | palette_idx_idc | 9.5.3.14 | MaxPalettelndex |
| | copy_above_indices_for_final_run_flag | FL | cMax = 1 |
| | palette_transpose_flag | FL | cMax = 1 |
| | copy_above_palette_indices_flag | FL | cMax = 1 |
| | palette_run_prefix | TR | cMax = Floor( Log2( PaletteMaxRunMinus1 ) ) + 1, |
| | | | cRiceParam = 0 |
| | palette_run_suffix | TB | cMax = ( Prefix0ffset << 1 ) > |
| | | | PaletteMaxRunMinus1 ? ( PalletMaxRun − Prefix0ffset ) : |
| | | | ( Prefix0ffset − 1 ) |
| | palette_escape_val | EG3 | |
| merge_data( ) | regular_merge_flag[ ][ ] | FL | cMax = 1 |
| | mmvd_merge_flag[ ][ ] | FL | cMax = 1 |
| | mmvd_cand_flag[ ][ ] | FL | cMax = 1 |
| | mmvd_distance_idx[ ][ ] | TR | cMax = 7, cRiceParam = 0 |
| | mmvd_direction_idx [ ][ ] | FL | cMax = 3 |
| | ciip_flag[ ][ ] | FL | cMax = 1 |
| | merge_subblock_flag[ ][ ] | FL | cMax = 1 |
| | merge_subblock_idx[ ][ ] | TR | cMax = MaxNumSubblockMergeCand − 1, |
| | merge_triangle_split_dir[ ][ ] | FL | cRiceParam = 0 |
| | | | cMax = 1 |
| | merge_triangle_idx0[ ][ ] | TR | cMax = MaxNumTriangleMergeCand − 1, |
| | merge_triangle_idx1[ ][ ] | TR | cRiceParam = 0 |
| | | | cMax = MaxNumTriangleMergeCand − 2, |
| | merge_idx[ ][ ] | TR | cRiceParam = 0 |
| | | | cMax = MaxNumMergeCand − 1, |
| mvd_coding( ) | abs_mvd_greater0_flag[ ] | FL | cRiceParam = 0 |
| | | | cMax = 1 |
| | abs_mvd_greater1_flag[ ] | FL | cMax = 1 |
| | abs_mvd_minus2[ ] | EG1 | — |
| | mvd_sign_flag[ ] | FL | cMax = 1 |
| transform_unit( ) | tu_cbf_luma[ ][ ][ ] | FL | cMax = 1 |
| | tu_cbf_cb[ ][ ][ ] | FL | cMax = 1 |
| | tu_cbf_cr[ ][ ][ ] | FL | cMax = 1 |
| | cu_qp_delta_abs | 9.3.3.10 | — |
| | cu_qp_delta_sign_flag | FL | cMax = 1 |
| | cu_chroma_qp_offset_flag | FL | cMax = 1 |
| | cu_chroma_qp_offset_idx | TR | cMax = chroma_qp_offset_list_len_minus1, |
| | | | cRiceParam = 0 |
| | transfom_skip_flag[ ][ ] | FL | cMax = 1 |
| | tu_mts_idx[ ][ ] | TR | cMax = 4, cRiceParam = 0 |
| | tu_joint_cbcr_residual_flag[ ][ ] | FL | cMax = 1 |
| residual_coding( ) | last_sig_coeff_x_prefix | TR | cMax = ( log2ZoTbWidth << 1 ) − 1, |
| | | | cRiceParam = 0 |
| | last_sig_coeff_y_prefix | TR | cMax = (log2ZoTbHeight « 1 ) − 1, |
| | | | cRiceParam = 0 |
| | last_sig_coeff_x_suffix | FL | cMax = ( 1 << ( ( last_sig_coefT_x_prefix >> 1 ) − 1 ) − 1 ) |
| | last_sig_coeff_y_suffix | FL | cMax = ( 1 << ( ( last_sig_coeff_y_prefix >> 1 ) − 1 ) − 1 |
| | coded_subblock_flag[ ][ ] | FL | cMax = 1 |
| | sig_coeff_flag[ ][ ] | FL | cMax = 1 |
| | par_level_flag[ ] | FL | cMax = 1 |
| | abs_level_gtx_flag[ ][ ] | FL | cMax = 1 |
| | abs_remainder[ ] | 9.3.3.11 | cldx, current sub-block index i, x0, y0, xC, |
| | | | yC, log2TbWidth, log2TbHeight |
| | dec_abs_level[ ] | 9.3.3.12 | cldx, x0, y0, xC, yC, log2TbWidth, |
| | | | log2TbHeight |
| | coeff_sign_flag[ ] | FL | cMax = 1 |

Derivation process for ctxTable, ctxIdx and bypassFlag

General

Input to this process is the position of the current bin within the bin string, binIdx.

Outputs of this process are ctxTable, ctxIdx and bypassFlag.

The values of ctxTable, ctxIdx and bypassFlag are derived as follows based on the entries for binIdx of the corresponding syntax element in Table 9-82:
If the entry in Table 9-82 is not equal to “bypass”, “terminate” or “na”, the values of binIdx are decoded by invoking the DecodeDecision process as specified in clause 9.3.4.3.2 and the following applies:
   ctxTable is specified in Table 9-4
   The variable ctxInc is specified by the corresponding entry in Table 9-82 and when more than one value is listed in Table 9-82 for a binIdx, the assignment process for ctxInc for that binIdx is further specified in the clauses given in parenthesis.
   The variable ctxIdxOffset is specified in Table 9-4 depending on the current value of initType.
   ctxIdx is set equal to the sum of ctxInc and ctxIdxOffset.
   bypassFlag is set equal to 0.
Otherwise, if the entry in Table 9-82 is equal to “bypass”, the values of binIdx are decoded by invoking the DecodeBypass process as specified in clause 9.3.4.3.4 and the following applies:
   ctxTable is set equal to 0.
   ctxIdx is set equal to 0.
   bypassFlag is set equal to 1.a
Otherwise, if the entry in Table 9-82 is equal to “terminate”, the values of binIdx are decoded by invoking the DecodeTerminate process as specified in clause 9.3.4.3.5 and the following applies:
   ctxTable is set equal to 0.
   ctxIdx is set equal to 0.
   bypassFlag is set equal to 0.
Otherwise (the entry in Table 9-82 is equal to “na”), the values of binIdx do not occur for the corresponding syntax element.

TABLE 9-82
Assignment of ctxInc to syntax elements with context coded bins

| | binIdx | | | | | |
|---|---|---|---|---|---|---|
| Syntax element | 0 | 1 | 2 | 3 | 4 | >= 5 |
| end_of_brick_one_bit | terminate | na | na | na | na | na |
| alf_ctb_flag[ ][ ][ ] | 0..8 | na | na | na | na | na |
| | (clause 9.3.4.2.2) | | | | | |
| alf_ctb_use_first_aps_flag | 0 | na | na | na | na | na |
| alf_use_aps_flag | 0 | na | na | na | na | na |
| alf_luma_fixed_filter_idx | bypass | bypass | bypass | bypass | bypass | bypass |
| alf_luma_prev_filter_idx_ | bypass | bypass | bypass | bypass | bypass | bypass |
| minus1 | | | | | | |
| alf_ctb_filter_alt_idx[ 0 ][ ][ ] | 0 | 0 | 0 | 0 | 0 | 0 |
| alf_ctb_filter_alt_idx[ 1 ][ ][ ] | 1 | 1 | 1 | 1 | 1 | 1 |
| sao_merge_left_flag | 0 | na | na | na | na | na |
| sao_merge_up_flag | 0 | na | na | na | na | na |
| sao_type_idx_luma | 0 | bypass | na | na | na | na |
| sao_type_idx_chroma | 0 | bypass | na | na | na | na |
| sao_offset_abs[ ][ ][ ][ ] | bypass | bypass | bypass | bypass | bypass | na |
| sao_offset_sign[ ][ ][ ][ ] | bypass | na | na | na | na | na |
| sao_band_position[ ][ ][ ] | bypass | bypass | bypass | bypass | bypass | bypass |
| sao_eo_class_luma | bypass | bypass | na | na | na | na |
| sao_eo_class_chroma | bypass | bypass | na | na | na | na |
| split_cu_flag | 0..8 | na | na | na | na | na |
| | (clause 9.3.4.2.2) | | | | | |
| split_qt_flag | 0..5 | na | na | na | na | na |
| | (clause 9.3.4.2.2) | | | | | |
| mtt_split_cu_vertical_flag | 0..4 | na | na | na | na | na |
| | (clause 9.3.4.2.3) | | | | | |
| mtt_split_cu_binary_flag | ( 2 * | na | na | na | na | na |
| | mtt_split_cu_vertical_ | | | | | |
| | flag ) + | | | | | |
| | ( mttDepth < = 1 ? 1 : | | | | | |
| | 0 ) | | | | | |
| mode_constraint_flag | 0,1 | na | na | na | na | na |
| | (clause 9.3.4.2.2) | | | | | |
| cu_skip_flag[ ][ ] | 0,1,2 | na | na | na | na | na |
| | (clause 9.3.4.2.2) | | | | | |
| pred_mode_flag | 0,1 | na | na | na | na | na |
| | (clause 9.3.4.2.2) | | | | | |
| pred_mode_ibc_flag | 0,1,2 | na | na | na | na | na |
| | (clause 9.3.4.2.2) | | | | | |
| pred_mode_plt_flag | 0 | na | na | na | na | na |
| intra_bdpcm_flag | 0 | na | na | na | na | na |
| intra_bdpcm_dir_flag | 0 | na | na | na | na | na |
| intra_mip_flag[ ][ ] | (Abs( Log2(cbWidth) − | | | | | |
| | Log2(cbHeight) ) | | | | | |
| | > 1) ? | | | | | |
| | 3 : ( 0,1,2 | | | | | |
| | (clause 9.3.4.2.2) ) | | | | | |
| intra_mip_transposed[ ][ ] | bypass | bypass | bypass | bypass | bypass | bypass |
| intra_mip_mode[ ][ ] | bypass | bypass | bypass | bypass | bypass | bypass |
| intra_luma_ref_idx[ ][ ] | 0 | 1 | na | na | na | na |
| intra_subpartitions_mode_ | 0 | na | na | na | na | na |
| flag | | | | | | |
| intra_subpartitions_split_ | 0 | na | na | na | na | na |
| flag | | | | | | |
| intra_luma_mpm_flag[ ][ ] | 0 | na | na | na | na | na |
| intra_luma_not_planar_ | intra_subpartitions_ | na | na | na | na | na |
| flag[ ][ ] | mode_flag | | | | | |
| intra_luma_mpm_idx[ ][ ] | bypass | bypass | bypass | bypass | na | na |
| intra_luma_mpm_ | bypass | bypass | bypass | bypass | bypass | bypass |
| remainder[ ][ ] | | | | | | |
| cclm_mode_flag | 0 | na | na | na | na | na |
| cclm_mode_idx | 0 | bypass | na | na | na | na |
| intra_chroma_pred_mode | 0 | bypass | bypass | na | na | na |
| palette_predictor_run | bypass | bypass | bypass | bypass | bypass | bypass |
| num_signalled_palette_ | bypass | bypass | bypass | bypass | bypass | bypass |
| entries | | | | | | |
| new_palette_entries | bypass | bypass | bypass | bypass | bypass | bypass |
| palette_escape_val_ | bypass | na | na | na | na | na |
| present_flag | | | | | | |
| palette_transpose_flag | 0 | na | na | na | na | na |
| num_palette_indices_ | bypass | bypass | bypass | bypass | bypass | bypass |
| minus1 | | | | | | |
| palette_idx_idc | bypass | bypass | bypass | bypass | bypass | bypass |
| copy_above_palette_indices_ | 0 | na | na | na | na | |
| flag | | | | | | |
| copy_above_indices_for_ | 0 | na | na | na | na | na |
| final_run_flag | | | | | | |
| palette_run_prefix | 0..7 | | | | | |
| | (clause 9.3.4.2.11) | | | | | |
| palette_run_suffix | bypass | bypass | bypass | bypass | bypass | bypass |
| palette_escape_val | bypass | bypass | bypass | bypass | bypass | bypass |
| general_merge_flag[ ][ ] | 0 | na | na | na | na | na |
| regular_merge_flag[ ][ ] | cu_skip_flag[ ][ ] ? | na | na | na | na | na |
| | 0 : 1 | | | | | |
| mmvd_merge_flag[ ][ ] | 0 | na | na | na | na | na |
| mmvd_cand_flag[ ][ ] | 0 | na | na | na | na | na |
| mmvd_distance_idx[ ][ ] | 0 | bypass | bypass | bypass | bypass | bypass |
| mmvd_direction_idx[ ][ ] | bypass | bypass | na | na | na | na |
| merge_subblock_flag[ ][ ] | 0,1,2 | na | na | na | na | na |
| | (clause 9.3.4.2.2) | | | | | |
| merge_subblock_idx[ ][ ] | 0 | bypass | bypass | bypass | bypass | na |
| ciip_flag[ ][ ] | 0 | na | na | na | na | na |
| merge_idx[ ][ ] | 0 | bypass | bypass | bypass | bypass | na |
| merge_triangle_split_ | bypass | na | na | na | na | na |
| dir[ ][ ] | | | | | | |
| merge_triangle_idx0[ ][ ] | 0 | bypass | bypass | bypass | bypass | na |
| merge_triangle_idx1[ ][ ] | 0 | bypass | bypass | bypass | na | na |
| inter_pred_idc[ x0 ][ y0 ] | ( cbWidth + | 4 | na | na | na | na |
| | cbHeight ) > 12 ? | | | | | |
| | 7 − ( ( 1 + | | | | | |
| | Log2( cbWidth ) + | | | | | |
| | Log2( cbHeight) ) >> | | | | | |
| | 1 ) : 4 | | | | | |
| inter_affine_flag[ ][ ] | 0,1,2 | na | na | na | na | na |
| | (clause 9.3.4.2.2) | | | | | |
| cu_affine_type_flag[ ][ ] | 0 | na | na | na | na | na |
| sym_mvd_flag[ ][ ] | 0 | na | na | na | na | na |
| ref_idx_l0[ ][ ] | 0 | 1 | bypass | bypass | bypass | bypass |
| ref_idx_l1 [ ][ ] | 0 | 1 | bypass | bypass | bypass | bypass |
| mvp_l0_flag[ ][ ] | 0 | na | na | na | na | na |
| mvp_l1_flag[ ][ ] | 0 | na | na | na | na | na |
| amvr_flag[ ][ ] | inter_affine_flag[ ][ ] | na | na | na | na | na |
| | ? 1 : 0 | | | | | |
| amvr_precision_idx[ ][ ] | 0 | 1 | na | na | na | na |
| bcw_idx[ ][ ] | 0 | bypass | na | na | na | na |
| NoBackwardPredFlag | | | | | | |
| = = 0 | | | | | | |
| bcw_idx[ ][ ] | 0 | bypass | bypass | bypass | na | na |
| NoBackwardPredFlag | | | | | | |
| = = 1 | | | | | | |
| cu_cbf | 0 | na | na | na | na | na |
| cu_sbt_flag | ( cbWidth * | na | na | na | na | na |
| | cbHeight < 256 ) ? | | | | | |
| | 1 : 0 | | | | | |
| cu_sbt_quad_flag | 0 | na | na | na | na | na |
| cu_sbt_horizontal_flag | ( cbWidth = = | na | na | na | na | na |
| | cbHeight ) ? 0 : | | | | | |
| | ( cbWidth < | | | | | |
| | cbHeight ) ? 1 : 2 | | | | | |
| cu_sbt_pos_flag | 0 | na | na | na | na | na |
| lfnst_idx[ ][ ] | ( tu_mts_idx[ x0 ] | bypass | na | na | na | na |
| | [ y0 ] = = 0 && | | | | | |
| | treeType != | | | | | |
| | SINGLE_TREE ) ? | | | | | |
| | 1 : 0 | | | | | |
| abs_mvd_greater0_flag[ ] | 0 | na | na | na | na | na |
| abs_mvd_greater1_flag[ ] | 0 | na | na | na | na | na |
| abs_mvd_minus2[ ] | bypass | bypass | bypass | bypass | bypass | bypass |
| mvd_sign_flag[ ] | bypass | na | na | na | na | na |
| tu_cbf_luma[ ][ ][ ] | 0,1,2,3 | na | na | na | na | na |
| | (clause 9.3.4.2.5) | | | | | |
| tu_cbf_cb[ ][ ][ ] | 0 | na | na | na | na | na |
| tu_cbf_cr[ ][ ][ ] | tu_cbf_cb[ ][ ][ ] | na | na | na | na | na |
| cu_qp_delta_abs | 0 | 1 | 1 | 1 | 1 | bypass |
| cu_qp_delta_sign_flag | bypass | na | na | na | na | na |
| cu_chroma_qp_offset_flag | 0 | na | na | na | na | na |
| cu_chroma_qp_offset_idx | 0 | 0 | 0 | 0 | 0 | na |
| transform_skip_flag[ ][ ] | 0 | na | na | na | na | na |
| tu_mts_idx[ ][ ] | 0 | 1 | 2 | 3 | na | na |
| tu_joint_cbcr_residual_ | 2*tu_cbf_cb[ ][ ] + | na | na | na | na | na |
| flag[ ][ ] | tu_cbf_cr[ ][ ] − 1 | | | | | |
| last_sig_coeff_x_prefix | 0..22 | | | | | |
| | (clause 9.3.4.2.4) | | | | | |
| last_sig_coeff_y_prefix | 0..22 | | | | | |
| | (clause 9.3.4.2.4) | | | | | |
| last_sig_coeff_x_suffix | bypass | bypass | bypass | bypass | bypass | bypass |
| last_sig_coeff_y_suffix | bypass | bypass | bypass | bypass | bypass | bypass |
| coded_sub_block_flag[ ][ ] | 0 .7 | na | na | na | na | na |
| | (clause 9.3.4 2.6) | | | | | |
| sig_coeff_flag[ ][ ] | ( MaxCcbs > 0) ? | na | na | na | na | na |
| | (0..93 | | | | | |
| | (clause 9.3.4.2 8) ) : | | | | | |
| | bypass | | | | | |
| par_level_flag[ ] | ( MaxCcbs > 0) ? | na | na | na | na | na |
| | (0..32 | | | | | |
| | (clause 9.3.42.9) ) : | | | | | |
| | bypass | | | | | |
| abs_level_gtx_flag[ ] | (MaxCcbs > 0) ? | na | na | na | na | na |
| | (0..73 | | | | | |
| | (clause 9.3.4.2.9) ) : | | | | | |
| | bypass | | | | | |
| abs_remainder[ ] | bypass | bypass | bypass | bypass | bypass | bypass |
| dec_abs_level[ ] | bypass | bypass | bypass | bypass | bypass | bypass |
| coeff_sign_flag[ ] | bypass | na | na | na | na | na |
| transform_skip_flag | | | | | | |
| [ x0 ][ y0 ] = = 0 | | | | | | |
| coeff_sign_flag[ ] | ( MaxCcbs > 0) ? | na | na | na | na | na |
| transform_skip_flag | (0..5 | | | | | |
| [ x0 ][ y0 ] = = 1 | (clause 9.3.4.2.10) ) : | | | | | |
| | bypass | | | | | |

APPENDIX B
Coding unit syntax

| coding_unit( x0, y0, cbWidth, cbHeight, cqtDepth, treeType, modeType ) { | Descriptor |
|---|---|
| chType = treeType = = DUAL_TREE_CHROMA? 1 : 0 | |
| if( slice_type != I ∥ sps_ibc_enabled_flag ∥ sps_palette_enabled_flag) { | |
| if( treeType != DUAL_TREE_CHROMA && | |
| !( ( ( cbWidth = = 4 && cbHeight = = 4 ) ∥ modeType = = | |
| MODE_TYPE_INTRA ) | |
| && !sps_ibc_enabled_flag ) ) | |
| cu_skip_flag[ x0 ][ y0 ] | ae(v) |
| if( cu_skip_flag[ x0 ][ y0 ] = = 0 && slice_type != I | |
| && !( cbWidth = = 4 && cbHeight = = 4 ) && modeType = = | |
| MODE_TYPE_ALL ) | |
| pred_mode _flag | ae(v) |
| if( ( ( slice_type = = I && cu_skip_flag[ x0 ][ y0 ] = = 0 ) ∥ | |
| ( slice_type != I && ( CuPredMode[ chType ][ x0 ][ y0 ] != | |
| MODE_INTRA ∥ | |
| ( cbWidth = = 4 && cbHeight = = 4 && cu_skip_flag[ x0 ][ y0 ] = = | |
| 0 ) ) ) ) && | |
| cbWidth <= 64 && cbHeight <= 64 && modeType != | |
| MODE_TYPE_INTER && | |
| sps_ibc_enabled_flag && treeType != DUAL_TREE_CHROMA ) | |
| pred_mode_ibc_flag | ae(v) |
| if( ( ( ( slice_type = = I ∥ ( cbWidth = = 4 && cbHeight = = 4 ) ∥ | |
| sps_ibc_enabled_flag ) && | |
| CuPredMode[ x0 ][ y0 ] = = MODE_INTRA ) ∥ | |
| ( slice_type != I && !( cbWidth = = 4 && cbHeight = = 4 ) && | |
| !sps_ibc_enabled_flag | |
| && CuPredMode[ x0 ][ y0 ] != MODE_INTRA ) ) && | |
| sps_palette_enabled_flag && | |
| cbWidth <= 64 && cbHeight <= 64 && && cu_skip_flag[ x0 ][ y0 ] = | |
| 0 && | |
| modeType != MODE_INTER ) | |
| pred_mode_plt_flag | ae(v) |
| } | |
| if( CuPredMode[ chType ][ x0 ][ y0 ] = = MODE_INTRA ∥ | |
| CuPredMode[ chType ][ x0 ][ y0 ] = = MODE_PLT ) { | |
| if( treeType = = SINGLE_TREE ∥ treeType = = DUAL_TREE_LUMA ) { | |
| if( pred_mode_plt_flag ) { | |
| if( treeType = = DUAL_TREE_LUMA ) | |
| palette_coding( x0, y0, cbWidth, cbHeight, 0, 1 ) | |
| else /* SINGLE_TREE */ | |
| palette_coding( x0, y0, cbWidth, cbHeight, 0, 3 ) | |
| } else { | |
| if( sps_bdpcm_enabled_flag && | |
| cbWidth <= MaxTsSize && cbHeight <= MaxTsSize ) | |
| intra_bdpcm_flag | ae(v) |
| if( intra_bdpcm_flag ) | |
| intra_bdpcm_dir_flag | ae(v) |
| else { | |
| if( sps_mip_enabled_flag && | |
| ( Abs( Log2( cbWidth ) − Log2( cbHeight ) ) <= 2 ) && | |
| cbWidth <= MaxTbSizeY && cbHeight <= MaxTbSizeY ) | |
| intra_mip_flag[ x0 ][ y0 ] | ae(v) |
| if( intra_mip_flag[ x0 ][ y0 ] ) | |
| intra_mip_transposed[ x0 ][ y0 ] | ae(v) |
| intra_mip_mode[ x0 ][ y0 ] | ae(v) |
| else { | |
| if( sps_mrl_enabled_flag && ( ( y0 % CtbSizeY ) > 0 ) ) | |
| intra_luma_ref_idx[ x0 ][ y0 ] | ae(v) |
| if( sps_isp_enabled_flag && intra_luma_ref_idx[ x0 ][ y0 ] = = 0 | |
| && | |
| ( cbWidth <= MaxTbSizeY && cbHeight <= MaxTbSizeY ) && | |
| ( cbWidth * cbHeight > MinTbSizeY * MinTbSizeY ) ) | |
| intra_subpartitions_mode_flag[ x0 ][ y0 ] | ae(v) |
| if( intra_subpartitions_mode_flag[ x0 ][ y0 ] = = 1 ) | |
| intra_subpartitions_split_flag[ x0 ][ y0 ] | ae(v) |
| if( intra_luma_ref_idx[ x0 ][ y0 ] = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx[ x0 ][ y0 ] = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainded[ x0 ][ y0 ] | ae(v) |
| } | |
| } | |
| } | |
| } | |
| if( ( treeType = = SINGLE TREE ∥ treeType = = DUAL_TREE_CHROMA ) | |
| && | |
| ChromaArrayType != 0 ) { | |
| if ( pred_mode_plt_flag && treeType = = DUAL_TREE_CHROMA ) | |
| palette_coding( x0, y0, cbWidth / Sub WidthC, cbHeight / SubHeightC, 1, | |
| 2 ) | |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |
| } else if( treeType != DUAL_TREE_CHROMA ) { /* MODE_INTER or | |
| MODE_IBC */ | |
| if( cu_skip_flag[ x0 ][ y0 ] = = 0 ) | |
| general_merge_flag[ x0 ][ y0 ] | ae(v) |
| if( general_merge_flag[ x0 ][ y0 ] ) { | |
| merge_data( x0, y0, cbWidth, cbHeight, chType ) | |
| } else if( CuPredMode[ chType ][ x0 ][ y0 ] = = MODE_IBC ) { | |
| mvd_coding( x0, y0, 0, 0 ) | |
| if( MaxNumIbcMergeCand > 1 ) | |
| mvp_10_flag[ x0 ][ y0 ] | ae(v) |
| if( sps_amvr_enabled_flag && | |
| ( MvdL0[ x0 ][ y0 ][ 0 ] != 0 ∥ MvdL0[ x0 ][ y0 ][ 1 ] != 0 ) ) { | |
| amvr_precision_idx[ x0 ][ y0 ] | ae(v) |
| } | |
| } else { | |
| if( slice_type = = B ) | |
| inter_pred_idc[ x0 ][ y0 ] | ae(v) |
| if( sps_affine_enabled_flag && cbWidth >= 16 && cbHeight >= 16 ) { | |
| inter_affine_flag[ x0 ][ y0 ] | ae(v) |
| if( sps_affine_type_flag && inter_affine_flag[ x0 ][ y0 ] ) | |
| cu_affine_type_flag[ x0 ][ y0 ] | ae(v) |
| } | |
| if( sps_smvd_enabled_flag && !mvd_11_zero_flag && | |
| inter_pred_idc[ x0 ][ y0 ] = = PRED_BI && | |
| !inter_affine_flag[ x0 ][ y0 ] && RefIdxSymL0 > −1 && RefIdxSymL1 | |
| > −1 ) | |
| sym_mvd_flag[ x0 ][ y0 ] | ae(v) |
| if( inter_pred_idc[ x0 ][ y0 ] != PRED_L1 ) { | |
| if( NumRefIdxActive[ 0 ] > 1 && !sym_mvd_flag[ x0 ][ y0 ] ) | |
| ref_idx_10[ x0 ][ y0 ] | ae(v) |
| mvd_coding( x0, y0, 0, 0 ) | |
| if( MotionModelIdc[ x0 ][ y0 ] > 0 ) | |
| mvd_coding( x0, y0, 0, 1 ) | |
| if(MotionModelIdc[ x0 ][ y0 ] > 1 ) | |
| mvd_coding( x0, y0, 0, 2 ) | |
| mvp_10_flag[ x0 ][ y0 ] | ae(v) |
| } else { | |
| MvdL0[ x0 ][ y0 ][ 0 ] = 0 | |
| MvdL0[ x0 ][ y0 ][ 1 ] = 0 | |
| } | |
| if( inter_pred_idc[ x0 ][ y0 ] != PRED_L0 ) { | |
| if( NumRefIdxActive 1 ] > 1 && !sym_mvd_flag[ x0 ][ y0 ] ) | |
| ref_idx_11[ x0 ][ y0 ] | ae(v) |
| if( mvd_11_zero_flag && inter_pred_idc[ x0 ][ y0 ] = = PRED_BI ) { | |
| MvdL1[ x0 ][ y0 ][ 0 ] = 0 | |
| MvdL1[ x0 ][ y0 ][ 1 ] = 0 | |
| MvdCpL1[ x0 ][ y0 ][ 0 ][ 0 ] = 0 | |
| MvdCpL1[ x0 ][ y0 ][ 0 ][ 1 ] = 0 | |
| MvdCpL1[ x0 ][ y0 ][ 1 ][ 0 ] = 0 | |
| MvdCpL1[ x0 ][ y0 ][ 1 ][ 1 ] = 0 | |
| MvdCpL1[ x0 ][ y0 ][ 2 ][ 0 ] = 0 | |
| MvdCpL1[ x0 ][ y0 ][ 2 ][ 1 ] = 0 | |
| } else { | |
| if( sym_mvd_flag[ x0 ][ y0 ] ) { | |
| MvdL1[ x0 ][ y0 ][ 0 ] = −MvdL0[ x0 ][ y0 ][ 0 ] | |
| MvdL1[ x0 ][ y0 ][ 1 ] = −MvdL0[ x0 ][ y0 ][ 1 ] | |
| } else | |
| mvd_coding( x0, y0, 1, 0 ) | |
| if( MotionModelIdc[ x0 ][ y0 ] > 0 ) | |
| mvd_coding( x0, y0, 1, 1 ) | |
| if(MotionModelIdc[ x0 ][ y0 ] > 1 ) | |
| mvd_coding( x0, y0, 1, 2 ) | |
| mvp_11_flag[ x0 ][ y0 ] | ae(v) |
| } | |
| } else { | |
| MvdL1[ x0 ][ y0 ][ 0 ] = 0 | |
| MvdL1[ x0 ][ y0 ][ 1 ] = 0 | |
| } | |
| if( ( sps_amvr_enabled_flag && inter_affine_flag[ x0 ][ y0 ] = = 0 && | |
| ( MvdL0[ x0 ][ y0 ][ 0 ] != 0 ∥ MvdL0[ x0 ][ y0 ][ 1 ] != 0 ∥ | |
| MvdL1[ x0 ][ y0 ][ 0 ] != 0 ∥ MvdL1[ x0 ][ y0 ][ 1 ] != 0 ) ) ∥ | |
| ( sps_affine_amvr_enabled_flag && inter_affine_flag[ x0 ][ y0 ] = = 1 | |
| && | |
| ( MvdCpL0[ x0 ][ y0 ][ 0 ][ 0 ] != 0 ∥ MvdCpL0[ x0 ][ y0 ][ 0 ][ 1 ] != | |
| 0 ∥ | |
| MvdCpL1[ x0 ][ y0 ][ 0 ][ 0 ] != 0 ∥ MvdCpL1[ x0 ][ y0 ][ 0 ][ 1 ] != | |
| 0 ∥ | |
| MvdCpL0[ x0 ][ y0 ][ 1 ][ 0 ] != 0 ∥ MvdCpL0[ x0 ][ y0 ][ 1 ][ 1 ] != | |
| 0 ∥ | |
| MvdCpL1[ x0 ][ y0][ 1 ][ 0 ] != 0 ∥ MvdCpL1[ x0 ][ y0][ 1 ][ 1 ] != | |
| 0 ∥ | |
| MvdCpL0[ x0 ][ y0 ][ 2 ][ 0 ] != 0 ∥ MvdCpL0[ x0 ][ y0 ][ 2 ][ 1 ] != | |
| 0 ∥ | |
| MvdCpL1[ x0 ][ y0 ][ 2 ][ 0 ] != 0 ∥ MvdCpL1[ x0 ][ y0 ][ 2 ][ 1 ] != | |
| 0 ) ) { | |
| amvr_flag[ x0 ][ y0 ] | ae(v) |
| if( amvr_flag[ x0 ][ y0 ] ) | |
| amvr_precision_idx[ x0 ][ y0 ] | ae(v) |
| } | |
| if( sps_bcw_enabled_flag && inter_pred_idc[ x0 ][ y0 ] = = PRED_BI | |
| && | |
| luma_weight_10_flag[ ref_idx_10 [ x0 ][ y0 ] ] = = 0 && | |
| luma_weight_11_flag[ ref_idx_11 [ x0 ][ y0 ] ] = = 0 && | |
| chroma_weight_10_flag[ ref_idx_10 [ x0 ][ y0 ] ] = = 0 && | |
| chroma_weight_11_flag[ ref_idx_11 [ x0 ][ y0 ] ] = = 0 && | |
| cbWidth * cbHeight >= 256 ) | |
| bcw_idx[ x0 ][ y0 ] | ae(v) |
| } | |
| } | |
| if( CuPredMode[ chType ][ x0 ][ y0 ] != MODE_INTRA | |
| && !pred_mode_ph_flag && | |
| general_merge_flag[ x0 ][ y0 ] = = 0 ) | |
| cu_cbf | ae(v) |
| if( cu_cbf ) { | |
| if( CuPredMode[ chType ][ x0 ][ y0 ] = = MODE_INTER && | |
| sps_sbt_enabled_flag | |
| && !ciip_flag[ x0 ][ y0 ] && !MergeTriangleFlag[ x0 ][ y0 ] ) { | |
| if( cbWidth <= MaxSbtSize && cbHeight <= MaxSbtSize ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH ∥ allowSbtHorH ∥ allowSbtVerQ ∥ | |
| allowSbtHorQ ) | |
| cu_sbt_flag | ae(v) |
| } | |
| if( cu_sbt_flag ) { | |
| if( ( allowSbtVerH ∥ allowSbtHorH ) && ( allowSbtVerQ ∥ | |
| allowSbtHorQ ) ) | |
| cu_sbt_quad_flag | ae(v) |
| if( ( cu_sbt_quad_flag && allowSbtVerQ && allowSbtHorQ ) ∥ | |
| ( !cu_sbt_quad_flag && allowSbtVerH && allowSbtHorH ) ) | |
| cu_sbt_horizontal_flag | ae(v) |
| cu_sbt_pos_flag | ae(v) |
| } | |
| } | |
| LfnstDcOnly = 1 | |
| LfnstZeroOutSigCoeffFlag = 1 | |
| transform tree( x0, y0, cbWidth, cbHeight, treeType ) | |
| lfnstWidth = ( treeType = = | |
| DUAL_TREE_CHROMA ) ? cbWidth / Sub WidthC | |
| : cbWidth | |
| lfnstHeight = ( treeType = = | |
| DUAL_TREE_CHROMA ) ? cbHeight / SubHeightC | |
| : cbHeight | |
| if( Min( lfnstWidth, lfnstHeight ) >= 4 && sps_lfnst_enabled_flag = = 1 | |
| && | |
| CuPredMode[ chType ][ x0 ][ y0 ] = = MODE_INTRA && | |
| IntraSubPartitionsSplitType = = ISP_NO_SPLIT && | |
| ( !intra_mip_flag[ x0 ][ y0 ] ∥ Min( lfnstWidth, lfnstHeight ) >= 16 ) && | |
| tu_mts_idx[ x0 ][ y0 ] = = 0 && Max( cbWidth, cbHeight ) <= | |
| MaxTbSizeY ) { | |
| if( LfnstDcOnly = = 0 && LfnstZeroOutSigCoeffFlag = = 1 ) | |
| lfnst_idx[ x0 ][ y0 ] | ae(v) |
| } | |
| } | |

### 1.1.1.1 Palette Coding Syntax

| palette_coding( x0, y0, cbWidth, cbHeight, startComp, numComps ) { | Descriptor |
|---|---|
| palettePredictionFinished = 0 | |
| NumPredictedPaletteEntries = 0 | |
| for( predictorEntryIdx = 0; predictorEntryIdx < PredictorPaletteSize[ startComp ] | |
| && | |
| !palettePredictionFinished && | |
| NumPredictedPaletteEntries[ startComp ] < | |
| palette_max_size; predictorEntryIdx++ ) { | |
| palette_predictor_run | ae(v) |
| if( palette_predictor_run != 1 ) { | |
| if( palette_predictor_run > 1 ) | |
| predictorEntryIdx += palette_predictor_run − 1 | |
| PalettePredictorEntryReuseFlags[ predictorEntryIdx ] = 1 | |
| NumPredictedPaletteEntries++ | |
| } else | |
| palettePredictionFinished = 1 | |
| } | |
| if( NumPredictedPaletteEntries < palette_max_size ) | |
| num_signalled_palette_entries | ae(v) |
| for( cIdx = startComp; cIdx < ( startComp + numComps ); cIdx++ ) | |
| for( i = 0; i < num_signalled_palette_entries; i++ ) | |
| new_palette_entries[ cIdx ][ i ] | ae(v) |
| if( CurrentPaletteSize[ startComp ] > 0 ) | |
| palette_escape_val_present_flag | ae(v) |
| if( MaxPaletteIndex > 0 ) { | |
| num_palette_indices_minus1 | ae(v) |
| adjust = 0 | |
| for( i = 0; i <= num_palette_indices_minus1; i++ ) { | |
| if( MaxPaletteIndex − adjust > 0 ) { | |
| palette_idx_idc | ae(v) |
| PaletteIndexIdc[ i ] = palette_idx_idc | |
| } | |
| adjust = 1 | |
| } | |
| copy_above_indices_for_final_run_flag | ae(v) |
| palette_transpose_flag | ae(v) |
| } | |
| if( treeType != DUAL_TREE_CHROMA && palette_escape_val_present_flag ) | |
| { | |
| if( cu_qp_delta_enabled_flag && !IsCuQpDeltaCoded ) { | |
| cu_qp_delta_abs | ae(v) |
| if( cu_qp_delta_abs ) | |
| cu_qp_delta_sign_flag | ae(v) |
| } | |
| } | |
| if( treeType != DUAL_TREE_LUMA && palette_escape_val_present_flag ) { | |
| if( cu_chroma_qp_offset_enabled_flag && !IsCuChromaQpOffsetCoded ) { | |
| cu_chroma_qp_offset_flag | ae(v) |
| if( cu_chroma_qp_offset_flag ) | |
| cu_chroma_qp_offset_idx | ae(v) |
| } | |
| } | |
| remainingNumIndices = num_palette_indices_minus1 + 1 | |
| PaletteScanPos = 0 | |
| log2CbWidth = Log2( cbWidth ) | |
| log2CbHeight = Log2( cbHeight ) | |
| while( PaletteScanPos < cbWidth*cbHeightt ) { | |
| xC = | |
| x0 + TraverseScanOrder[ log2CbWidth ][ log2CbHeight ][ PaletteScanPos ][ 0 ] | |
| yC = | |
| y0 + TraverseScanOrder[ log2CbWidth ][ log2CbHeight ][ PaletteScanPos][ 1 ] | |
| if( PaletteScanPos > 0 ) { | |
| xcPrev = | |
| x0 + TraverseScanOrder[ log2CbWidth ][ log2CbHeight ][ PaletteScanPos − 1 ][ 0 ] | |
| ycPrev = | |
| y0 + TraverseScanOrder[ log2CbWidth ][ log2CbHeight ][ PaletteScanPos − 1 ][ 1 ] | |
| } | |
| PaletteRunMinus1 = cbWidth * cbHeight − PaletteScanPos − 1 | |
| RunToEnd = 1 | |
| CopyAboveIndicesFlag[ xC ][ yC ] = 0 | |
| if( MaxPaletteIndex > 0 ) | |
| if( ( ( !palette_transpose_flag && yC > 0 ) ∥ ( palette_transpose_flag && | |
| xC > 0 ) ) | |
| && CopyAboveIndicesFlag[ xcPrev ][ ycPrev ] = = 0 ) | |
| if( remainingNumIndices > 0 && PaletteScanPos < cbWidth* cbHeight − | |
| 1 ) { | |
| copy_above_palette_indices_flag | ae(v) |
| CopyAboveIndicesFlag[ xC ][ yC ] = copy_above_palette_indices_flag | |
| } else { | |
| if( PaletteScanPos = = cbWidth * cbHeight − 1 && | |
| remainingNumIndices > 0 ) | |
| CopyAboveIndicesFlag[ xC ][ yC ] = 0 | |
| else | |
| CopyAboveIndicesFlag[ xC ][ yC ] = 1 | |
| } | |
| if( CopyAboveIndicesFlag[ xC ][ yC ] = = 0 ) { | |
| currNumIndices = num_palette_indices_minus1 + 1 − remainingNumIndices | |
| PaletteIndexMap[ xC ][ yC ] = PaletteIndexIdc[ currNumIndices ] | |
| } | |
| if( MaxPaletteIndex > 0 ) { | |
| if( CopyAboveIndicesFlag[ xC ][ yC ] = = 0 ) | |
| remainingNumIndices − = 1 | |
| if( remainingNumIndices > 0 ∥ CopyAboveIndicesFlag[ xC ][ yC ] != | |
| copy_above_indices_for_final_run_flag ) { | |
| PaletteMaxRunMinus1 = cbWidth * cbHeight − PaletteScanPos − 1 − | |
| remainingNumIndices − copy_above_indices_for_final_run_flag | |
| RunToEnd = 0 | |
| if( PaletteMaxRunMinus 1 > 0 ) { | |
| palette_run_prefix | ae(v) |
| if( ( palette_run_prefix > 1 ) && ( PaletteMaxRunMinus 1 != | |
| ( 1 << ( palette_run_prefix − 1 ) ) ) ) | |
| palette_run_suffix | ae(v) |
| } | |
| } | |
| } | |
| runPos = 0 | |
| while ( runPos <= PaletteRunMinus1 ) { | |
| xR = x0 + | |
| TraverseScanOrder[ log2CbWidth ][ log2CbHeight ][ PaletteScanPos ][ 0 ] | |
| yR = | |
| y0 + TraverseScanOrder[ log2CbWidth ][ log2CbHeight ][ PaletteScanPos ][ 1 ] | |
| if( CopyAboveIndicesFlag[ xC ][ yC ] = = 0 ) { | |
| CopyAboveIndicesFlag[ xR ][ yR ] = 0 | |
| PaletteIndexMap[ xR ][ yR ] = PaletteIndexMap[ xC ][ yC ] | |
| } else { | |
| CopyAboveIndicesFlag[ xR ][ yR ] = 1 | |
| if( !palette_transpose_flag ) | |
| PaletteIndexMap[ xR ][ yR ] = PaletteIndexMap[ xR ][ yR − 1 ] | |
| else | |
| PaletteIndexMap[ xR ][ yR ] = PaletteIndexMap[ xR − 1 ][ yR ] | |
| } | |
| runPos++ | |
| PaletteScanPos ++ | |
| } | |
| } | |
| if( palette_escape_val_present_flag ) { | |
| for( cIdx = startComp; cIdx < ( startComp + numComps ); cIdx++ ) | |
| for( sPos = 0; sPos < cbWidth* cbHeight; sPos++ ) { | |
| xC = x0 + TraverseScanOrder[ log2CbWidth][ log2CbHeight][ sPos ][ 0 ] | |
| yC = y0 + TraverseScanOrder[ log2CbWidth][ log2CbHeight][ sPos][ 1 ] | |
| if( PaletteIndexMap[ cIdx ][ xC ][ yC ] = = MaxPaletteIndex ) { | |
| palette_escape_val | ae(v) |
| PaletteEscapeVal[ cIdx ][ xC ][ yC ] = palette_escape_val | |
| } | |
| } | |
| } | |
| } | |

### 1.1.1.2 Merge Data Syntax

| merge data( x0, y0, cbWidth, cbHeight, chType ) { | Descriptor |
|---|---|
| if( CuPredMode[ chType ][ x0 ][ y0 ] = = MODE_IBC ) { | |
| if( MaxNumIbcMergeCand > 1 ) | |
| merge_idx[ x0 ][ y0 ] | ae(v) |
| } else { | |
| if( MaxNumSubblockMergeCand > 0 && cbWidth >= 8 && cbHeight | |
| >= 8 ) | |
| merge_subblock_flag[ x0 ][ y0 ] | ae(v) |
| if( merge_subblock_flag[ x0 ][ y0 ] = = 1 ) { | |
| if( MaxNumSubblockMergeCand > 1 ) | |
| merge_subblock_idx[ x0 ][ y0 ] | ae(v) |
| } else { | |
| if( ( cbWidth * cbHeight ) >= 64 && ( (sps_cup_enabled_flag && | |
| cu_skip_flag[ x0 ][ y0 ] = = 0 && cbWidth < 128 && cbHeight < | |
| 128 ) ∥ | |
| ( sps_triangle_enabled_flag && MaxNumTriangleMergeCand > 1 | |
| && | |
| slice_type = = B ) ) ) | |
| regular_merge_flag[ x0 ][ y0 ] | ae(v) |
| if( regular_merge_flag[ x0 ][ y0 ] = = 1 ){ | |
| if( sps_mmvd_enabled_flag ) | |
| mmvd_merge_flag[ x0 ][ y0 ] | ae(v) |
| if( mmvd_merge_flag[ x0 ][ y0 ] = = 1 ) { | |
| if( MaxNumMergeCand > 1 ) | |
| mmvd_cand_flag[ x0 ][ y0 ] | ae(v) |
| mmvd_distance_idx[ x0 ][ y0 ] | ae(v) |
| mmvd_direction_idx[ x0 ][ y0 ] | ae(v) |
| } else { | |
| if( MaxNumMergeCand > 1 ) | |
| merge_idx[ x0 ][ y0 ] | ae(v) |
| } | |
| } else { | |
| if( sps_cup_enabled_flag && sps_triangle_enabled_flag && | |
| MaxNumTriangleMergeCand > 1 && slice_type = = B && | |
| cu_skip_flag[ x0 ][ y0 ] = = 0 && | |
| ( cbWidth * cbHeight ) >= 64 && cbWidth < 128 && cbHeight < | |
| 128 ) { | |
| ciip_flag[ x0 ][ y0 ] | ae(v) |
| if( cup_flag[ x0 ][ y0 ] && MaxNumMergeCand > 1 ) | |
| merge_idx[ x0 ][ y0 ] | ae(v) |
| if( !cup_flag[ x0 ][ y0 ] && MaxNumTriangleMergeCand > 1 ) { | |
| merge_triangle_split_did[ x0 ][ y0 ] | ae(v) |
| merge_triangle_idx0[ x0 ][ y0 ] | ae(v) |
| merge_triangle_idx1[ x0 ][ y0 ] | ae(v) |
| } | |
| } | |
| } | |
| } | |
| } | |

### 1.1.1.3 Motion Vector Difference Syntax

| mvd_coding( x0, y0, refList ,cpIdx ) { | Descriptor |
|---|---|
| abs_mvd_greater0_flag[ 0 ] | ae(v) |
| abs_mvd_greater0_flag[ 1 ] | ae(v) |
| if( abs_mvd_greater0_flag[ 0 ] ) | |
| abs_mvd_greatert_flag 0 | ae(v) |
| if( abs_mvd_greater0_flag[ 1 ] ) | |
| abs_mvd_greatert_flag[ 1 ] | ae(v) |
| if( abs_mvd_greater0_flag[ 0 ] ) { | |
| if( abs_mvd_greater1_flag[ 0 ] ) | |
| abs_mvd_minus2[ 0 ] | ae(v) |
| mvd_sign_flag[ 0 ] | ae(v) |
| } | |
| if( abs_mvd_greater0_flag[ 1 ] ) { | |
| if( abs_mvd_greater1_flag[ 1 ] ) | |
| abs_mvd_minus2[ 1 ] | ae(v) |
| mvd_sign_flag[ 1 ] | ae(v) |
| } | |
| } | |

### 1.1.1.4 Transform Tree Syntax

| transform tree( x0, y0, tbWidth, tbHeight, treeType, chType ) { | Descriptor |
|---|---|
| InferTuCbfLuma = 1 | |
| if( IntraSubPartitionsSplitType = = ISP_NO_SPLIT && !cu_sbt_flag ) { | |
| if( tbWidth > MaxTbSizeY ∥ tbHeight > MaxTbSizeY ) { | |
| verSplitFirst = ( tbWidth > MaxTbSizeY && tbWidth > tbHeight ) ? 1 : 0 | |
| trafoWidth = verSplitFirst ? (tbWidth / 2) : tbWidth | |
| trafoHeight = !verSplitFirst ? (tbHeight / 2) : tbHeight | |
| transform tree( x0, y0, trafoWidth, trafoHeight, chType ) | |
| if( verSplitFirst ) | |
| transform_tree( x0 + trafoWidth, y0, trafoWidth, trafoHeight, treeType, chType ) | |
| else | |
| transform_tree( x0, y0 ] trafoHeight, trafoWidth, trafoHeight, treeType, chType ) | |
| } else { | |
| transform_unit( x0, y0, tbWidth, tbHeight, treeType, 0, chType ) | |
| } | |
| } else if( cu_sbt_flag ) { | |
| if( !cu_sbt_horizontal_flag) { | |
| trafoWidth = tbWidth * SbtNumFourthsTb0 / 4 | |
| transform_unit( x0, y0, trafoWidth, tbHeight, treeType, 0, 0) | |
| transform_unit( x0 + trafoWidth, y0, tbWidth − trafoWidth, tbHeight, treeType, | |
| 1, 0 ) | |
| } else { | |
| trafoHeight = tbHeight * SbtNumFourthsTb0 / 4 | |
| transform_unit( x0, y0, tbWidth, trafoHeight, treeType, 0, 0) | |
| transform_unit( x0, y0 ] trafoHeight, tbWidth, tbHeight − trafoHeight, treeType, | |
| 1, 0 ) | |
| } | |
| } else if( IntraSubPartitionsSplitType = = ISP_HOR_SPLIT ) { | |
| trafoHeight = tbHeight / NumIntraSubPartitions | |
| for( partIdx = 0; partIdx < NumIntraSubPartitions; partIdx][ ) | |
| transform_unit( x0, y0 ] trafoHeight * partIdx, tbWidth, trafoHeight, treeType, | |
| partIdx, 0) | |
| } else if( IntraSubPartitionsSplitType = = ISP_VER_SPLIT) { | |
| trafoWidth = tbWidth / NumIntraSubPartitions | |
| for( partIdx = 0; partIdx < NumIntraSubPartitions; partIdx][ ) | |
| transform_unit( x0 + trafoWidth * partIdx, y0, trafoWidth, tbHeight, treeType, | |
| partIdx, 0) | |
| } | |
| } | |

### 1.1.1.5 Transform Unit Syntax

| transform unit( x0, y0, tbWidth, tbHeight, treeType, subTuIndex, chType ) { | Descriptor |
|---|---|
| if( ( treeType = = SINGLE TREE ∥ treeType = = DUAL_TREE_CHROMA ) | |
| && | |
| ChromaArrayType != 0 ) { | |
| if( ( IntraSubPartitionsSplitType = = ISP_NO_SPLIT && !( cu_sbt_flag && | |
| ( ( subTuIndex = = 0 && cu_sbt_pos_flag ) ∥ | |
| ( subTuIndex = = 1 && !cu_sbt_pos_flag ) ) ) ) ∥ | |
| ( IntraSubPartitionsSplitType != ISP_NO_SPLIT && | |
| ( subTuIndex = = NumIntraSubPartitions − 1 ) ) ) { | |
| tu_cbf_cb[ x0 ][ y0 ] | ae(v) |
| tu_cbf_cr[ x0 ][ y0 ] | ae(v) |
| } | |
| } | |
| if( treeType = = SINGLE_TREE ∥ treeType = = DUAL_TREE_LUMA ) { | |
| if( ( IntraSubPartitionsSplitType = = ISP_NO_SPLIT && !( cu_sbt_flag && | |
| ( ( subTuIndex = = 0 && cu_sbt_pos flag ) ∥ | |
| ( subTuIndex = = 1 && !cu_sbt_pos_flag ) ) ) && | |
| ( CuPredMode[ chType ][ x0 ][ y0 ] = = MODE_INTRA ∥ | |
| tu_cbf_cb[ x0 ][ y0 ] ∥ tu_cbf_cr[ x0 ][ y0 ] ∥ | |
| CbWidth[ chType ][ x0 ][ y0 ] > MaxTbSizeY ∥ | |
| CbHeight[ chType ][ x0 ][ y0 ] > MaxTbSizeY ) ) ∥ | |
| ( IntraSubPartitionsSplitType != ISP_NO_SPLIT && | |
| ( subTuIndex < NumIntraSubPartitions − 1 ∥ !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && !tu_cbf_luma[ x0 ][ y0 ] | |
| } | |
| if( IntraSubPartitionsSplitType != ISP_NO_SPLIT && | |
| treeType = = SINGLE TREE && subTuIndex = = NumIntraSubPartitions − 1 | |
| ) ) | |
| xC = CbPosX[ chType ][ x0 ][ y0 ] | |
| yC = CbPosY[ chType ][ x0 ][ y0 ] | |
| wC = CbWidth[ chType ][ x0 ][ y0 ] / Sub WidthC | |
| hC = CbHeight[ chType ][ x0 ][ y0 ] / SubHeightC | |
| } else | |
| xC = x0 | |
| yC = y0 | |
| wC = tbWidth / Sub WidthC | |
| hC = tbHeight / SubHeightC | |
| } | |
| if( ( CbWidth[ chType ][ x0 ][ y0 ] > 64 ∥ | |
| CbHeight[ chType ][ x0 ][ y0 ] > 64 ∥ | |
| tu_cbf_luma[ x0 ][ y0 ] ∥ tu_cbf_cb[ x0 ][ y0 ] ∥ | |
| tu_cbf_cr[ x0 ][ y0 ] ) && | |
| treeType != DUAL TREE CHROMA ) { | |
| if( cu_qp_delta_enabled_flag && !IsCuQpDeltaCoded ) { | |
| cu_qp_delta_abs | ae(v) |
| if( cu_qp_delta_abs ) | |
| cu_qp_delta_sign_flag | ae(v) |
| } | |
| } | |
| if( ( tu_cbf_cb[ x0 ][ y0 ] ∥ tu_cbf_cr[ x0 ][ y0 ] ) { | |
| if( cu_chroma_qp_offset_enabled_flag && !IsCuChromaQpOffsetCoded) { | |
| cu_chroma_qp_offset_flag | ae(v) |
| if( cu_chroma_qp_offset_flag && chroma_qp_offset_list_len_minus1 > 0) | |
| cu_chroma_qp_offset_idx | ae(v) |
| } | |
| } | |
| if( sps_joint_cbcr_enabled_flag && ( ( CuPredMode[ chType ][ x0 ][ y0 ] = = | |
| MODE_INTRA | |
| && ( tu_cbf_cb[ x0 ][ y0 ] ∥ tu_cbf_cr[ x0 ][ y0 ] ) ) ∥ | |
| ( tu_cbf_cb[ x0 ][ y0 ] && tu_cbf_cr[ x0 ][ y0 ] ) ) ) | |
| tu_joint_cbcr_residual_flag[ x0 ][ y0 ] | ae(v) |
| if( tu_cbf_luma[ x0 ][ y0 ] && treeType != DUAL TREE CHROMA | |
| && ( tbWidth <= 32) && ( tbHeight <= 32) | |
| && ( IntraSubPartitionsSplit[ x0 ][ y0 ] = = ISP_NO_SPLIT ) | |
| && ( !cu_sbt_flag ) ) { | |
| if( sps_transform_skip_enabled_flag && !BdpcmFlag[ x0 ][ y0 ] && | |
| tbWidth <= MaxTsSize && tbHeight <= MaxTsSize ) | |
| transform_skip_flag[ x0 ][ y0 ] | ae(v) |
| if( ( ( CuPredMode[ chType ][ x0 ][ y0 ] = = MODE INTER && | |
| sps_explicit_mts_inter_enabled_flag ) | |
| ∥( CuPredMode[ chType ][ x0 ][ y0 ] = = MODE INTRA && | |
| sps_explicit_mts_intra_enabled_flag ) ) && | |
| ( !transform_skip_flag[ x0 ][ y0 ] ) ) | |
| tu_mts_idx[ x0 ][ y0 ] | ae(v) |
| } | |
| if( tu_cbf_luma[ x0 ][ y0 ] ) { | |
| if( !transform_skip_flag[ x0 ][ y0 ] ) | |
| residual_coding( x0, y0, Log2( tbWidth ), Log2( tbHeight ), 0 ) | |
| else | |
| residual_ts_coding( x0, y0, Log2( tbWidth ), Log2( tbHeight ), 0 ) | |
| } | |
| if( tu_cbf_cb[ x0 ][ y0 ] ) | |
| residual_coding( xC, yC, Log2( wC ), Log2( hC ), 1 ) | |
| if( tu_cbf_cr[ x0 ][ y0 ] && | |
| !( tu_cbf_cb[ x0 ][ y0 ] && tu_joint_cbcr_residual_flag[ x0 ][ y0 ] )) { | |
| residual_coding( xC, yC, Log2( wC ), Log2( hC ), 2 ) | |
| } | |
| } | |

### 1.1.1.6 Residual Coding Syntax

| residual_coding( x0, y0, log2TbWidth, log2TbHeight, cIdx ) { | Descriptor |
|---|---|
| if( ( tu_mts_idx[ x0 ][ y0 ] > 0 ∥ | |
| ( cu_sbt_flag && log2TbWidth < 6 && log2TbHeight < 6 ) ) | |
| && cIdx = = 0 && log2TbWidth > 4 ) | |
| log2ZoTbWidth = 4 | |
| else | |
| log2ZoTbWidth = Min( log2TbWidth, 5 ) | |
| MaxCcbs = 2 * ( 1 << log2TbWidth ) * ( 1 << log2TbHeight) | |
| if( tu_mts_idx[ x0 ][ y0 ] > 0 ∥ | |
| ( cu_sbt_flag && log2TbWidth < 6 && log2TbHeight < 6 ) ) | |
| && cIdx = = 0 && log2TbHeight > 4 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight) < 2 ? 1 : 2) | |
| log2SbH = log2SbW | |
| if( log2TbWidth + log2TbHeight > 3 ) { | |
| if( log2TbWidth < 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| } | |
| numSbCoeff = 1 << ( log2SbW + log2SbH ) | |
| lastScanPos = numSbCoeff | |
| lastSubBlock = ( 1 << ( | |
| log2TbWidth + log2TbHeight − ( log2SbW + log2SbH ) ) ) − 1 | |
| do { | |
| if( lastScanPos = = 0) { | |
| lastScanPos = numSbCoeff | |
| lastSubBlock- - | |
| } | |
| lastScanPos- - | |
| xS = | |
| DiagScanOrder[ log2TbWidth − log2SbW ][ log2TbHeight − log2SbH ] | |
| [ lastSubBlock ][ 0 ] | |
| yS = | |
| DiagScanOrder[ log2TbWidth − log2SbW ][ log2TbHeight − log2SbH ] | |
| [ lastSubBlock ][ 1 ] | |
| xC = ( xS << log2SbW ) + | |
| DiagScanOrder[ log2SbW ][ log2SbH ][ lastScanPos ][ 0 ] | |
| yC = ( yS << log2SbH ) + | |
| DiagScanOrder[ log2SbW ][ log2SbH ][ lastScanPos][ 1 ] | |
| } while( ( xC != LastSignificantCoeffX ) ∥ ( yC != | |
| LastSignificantCoeffY ) ) | |
| if( lastSubBlock = = 0 && log2TbWidth >= 2 && log2TbHeight >= 2 | |
| && | |
| !transform_skip_flag[ x0 ][ y0 ] && lastScanPos > 0 ) | |
| LfnstDcOnly = 0 | |
| if( ( lastSubBlock > 0 && log2TbWidth >= 2 && log2TbHeight >= 2 ) ∥ | |
| ( lastScanPos > 7 && ( log2TbWidth = = 2 ∥ log2TbWidth = = 3 ) && | |
| log2TbWidth = = log2TbHeight ) ) | |
| LfnstZeroOutSigCoeffFlag = 0 | |
| QState = 0 | |
| for( i = lastSubBlock; i >= 0; i− − ) { | |
| startQStateSb = QState | |
| xS = | |
| DiagScanOrder[ log2TbWidth − log2SbW ][ log2TbHeight − log2SbH ] | |
| [ i ][ 0 ] | |
| yS = | |
| DiagScanOrder[ log2TbWidth − log2SbW ][ log2TbHeight − log2SbH ] | |
| [ i ][ 1 ] | |
| inferSbDcSigCoeffFlag = 0 | |
| if( ( i < lastSubBlock ) && ( i > 0 ) ) { | |
| coded_sub_block_flag[ xS ][ yS ] | ae(v) |
| inferSbDcSigCoeffFlag = 1 | |
| } | |
| firstSigScanPosSb = numSbCoeff | |
| lastSigScanPosSb = −1 | |
| firstPosMode0 = ( i = = lastSubBlock ? lastScanPos : numSbCoeff − 1) | |
| firstPosModel = −1 | |
| for( n = firstPosMode0; n >= 0 && remBinsPass1 >= 4; n− −) { | |
| xC = ( xS << log2SbW ) + | |
| DiagScanOrder[ log2SbW ][ log2SbH ][ n ][ 0 ] | |
| yC = ( yS << log2SbH ) + | |
| DiagScanOrder[ log2SbW ][ log2SbH ][ n ][ 1 ] | |
| if( coded_sub_block_flag[ xS ][ yS ] && ( n > 0 ∥ | |
| !inferSbDcSigCoeffFlag ) && | |
| ( xC != LastSignificantCoeffX ∥ yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |
| inferSbDcSigCoeffFlag = 0 | |
| } | |
| if( sig_coeff_flag[ xC ][ yC ] ) { | |
| abs_level_gtx_flag[ n ][ 0 ] | ae(v) |
| remBinsPass1− − | |
| if( abs_level_gtx_flag[ n ][ 0 ] ) { | |
| par_level_flag[ n ] | ae(v) |
| remBinsPass1− − | |
| abs_level_gtx_flag[ n ][ 1 ] | ae(v) |
| remBinsPass1− − | |
| } | |
| if( lastSigScanPosSb = = −1) | |
| lastSigScanPosSb = n | |
| firstSigScanPosSb = n | |
| } | |
| AbsLevelPass1[ xC ][ yC ] = sig_coeff_flag[ xC ][ yC ] + | |
| par_level_flag[ n ] + | |
| abs_level_gtx_flag[ n ][ 0 ] + | |
| 2 * abs_level_gtx_flag[ n ][ 1 ] | |
| if( dep_quant_enabled_flag ) | |
| QState = QStateTransTable[ QState ][ AbsLevelPass1[ xC ][ yC ] & | |
| 1] | |
| if( remBinsPass1 < 4 ) | |
| firstPosModel = n − 1 | |
| } | |
| for( n = numSbCoeff − 1; n >= firstPosModel; n− − ) { | |
| xC = ( xS << log2SbW ) + | |
| DiagScanOrder[ log2SbW ][ log2SbH ][ n ][ 0 ] | |
| yC = ( yS << log2SbH ) + | |
| DiagScanOrder[ log2SbW ][ log2SbH ][ n ][ 1 ] | |
| if( abs_level_gtx_flag[ n ][ 1 ] ) | |
| abs_remainder[ n ] | ae(v) |
| AbsLevel[ xC ][ yC ] = AbsLevelPass1[ xC ][ yC ] | |
| +2 * abs_remainder[ n ] | |
| } | |
| for( n = firstPosModel; n >= 0; n− − ) { | |
| xC = ( xS << log2SbW ) + | |
| DiagScanOrder[ log2SbW ][ log2SbH ][ n ][ 0 ] | |
| yC = ( yS << log2SbH ) + | |
| DiagScanOrder[ log2SbW ][ log2SbH ][ n ][ 1 ] | |
| dec_abs_level[ n ] | ae(v) |
| if(AbsLevel[ xC ][ yC ] > 0 ) | |
| firstSigScanPosSb = n | |
| if( dep_quant_enabled_flag ) | |
| QState = QStateTransTable[ QState ][ AbsLevel[ xC ][ yC ] & 1 ] | |
| } | |
| if( dep_quant_enabled_flag ∥ !sign_data_hiding_enabled_flag ) | |
| signHidden = 0 | |
| else | |
| signHidden = ( lastSigScanPosSb − firstSigScanPosSb > 3 ? 1 : 0 ) | |
| for( n = numSbCoeff − 1; n >= 0; n− − ) { | |
| xC = ( xS << log2SbW ) + | |
| DiagScanOrder[ log2SbW ][ log2SbH ][ n ][ 0 ] | |
| yC = ( yS << log2SbH ) + | |
| DiagScanOrder[ log2SbW ][ log2SbH ][ n ][ 1 ] | |
| if( ( AbsLevel[ xC ][ yC ] > 0 ) && | |
| ( !signHidden ∥ ( n != firstSigScanPosSb ) ) ) | |
| coeff_sign_flag[ n ] | ae(v) |
| } | |
| if( dep_quant_enabled_flag) { | |
| QState = startQStateSb | |
| for( n = numSbCoeff − 1; n >= 0; n− − ) { | |
| xC = ( xS << log2SbW ) + | |
| DiagScanOrder[ log2SbW ][ log2SbH ][ n ][ 0 ] | |
| yC = ( yS << log2SbH ) + | |
| DiagScanOrder[ log2SbW ][ log2SbH ][ n ][ 1 ] | |
| if( AbsLevel[ xC ][ yC] > 0 ) | |
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| ( 1 − 2 * coeff_sign_flag[ n ] ) | |
| QState = QStateTransTable[ QState ][ par_level_flag[ n ] ] | |
| } else { | |
| sumAbsLevel = 0 | |
| for( n = numSbCoeff − 1; n >= 0; n− − ) { | |
| xC = ( xS << log2SbW ) + | |
| DiagScanOrder[ log2SbW ][ log2SbH ][ n ][ 0 ] | |
| yC = ( yS << log2SbH ) + | |
| DiagScanOrder[ log2SbW ][ log2SbH ][ n ][ 1 ] | |
| if( AbsLevel[ xC ][ yC ] > 0 ) { | |
| TransCoeffLevel[ x0 ][ y0 ][ cIdx ][ xC ][ yC ] = | |
| AbsLevel[ xC ][ yC ] * ( 1 − 2 * coeff_sign_flag[ n ] ) | |
| if( signHidden ) { | |
| sumAbsLevel += AbsLevel[ xC ][ yC ] | |
| if( ( n = = firstSigScanPosSb ) && ( sumAbsLevel % 2) = = | |
| 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| } | |
| residual_ts_coding( x0, y0, log2TbWidth, log2TbHeight, cIdx ) { | Descriptor |
| log2SbSize = ( Min( log2TbWidth, log2TbHeight ) < 2 ? 1 : 2 ) | |
| numSbCoeff = 1 << ( log2SbSize << 1 ) | |
| lastSubBlock = ( 1 << ( log2TbWidth + log2TbHeight − 2 * log2SbSize ) | |
| ) − 1 | |
| inferSbCbf = 1 | |
| MaxCcbs = 2 * ( 1 << log2TbWidth ) * ( 1<< log2TbHeight ) | |
| for( i = 0; i <= lastSubBlock; i++ ) { | |
| xS = | |
| DiagScanOrder[ log2TbWidth − log2SbSize ][ log2TbHeight − log2SbSize ][ i | |
| ][ 0 ] | |
| yS = | |
| DiagScanOrder[ log2TbWidth − log2SbSize ][ log2TbHeight − log2SbSize ][ i | |
| ][ 1 ] | |
| if( ( i != lastSubBlock ∥ !inferSbCbf ) { | |
| coded_sub_block_flag[ xS ][ yS ] | ae(v) |
| } | |
| if( coded_sub_block_flag[ xS ][ yS ] && i < lastSubBlock ) | |
| inferSbCbf = 0 | |
| /* First scan pass */ | |
| inferSbSigCoeffFlag = 1 | |
| for( n = 0; n <= numSbCoeff − 1; n++ ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( coded_sub_block_flag[ xS ][ yS ] && | |
| ( n != numSbCoeff − 1 ∥ !inferSbSigCoeffFlag ) ) { | |
| sig_coeff_flag[ xC ][ yC ] | ae(v) |
| MaxCcbs- - | |
| if( sig_coeff_flag[ xC ][ yC ] ) | |
| inferSbSigCoeffFlag = 0 | |
| } | |
| CoeffSignLevel[ xC ][ yC ] = 0 | |
| if( sig_coeff_flag[ xC ][ yC ] { | |
| coeff_sign_flag[ n ] | ae(v) |
| MaxCcbs- - | |
| CoeffSignLevel[ xC ][ yC ] = ( coeff_sign_flag[ n ] > 0 ? −1 : 1 ) | |
| abs_level_gtx_flag[ n ][ 0 ] | ae(v) |
| MaxCcbs- - | |
| if( abs_level_gtx_flag[ n ][ 0 ] ) { | |
| par_level_flag[ n ] | ae(v) |
| MaxCcbs- - | |
| } | |
| } | |
| AbsLevelPassX[ xC ][ yC ] = | |
| sig_coeff_flag[ xC ][ yC ] + par_level_flag[ n ] + | |
| abs_level_gtx_flag[ n ][ 0 ] | |
| } | |
| /* Greater than X scan pass (numGtXFlags=5) */ | |
| for( n = 0; n <= numSbCoeff − 1; n++ ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| for( j = 1; j < 5; j++ ) { | |
| if( abs_level_gtx_flag[ n ][ j − 1 ] ) | |
| abs_level_gtx_flag[ n ][ j ] | ae(v) |
| MaxCcbs- - | |
| AbsLevelPassX[ xC ][ yC ] += 2 * abs_level_gtx_flag[ n ][ j ] | |
| } | |
| } | |
| /* remainder scan pass */ | |
| for( n = 0; n <= numSbCoeff − 1; n++ ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( abs_level_gtx_flag[ n ][ 4 ] ) | |
| abs_remainder[ n ] | ae(v) |
| if( intra_bdpcm_flag = = 0 ) { | |
| absRightCoeff = abs( | |
| TransCoeffLevel[ x0 ][ y0 ][ cIdx ][ xC − 1 ][ yC ] ) | |
| absBelowCoeff = abs( | |
| TransCoeffLevel[ x0 ][ y0 ][ cIdx ][ xC ][ yC − 1 ] ) | |
| predCoeff = Max( absRightCoeff, absBelowCoeff ) | |
| if( AbsLevelPassX[ xC ][ yC ] + abs_remainder[ n ] = = 1 && | |
| predCoeff > 0 ) | |
| TransCoeffLevel[ x0 ][ y0 ][ cIdx ][ xC ][ yC ] = | |
| ( 1 − 2 * coeff_sign_flag[ n ] ) * predCoeff | |
| else if( AbsLevelPassX[ xC ][ yC ] + abs_remainder[ n ] <= | |
| predCoeff) | |
| TransCoeffLevel[ x0 ][ y0 ][ cIdx ][ xC ][ yC ] = ( 1 − 2 * | |
| coeff_sign_flag[ n ] ) * | |
| ( AbsLevelPassX[ xC ][ yC ] + | |
| abs_remainder[ n ] − 1 ) | |
| else | |
| TransCoeffLevel[ x0 ][ y0 ][ cIdx ][ xC ][ yC ] = ( 1− 2 * | |
| coeff_sign_flag[ n ] ) * | |
| ( AbsLevelPassX[ xC ][ yC ] + | |
| abs_remainder[ n ] ) | |
| } else | |
| TransCoeffLevel[ x0 ][ y0 ][ cIdx ][ xC ][ yC ] = ( 1 − 2 * | |
| coeff_sign_flag[ n ] ) * | |
| ( AbsLevelPassX[ xC ][ yC ] + | |
| abs_remainder[ n ] ) | |
| } | |
| } | |
| } | |

### 1.1.1.7 Coding Unit Semantics

The following assignments are made for x=x0 . . . x0+cbWidth−1 and y=y0 . . . y0+cbHeight−1:

CbPosX[chType][x][y]=x0 (7-134)

CbPosY[chType][x][y]=y0 (7-135)

CbWidth[chType][x][y]=cbWidth (7-136)

CbHeight[chType][x][y]=cbHeight (7-137)

CqtDepth[chType][x][y]=cqtDepth (7-138)

The variable CclmEnabled is derived by invoking the cross-component chroma intra prediction mode checking process specified in clause 8.4.4 with the luma location (xCb, yCb) set equal to (x0, y0) as input.

cu_skip_flag[x0][y0] equal to 1 specifies that for the current coding unit, when decoding a P or B slice, no more syntax elements except one or more of the following are parsed after cu_skip_flag[x0][y0]: the IBC mode flag pred_mode_ibc_flag[x0][y0], and the merge_data( ) syntax structure; when decoding an I slice, no more syntax elements except merge_idx[x0][y0] are parsed after cu_skip_flag[x0][y0]. cu_skip_flag[x0][y0] equal to 0 specifies that the coding unit is not skipped. The array indices x0, y0 specify the location (x0, y0) of the top-left luma sample of the considered coding block relative to the top-left luma sample of the picture.

When cu_skip_flag[x0][y0] is not present, it is inferred to be equal to 0.

pred_mode_flag equal to 0 specifies that the current coding unit is coded in inter prediction mode. pred_mode_flag equal to 1 specifies that the current coding unit is coded in intra prediction mode.

When pred_mode_flag is not present, it is inferred as follows:
If cbWidth is equal to 4 and cbHeight is equal to 4, pred_mode_flag is inferred to be equal to 1.
Otherwise, if modeType is equal to MODE_TYPE_INTRA, pred_mode_flag is inferred to be equal to 1.
Otherwise, if modeType is equal to MODE_TYPE_INTER, pred_mode_flag is inferred to be equal to 0.
Otherwise, pred_mode_flag is inferred to be equal to 1 when decoding an I slice, and equal to 0 when decoding a P or B slice, respectively.

The variable CuPredMode[chType][x][y] is derived as follows for x=x0 . . . x0+cbWidth−1 and y=y0 . . . y0+cbHeight−1:
If pred_mode_flag is equal to 0, CuPredMode[chType][x][y] is set equal to MODE_INTER.
Otherwise (pred_mode_flag is equal to 1), CuPredMode[chType][x][y] is set equal to MODE_INTRA.

pred_mode_ibc_flag equal to 1 specifies that the current coding unit is coded in IBC prediction mode. pred_mode_ibc_flag equal to 0 specifies that the current coding unit is not coded in IBC prediction mode.

When pred_mode_ibc_flag is not present, it is inferred as follows:
If cu_skip_flag[x0][y0] is equal to 1, and cbWidth is equal to 4, and cbHeight is equal to 4, pred_mode_ibc_flag is inferred to be equal 1.
Otherwise, if both cbWidth and cbHeight are equal to 128, pred_mode_ibc_flag is inferred to be equal to 0.
Otherwise, if modeType is equal to MODE_TYPE_INTER, pred_mode_ibc_flag is inferred to be equal to 0.
Otherwise, if treeType is equal to DUAL_TREE_CHROMA, pred_mode_ibc_flag is inferred to be equal to 0.
Otherwise, pred_mode_ibc_flag is infered to be equal to the value of sps_ibc_enabled_flag when decoding an I slice, and 0 when decoding a P or B slice, respectively.

When pred_mode_ibc_flag is equal to 1, the variable CuPredMode[chType][x][y] is set to be equal to MODE_IBC for x=x0 . . . x0+cbWidth−1 and y=y0 . . . y0+cbHeight−1.

pred_mode_plt_flag specifies the use of palette mode in the current coding unit. pred_modeplt_flag equal to 1 indicates that palette mode is applied in the current coding unit. pred_modeplt_flag equal to 0 indicates that palette mode is not applied in the current coding unit. When pred_modeplt_flag is not present, it is inferred to be equal to 0.

When pred_modeplt_flag is equal to 1, the variable CuPredMode[x][y] is set to be equal to MODE_PLT for x=x0 . . . x0+cbWidth−1 and y=y0 . . . y0+cbHeight−1.

intra_bdpcm_flag equal to 1 specifies that BDPCM is applied to the current luma coding block at the location (x0, y0), i.e. the transform is skipped, the intra luma prediction mode is specified by intra_bdpcm_dir_flag. intra_bdpcm_flag equal to 0 specifies that BDPCM is not applied to the current luma coding block at the location (x0, y0).

When intra_bdpcm_flag is not present it is inferred to be equal to 0.

The variable BdpcmFlag[x][y] is set equal to intra_bdpcm_flag for x=x0 . . . x0+cbWidth−1 and y=y0 . . . y0+cbHeight−1.

intra_bdpcm_dir_flag equal to 0 specifies that the BDPCM prediction direction is horizontal. intra_bdpcm_dir_flag equal to 1 specifies that the BDPCM prediction direction is vertical.

The variable BdpcmDir[x][y] is set equal to intra_bdpcm_dir_flag for x=x0 . . . x0+cbWidth−1 and y=y0 . . . y0+cbHeight−1.

intra_mip_flag[x0][y0] equal to 1 specifies that the intra prediction type for luma samples is matrix-based intra prediction. intra_mip_flag[x0][y0] equal to 0 specifies that the intra prediction type for luma samples is not matrix-based intra prediction.

When intra_mip_flag[x0][y0] is not present, it is inferred to be equal to 0.

intra_mip_transposed[x0][y0] specifies whether the input vector for matrix-based intra prediction mode for luma samples is transposed or not.

intra_mip_mode[x0][y0] specifies the matrix-based intra prediction mode for luma samples. The array indices x0, y0 specify the location (x0, y0) of the top-left luma sample of the considered coding block relative to the top-left luma sample of the picture.

intra_luma_ref_idx[x0][y0] specifies the intra prediction reference line index IntraLumaRefLineIdx[x][y] for x=x0 . . . x0+cbWidth−1 and y=y0 . . . y0+cbHeight−1 as specified in Table 7-15.

When intra_luma_ref_idx[x0][y0] is not present it is inferred to be equal to 0.

TABLE 7-15
Specification of IntraLumaRefLineIdx[x][y] based on
intra_luma_ref_idx[x0][y0].

| | IntraLumaRefLineIdx[x][y] |
|---|---|
| | x = x0 . . . x0 + cbWidth − 1 |
| intra_luma_ref_idx[x0][y0] | y = y0 . . . y0 + cbHeight − 1 |
| 0 | 0 |
| 1 | 1 |
| 2 | 3 |

intra_subpartitions_mode_flag[x0][y0] equal to 1 specifies that the current intra coding unit is partitioned into NumIntraSubPartitions[x0][y0] rectangular transform block subpartitions. intra_subpartitions_mode_flag[x0][y0] equal to 0 specifies that the current intra coding unit is not partitioned into rectangular transform block subpartitions.

When intra_subpartitions_mode_flag[x0][y0] is not present, it is inferred to be equal to 0.

intra_subpartitions_split_flag[x0][y0] specifies whether the intra subpartitions split type is horizontal or vertical. When intra_subpartitions_split_flag[x0][y0] is not present, it is inferred as follows:
If cbHeight is greater than MaxTbSizeY, intra_subpartitions_split_flag[x0][y0] is inferred to be equal to 0.
Otherwise (cbWidth is greater than MaxTbSizeY), intra_subpartitions_split_flag[x0][y0] is inferred to be equal to 1.

The variable IntraSubPartitionsSplitType specifies the type of split used for the current luma coding block as illustrated in Table 7-16. IntraSubPartitionsSplitType is derived as follows:
If intra_subpartitions_mode_flag[x0][y0] is equal to 0, IntraSubPartitionsSplitType is set equal to 0.
Otherwise, the IntraSubPartitionsSplitType is set equal to 1+intra_subpartitions_split_flag[x0][y0].

TABLE 7-16
Name association to IntraSubPartitionsSplitType

| | Name of |
|---|---|
| IntraSubPartitionsSplitType | IntraSubPartitionsSplitType |
| 0 | ISP_NO_SPLIT |
| 1 | ISP_HOR_SPLIT |
| 2 | ISP_VER_SPLIT |

The variable NumIntraSubPartitions specifies the number of transform block subpartitions into which an intra luma coding block is divided. NumIntraSubPartitions is derived as follows:
If IntraSubPartitionsSplitType is equal to ISP_NO_SPLIT, NumIntraSubPartitions is set equal to 1.
Otherwise, if one of the following conditions is true, NumIntraSubPartitions is set equal to 2:
   cbWidth is equal to 4 and cbHeight is equal to 8,
   cbWidth is equal to 8 and cbHeight is equal to 4.
Otherwise, NumIntraSubPartitions is set equal to 4.

The syntax elements intra_luma_mpm_flag[x0][y0], intra_luma_not_planar_flag[x0][y0], intra_luma_mpm_idx[x0][y0] and intra_luma_mpm_remainder[x0][y0] specify the intra prediction mode for luma samples. The array indices x0, y0 specify the location (x0, y0) of the top-left luma sample of the considered coding block relative to the top-left luma sample of the picture. When intra_luma_mpm_flag[x0][y0] is equal to 1, the intra prediction mode is inferred from a neighbouring intra-predicted coding unit according to clause 8.4.2.

When intra_luma_mpm_flag[x0][y0] is not present, it is inferred to be equal to 1.

When intra_luma_not_planar_flag[x0][y0] is not present, it is inferred to be equal to 1.

cclm_mode_flag equal to 1 specifies that one of the INTRA_LT_CCLM, INTRA_L_CCLM and INTRA_T_CCLM intra chroma prediction modes is applied. cclm_mode_flag equal to 0 specifies that none of the INTRA_LT_CCLM, INTRA_L_CCLM and INTRA_T_CCLM intra chroma prediction modes is applied.

When cclm_mode_flag is not present, it is inferred to be equal to 0.

cclm_mode_idx specifies which one of the INTRA_LT_CCLM, INTRA_L_CCLM and INTRA_T_CCLM intra chroma prediction modes is applied.

intra_chroma_pred_mode specifies the intra prediction mode for chroma samples. When intra_chroma_pred_mode is not present, it is inferred to be equal to 0.

general_merge_flag[x0][y0] specifies whether the inter prediction parameters for the current coding unit are inferred from a neighbouring inter-predicted partition. The array indices x0, y0 specify the location (x0, y0) of the top-left luma sample of the considered coding block relative to the top-left luma sample of the picture.

When general_merge_flag[x0][y0] is not present, it is inferred as follows:
If cu_skip_flag[x0][y0] is equal to 1, general_merge_flag[x0][y0] is inferred to be equal to 1.
Otherwise, general_merge_flag[x0][y0] is inferred to be equal to 0.

mvp_l0_flag[x0][y0] specifies the motion vector predictor index of list 0 where x0, y0 specify the location (x0, y0) of the top-left luma sample of the considered coding block relative to the top-left luma sample of the picture.

When mvp_l0_flag[x0][y0] is not present, it is inferred to be equal to 0.

mvp_l1_flag[x0][y0] has the same semantics as mvp_l0_flag, with l0 and list 0 replaced by l1 and list 1, respectively.

inter_pred_idc[x0][y0] specifies whether list0, list1, or bi-prediction is used for the current coding unit according to Table 7-17. The array indices x0, y0 specify the location (x0, y0) of the top-left luma sample of the considered coding block relative to the top-left luma sample of the picture.

TABLE 7-17
Name association to inter prediction mode

| | Name of inter_pred_idc | | |
|---|---|---|---|
| | ( cbWidth + | ( cbWidth + | ( cbWidth + |
| inter_pred_idc | cbHeight ) > 12 | cbHeight ) = = 12 | cbHeight ) = = 8 |
| 0 | PRED_L0 | PRED_L0 | n.a. |
| 1 | PRED_L1 | PRED_L1 | n.a. |
| 2 | PRED_BI | n.a. | n.a. |

When inter_pred_idc[x0][y0] is not present, it is inferred to be equal to PRED_L0.

sym_mvd_flag[x0][y0] equal to 1 specifies that the syntax elements ref_idx_l0[x0][y0] and ref_idx_l1[x0][y0], and the mvd_coding(x0, y0, refList, cpIdx) syntax structure for refList equal to 1 are not present. The array indices x0, y0 specify the location (x0, y0) of the top-left luma sample of the considered coding block relative to the top-left luma sample of the picture.

When sym_mvd_flag[x0][y0] is not present, it is inferred to be equal to 0.

ref_idx_l0[x0][y0] specifies the list 0 reference picture index for the current coding unit. The array indices x0, y0 specify the location (x0, y0) of the top-left luma sample of the considered coding block relative to the top-left luma sample of the picture.

When ref_idx_l0[x0][y0] is not present it is inferred as follows:
If sym_mvd_flag[x0][y0] is equal to 1, ref_idx_l0[x0][y0] is inferred to be equal to RefIdxSymL0.
Otherwise (sym_mvd_flag[x0][y0] is equal to 0), ref_idx_l0[x0][y0] is inferred to be equal to 0.

ref_idx_l1[x0][y0] has the same semantics as ref_idx_l0, with l0, L0 and list 0 replaced by l1, L1 and list 1, respectively.

inter_affine_flag[x0][y0] equal to 1 specifies that for the current coding unit, when decoding a P or B slice, affine model based motion compensation is used to generate the prediction samples of the current coding unit. inter_affine_flag[x0][y0] equal to 0 specifies that the coding unit is not predicted by affine model based motion compensation. When inter_affine_flag[x0][y0] is not present, it is inferred to be equal to 0.

cu_affine_type_flag[x0][y0] equal to 1 specifies that for the current coding unit, when decoding a P or B slice, 6-parameter affine model based motion compensation is used to generate the prediction samples of the current coding unit. cu_affine_type_flag[x0][y0] equal to 0 specifies that 4-parameter affine model based motion compensation is used to generate the prediction samples of the current coding unit.

MotionModelIdc[x][y] represents motion model of a coding unit as illustrated in Table 7-18. The array indices x, y specify the luma sample location (x, y) relative to the top-left luma sample of the picture.

The variable MotionModelIdc[x][y] is derived as follows for x=x0 . . . x0+cbWidth−1 and y=y0 . . . y0+cbHeight−1:
If general_merge_flag[x0][y0] is equal to 1, the following applies:

MotionModelIdc[x][y]=merge_subblock_flag[x0][y0] (7-139)
Otherwise (general_merge_flag[x0][y0] is equal to 0), the following applies:

MotionModelIdc[x][y]=inter_affine_flag[x0][y0]+cu_affine_type_flag[x0][y0] (7-140)

TABLE 7-18
Interpretation of MotionModelIdc[x0][y0]

| | Motion model for motion |
|---|---|
| MotionModelIdc[x][y] | compensation |
| 0 | Translational motion |
| 1 | 4-parameter affine motion |
| 2 | 6-parameter affine motion |

amvr_flag[x0][y0] specifies the resolution of motion vector difference. The array indices x0, y0 specify the location (x0, y0) of the top-left luma sample of the considered coding block relative to the top-left luma sample of the picture. amvr_flag[x0][y0] equal to 0 specifies that the resolution of the motion vector difference is ¼ of a luma sample. amvr_flag[x0][y0] equal to 1 specifies that the resolution of the motion vector difference is further specified by amvr_precision_flag[x0][y0].

When amvr_flag[x0][y0] is not present, it is inferred as follows:
If CuPredMode[chType][x0][y0] is equal to MODE_IBC, amvr_flag[x0][y0] is inferred to be equal to 1.
Otherwise (CuPredMode[chType][x0][y0] is not equal to MODE_IBC), amvr_flag[x0][y0] is inferred to be equal to 0.

amvr_precision_idx[x0][y0] equal to 0 specifies that the resolution of the motion vector difference with AmvrShift as defined in Table 7-19. The array indices x0, y0 specify the location (x0, y0) of the top-left luma sample of the considered coding block relative to the top-left luma sample of the picture.

When amvr_precision_flag[x0][y0] is not present, it is inferred to be equal to 0.

The motion vector differences are modified as follows:
If inter_affine_flag[x0][y0] is equal to 0, the the variables MvdL0[x0][y0][0], MvdL0[x0][y0][1], MvdL1[x0][y0][0], MvdL1[x0][y0][1] are modified as follows:

MvdL0[x0][y0][0]=MvdL0[x0][y0][0]<<AmvrShift (7-141)

MvdL0[x0][y0][1]=MvdL0[x0][y0][1]<<AmvrShift (7-142)

MvdL1[x0][y0][0]=MvdL1[x0][y0][0]<<AmvrShift (7-143)

MvdL1[x0][y0][1]=MvdL1[x0][y0][1]<<AmvrShift (7-144)
Otherwise (inter_affine_flag[x0][y0] is equal to 1), the variables MvdCpL0[x0][y0][0][0], MvdCpL0[x0][y0][0][1], MvdCpL0[x0][y0][1][0], MvdCpL0[x0][y0][1][1], MvdCpL0[x0][y0][2][0] and MvdCpL0[x0][y0][2][1] are modified as follows:

MvdCpL0[x0][y0][0][0]=MvdCpL0[x0][y0][0][0]<<AmvrShift (7-145)

MvdCpL1[x0][y0][0][1]=MvdCpL1[x0][y0][0][1]<<AmvrShift (7-146)

MvdCpL0[x0][y0][1][0]=MvdCpL0[x0][y0][1][0]<<AmvrShift (7-147)

MvdCpL1[x0][y0][1][1]=MvdCpL1[x0][y0][1][1]<<AmvrShift (7-148)

MvdCpL0[x0][y0][2][0]=MvdCpL0[x0][y0][2][0]<<AmvrShift (7-149)

MvdCpL1[x0][y0][2][1]=MvdCpL1[x0][y0][2][1]<<AmvrShift (7-150)

TABLE 7-19
Specification of AmvrShift.

| | | AmvrShift | | |
|---|---|---|---|---|
| | | | | inter_affine_flag = = 0 && |
| | | | CuPredMode[chType][x0] | CuPredMode[chType][x0] |
| amvr_flag | amvr_precision_idx | inter_affine_flag = = 1 | [y0] = = MODE_IBC) | [y0] ! = MODE_IBC |
| 0 | — | 2 (1/4 luma sample) | — | 2 (1/4 luma sample) |
| 1 | 0 | 0 (1/16 luma sample) | 4 (1 luma sample) | 3 (1/2 luma sample) |
| 1 | 1 | 4 (1 luma sample) | 6 (4 luma samples) | 4 (1 luma sample) |
| 1 | 2 | — | — | 6 (4 luma samples) |

bcw_idx[x0][y0] specifies the weight index of bi-prediction with CU weights. The array indices x0, y0 specify the location (x0, y0) of the top-left luma sample of the considered coding block relative to the top-left luma sample of the picture.

When bcw_idx[x0][y0] is not present, it is inferred to be equal to 0.

cu_cbf equal to 1 specifies that the transform_tree( ) syntax structure is present for the current coding unit. cu_cbf equal to 0 specifies that the transform_tree( ) syntax structure is not present for the current coding unit.

When cu_cbf is not present, it is inferred as follows:
If cu_skip_flag[x0][y0] is equal to 1 or pred_modeplt_flag is equal to 1, cu_cbf is inferred to be equal to 0.
Otherwise, cu_cbf is inferred to be equal to 1.

cu_sbt_flag equal to 1 specifies that for the current coding unit, subblock transform is used. cu_sbt_flag equal to 0 specifies that for the current coding unit, subblock transform is not used.

When cu_sbt_flag is not present, its value is inferred to be equal to 0.
NOTE—: When subblock transform is used, a coding unit is split into two transform units; one transform unit has residual data, the other does not have residual data.

cu_sbt_quad_flag equal to 1 specifies that for the current coding unit, the subblock transform includes a transform unit of ¼ size of the current coding unit. cu_sbt_quad_flag equal to 0 specifies that for the current coding unit the subblock transform includes a transform unit of ½ size of the current coding unit.

When cu_sbt_quad_flag is not present, its value is inferred to be equal to 0.

cu_sbt_horizontal_flag equal to 1 specifies that the current coding unit is split horizontally into 2 transform units. cu_sbt_horizontal_flag[x0][y0] equal to 0 specifies that the current coding unit is split vertically into 2 transform units.

When cu_sbt_horizontal_flag is not present, its value is derived as follows:
If cu_sbt_quad_flag is equal to 1, cu_sbt_horizontal_flag is set to be equal to allowSbtHorQ.
Otherwise (cu_sbt_quad_flag is equal to 0), cu_sbt_horizontal_flag is set to be equal to allowSbtHorH.

cu_sbt_pos_flag equal to 1 specifies that the tu_cbf_luma, tu_cbf_cb and tu_cbf_cr of the first transform unit in the current coding unit are not present in the bitstream. cu_sbt_pos_flag equal to 0 specifies that the tu_cbf_luma, tu_cbf_cb and tu_cbf_cr of the second transform unit in the current coding unit are not present in the bitstream.

The variable SbtNumFourthsTb0 is derived as follows:

sbtMinNumFourths=cu_sbt_quad_flag?1:2 (7-151)

SbtNumFourthsTb0=cu_sbt_pos_flag?(4−sbtMinNumFourths):sbtMinNumFourths (7-152)

lfnst_idx[x0][y0] specifies whether and which one of the two low frequency non-separable transform kernels in a selected transform set is used. lfnst_idx[x0][y0] equal to 0 specifies that the low frequency non-separable transform is not used. The array indices x0, y0 specify the location (x0, y0) of the top-left sample of the considered transform block relative to the top-left sample of the picture.

When lfnst_idx[x0][y0] is not present, it is inferred to be equal to 0.

When ResetIbcBuf is equal to 1, the following applies:
For x=0 . . . IbcBufWidthY−1 and y=0 . . . CtbSizeY−1, the following assignments are made:

IbcVirBuf[0][x][y]=−1 (7-153)
The variable ResetIbcBuf is set equal to 0.

When x0% VSize is equal to 0 and y0% VSize is equal to 0, the following assignments are made for x=x0 . . . x0+VSize−1 and y=y0 . . . y0+VSize−1:

IbcVirBuf[0][x % IbcBufWidthY][y % CtbSizeY]=−1 (7-154)

### 1.2 Decoding Process for Coding Units Coded in Intra Prediction Mode

### 1.2.1 General Decoding Process for Coding Units Coded in Intra Prediction Mode

Inputs to this process are:
a luma location (xCb, yCb) specifying the top-left sample of the current coding block relative to the top-left luma sample of the current picture,
a variable cbWidth specifying the width of the current coding block in luma samples,
a variable cbHeight specifying the height of the current coding block in luma samples,
a variable treeType specifying whether a single or a dual tree is used and if a dual tree is used, it specifies whether the current tree corresponds to the luma or chroma components.

Output of this process is a modified reconstructed picture before in-loop filtering.

The derivation process for quantization parameters as specified in clause 8.7.1 is invoked with the luma location (xCb, yCb), the width of the current coding block in luma samples cbWidth and the height of the current coding block in luma samples cbHeight, and the variable treeType as inputs.

When treeType is equal to SINGLE_TREE or treeType is equal to DUAL_TREE_LUMA, the decoding process for luma samples is specified as follows:
If pred_modeplt_flag is equal to 1, the following applies:
   The general decoding process for palette blocks as specified in clause 8.4.5.3 is invoked with the luma location (xCb, yCb), the variable startComp set equal to 0, the variable cIdx set to 0, the variable nCbW set equal to cbWidth, the variable nCbH set equal to cbHeight.
Otherwise (pred_modeplt_flag is equal to 0), the following applies:
   1. The variable MipSizeId[x][y] for x=xCb . . . xCb+cbWidth−1 and y=yCb . . . yCb+cbHeight−1 is derived as follows:
      If both cbWidth and cbHeight are equal to 4, MipSizeId[x][y] is set equal to 0.
      Otherwise, if both cbWidth and cbHeight are less than or equal to 8, MipSizeId[x][y] is set equal to 1.
      Otherwise, MipSizeId[x][y] is set equal to 2.
   2. The luma intra prediction mode is derived as follows:
      If intra_mip_flag[xCb][yCb] is equal to 1, IntraPredModeY[x][y] with x=xCb . . . xCb+cbWidth−1 and y=yCb . . . yCb+cbHeight−1 is set to be equal to intra_mip_mode[xCb][yCb] and isTransposed is set equal to intra_mip_transposed[xCb][yCb].
      Otherwise, the derivation process for the luma intra prediction mode as specified in clause 8.4.2 is invoked with the luma location (xCb, yCb), the width of the current coding block in luma samples cbWidth and the height of the current coding block in luma samples cbHeight as input.
   3. The variable predModeIntra is set equal to IntraPredModeY[xCb][yCb].
   4. The general decoding process for intra blocks as specified in clause 8.4.5.1 is invoked with the sample location (xTb0, yTb0) set equal to the luma location (xCb, yCb), the variable nTbW set equal to cbWidth, the variable nTbH set equal to cbHeight, predModeIntra, and the variable cIdx set equal to 0 as inputs, and the output is a modified reconstructed picture before in-loop filtering.

When treeType is equal to SINGLE_TREE or treeType is equal to DUAL_TREE_CHROMA, and when ChromaArrayType is not equal to 0, the decoding process for chroma samples is specified as follows:
If pred_modeplt_flag is equal to 1, the following applies:
   The general decoding process for palette blocks as specified in clause 8.4.5.3 is invoked with the luma location (xCb, yCb), the variable startComp set equal to 0, the variable cIdx set to 1, the variable nCbW set equal to (cbWidth/SubWidthC), the variable nCbH set equal to (cbHeight/SubHeightC).
   The general decoding process for palette blocks as specified in clause 8.4.5.3 is invoked with the luma location (xCb, yCb), the variable startComp set equal to 0, the variable cIdx set to 2, the variable nCbW set equal to (cbWidth/SubWidthC), the variable nCbH set equal to (cbHeight/SubHeightC).
Otherwise (pred_modeplt_flag is equal to 0), the following applies:
   1. The derivation process for the chroma intra prediction mode as specified in clause 8.4.3 is invoked with the luma location (xCb, yCb), the width of the current coding block in luma samples cbWidth and the height of the current coding block in luma samples cbHeight as input.
   2. The general decoding process for intra blocks as specified in clause 8.4.5.1 is invoked with the sample location (xTb0, yTb0) set equal to the chroma location (xCb/SubWidthC, yCb/SubHeightC), the variable nTbW set equal to (cbWidth/SubWidthC), the variable nTbH set equal to (cbHeight/SubHeightC), the variable predModeIntra set equal to IntraPredModeC[xCb][yCb], and the variable cIdx set equal to 1, and the output is a modified reconstructed picture before in-loop filtering.
   3. The general decoding process for intra blocks as specified in clause 8.4.5.1 is invoked with the sample location (xTb0, yTb0) set equal to the chroma location (xCb/SubWidthC, yCb/SubHeightC), the variable nTbW set equal to (cbWidth/SubWidthC), the variable nTbH set equal to (cbHeight/SubHeightC), the variable predModeIntra set equal to IntraPredModeC[xCb][yCb], and the variable cIdx set equal to 2, and the output is a modified reconstructed picture before in-loop filtering.

### 1.2.1.1.1 Matrix-Based Intra Sample Prediction

Inputs to this process are:
a sample location (xTbCmp, yTbCmp) specifying the top-left sample of the current transform block relative to the top-left sample of the current picture,
a variable predModeIntra specifying the intra prediction mode,
a variable isTransposed specifying the required input reference vector order,
a variable nTbW specifying the transform block width,
a variable nTbH specifying the transform block height.

Outputs of this process are the predicted samples predSamples[x][y], with x=0 . . . nTbW−1, y=0 . . . nTbH−1.

Variables numModes, boundarySize, predW, predH and predC are derived using MipSizeId[xTbCmp][yTbCmp] as specified in Table 8-4.

TABLE 8-4
Specification of number of prediction modes numModes, boundary size
boundarySize, and prediction sizes predW, predH and predC using MipSizeId

| MipSizeId | numModes | boundarySize | predW | predH | predC |
|---|---|---|---|---|---|
| 0 | 8 | 2 | 4 | 4 | 4 |
| 1 | 8 | 4 | 4 | 4 | 4 |
| 2 | 8 | 4 | Min(nTbW, 8) | Min(nTbH, 8) | 8 |

The variable inSize is derived as follows:

inSize=(2*boundary Size)−(MipSizeId[xTbCmp][yTbCmp]==2)?1:0 (8-22)

The variables mipW and mipH are derived as follows:

mipW=isTransposed?predH:predW (8-23)

mipH=isTransposed?predW:predH (8-24)

For the generation of the reference samples refT[x] with x=0 . . . nTbW−1 and refL[y] with y=0 . . . nTbH−1, the following applies:
The reference sample availability marking process as specified in clause 8.4.5.2.7 is invoked with the sample location (xTbCmp, yTbCmp), reference line index equal to 0, the reference sample width nTbW, the reference sample height nTbH, colour component index equal to 0 as inputs, and the reference samples refUnfilt[x][y] with x=−1, y=−1 . . . nTbH−1 and x=0 . . . nTbW−1, y=−1 as output.
When at least one sample refUnfilt[x][y] with x=−1, y=−1 . . . nTbH−1 and x=0 . . . nTbW−1, y=−1 is marked as “not available for intra prediction”, the reference sample substitution process as specified in clause 8.4.5.2.8 is invoked with reference line index 0, the reference sample width nTbW, the reference sample height nTbH, the reference samples refUnfilt[x][y] with x=−1, y=−1 . . . nTbH−1 and x=0 . . . nTbW−1, y=−1, and colour component index 0 as inputs, and the modified reference samples refUnfilt[x][y] with x=−1, y=−1 . . . nTbH−1 and x=0 . . . nTbW−1, y=−1 as output.
The reference samples refT[x] with x=0 . . . nTbW−1 and refL[y] with y=0 . . . nTbH−1 are assigned as follows:

refT[x]=refUnfilt[x][−1] (8-25)

refL[y]=refUnfilt[−1][y] (8-26)

For the generation of the input samples p[x] with x=0 . . . 2*inSize−1, the following applies:
The MIP boundary downsampling process as specified in clause 8.4.5.2.2 is invoked for the top reference samples with the block size nTbW, the reference samples refT[x] with x=0 . . . nTbW−1, and the boundary size boundarySize as inputs, and reduced boundary samples redT[x] with x=0 . . . boundarySize−1 as outputs.
The MIP boundary downsampling process as specified in clause 8.4.5.2.2 is invoked for the left reference samples with the block size nTbH, the reference samples refL[y] with y=0 . . . nTbH−1, and the boundary size boundarySize as inputs, and reduced boundary samples redL[x] with x=0 . . . boundarySize−1 as outputs.
The reduced top and left boundary samples redT and redL are assigned to the boundary sample array pTemp[x] with x=0 . . . 2*boundarySize−1 as follows:
   If isTransposed is equal to 1, pTemp[x] is set equal to redL[x] with x=0 . . . boundarySize−1 and pTemp[x+boundarySize] is set equal to redT[x] with x=0 . . . boundarySize−1.
   Otherwise, pTemp[x] is set equal to redT[x] with x=0 . . . boundarySize−1 and pTemp[x+boundarySize] is set equal to redL[x] with x=0 . . . boundarySize−1.
The input values p[x] with x=0 . . . inSize−1 are derived as follows:
   If MipSizeId[xTbCmp][yTbCmp] is equal to 2, the following applies:

p[x]=pTemp[x+1]−pTemp[0] (8-27)
Otherwise (MipSizeId[xTbCmp][yTbCmp] is less than 2), the following applies:

p[0]=pTemp[0]−(1<<(BitDepth_{Y}−1))

p[x]=pTemp[x]−pTemp[0] for x=1 . . . inSize−1 (8-28)

For the intra sample prediction process according to predModeIntra, the following ordered steps apply:
1. The matrix-based intra prediction samples predMip[x][y], with x=0 . . . mipW−1, y=0 . . . mipH−1 are derived as follows:
   The variable modeId is set equal to predModeIntra.
   The weight matrix mWeight[x][y] with x=0 . . . 2*inSize−1, y=0 . . . predC*predC−1 is derived by invoking the MIP weight matrix derivation process as specified in clause 8.4.5.2.3 with MipSizeId[xTbCmp][yTbCmp] and modeId as inputs.
   The variable sW is derived using MipSizeId[xTbCmp][yTbCmp] and modeId as specified in Table 8-5.
   The variable sO is set equal to 46.
   The matrix-based intra prediction samples predMip[x][y], with x=0 . . . mipW−1, y=0 . . . mipH−1 are derived as follows:

oW=(1<<(sW−1))−sO*(Σᵢ₌₀^{inSize-1}p[i]) (8-29)

incW=(predC>mipW)?2:1 (8-30)

incH=(predC>mipH)?2:1 (8-31)

predMip[x][y]=(((Σᵢ₌₀^{inSize-1}mWeight[i][y*incH*predC+x*incW]*p[i])+oW)>>sW)+pTemp[0] (8-32)
2. The matrix-based intra prediction samples predMip[x][y], with x=0 . . . mipW−1, y=0 . . . mipH−1 are clipped as follows:

predMip[x][y]=Clip1_{Y}(predMip[x][y]) (8-33)
3. When isTransposed is equal to TRUE, the predH×predW array predMip[x][y] with x=0 . . . predH−1, y=0 . . . predW−1 is transposed as follows:

predTemp[y][x]=predMip[x][y] (8-34)

predMip=predTemp (8-35)
4. The predicted samples predSamples[x][y], with x=0 . . . nTbW−1, y=0 . . . nTbH−1 are derived as follows:
   If nTbW is greater than predW or nTbH is greater than predH, the MIP prediction upsampling process as specified in clause 8.4.5.2.4 is invoked with the input block width predW, the input block height predH, matrix-based intra prediction samples predMip[x][y] with x=0 . . . predW−1, y=0 . . . predH−1, the transform block width nTbW, the transform block height nTbH, the top reference samples refT[x] with x=0 . . . nTbW−1, and the left reference samples refL[y] with y=0 . . . nTbH−1 as inputs, and the output is the predicted sample array predSamples.
   Otherwise, predSamples[x][y], with x=0 . . . nTbW−1, y=0 . . . nTbH−1 is set equal to predMip[x][y].

TABLE 8-5
Specification of weight shift sW depending
on MipSizeld and modeld

| | modeId | | | |
|---|---|---|---|---|
| MipSizeId | 0 | 1 | 2 | 3 |
| 0 | 6 | 6 | 6 | 6 |
| 1 | 6 | 6 | 7 | 6 |
| 2 | 7 | 5 | 6 | 6 |

### 1.2.1.1.2 MIP Boundary Sample Downsampling Process

Inputs to this process are:
a variable nTbS specifying the transform block size,
reference samples refS[x] with x=0 . . . nTbS−1,
a variable boundarySize specifying the downsampled boundary size.

Outputs of this process are the reduced boundary samples redS[x] with x=0 . . . boundarySize−1 and upsampling boundary samples upsBdryS[x] with x=0 . . . upsBdrySize−1.

The reduced boundary samples redS[x] with x=0 . . . boundarySize−1 are derived as follows:
If boundarySize is less than nTbs, the following applies:

bDwn=nTbs/boundarySize (8-36)

redS[x]=(Σᵢ₌₀^{bDwn-1}refS[x*bDwn+i]+(1<<(Log 2(bDwn)−1)))>>Log 2(bDwn) (8-37)
Otherwise (boundarySize is equal to nTbs), redS[x] is set equal to refS[x].

### 1.2.1.1.3 MIP Weight Matrix Derivation Process

Inputs to this process are:
a variable mipSizeId,
a variable modeId.

Output of this process is the MIP weight matrix mWeight[x][y].

The MIP weight matrix mWeight[x][y] is derived depending on mipSizeId and modeId as follows:
If mipSizeId is equal to 0 and modeId is equal to 0, the following applies:

$$mWeight [ x ] [ y ] = \{ \{ 47 , 46 , 101 , 49 \} , \{ 46 , 39 , 72 , 48 \} , \{ 46 , 51 , 41 , 45 \} , \{ 46 , 102 , 42 , 45 \} , \{ 46 , 46 , 112 , 45 \} , \{ 46 , 47 , 110 , 48 \} , \{ 46 , 40 , 89 , 48 \} , \{ 46 , 48 , 53 , 46 \} , \{ 47 , 46 , 94 , 61 \} , \{ 46 , 46 , 111 , 44 \} , \{ 46 , 48 , 113 , 46 \} , \{ 46 , 42 , 101 , 48 \} , \{ 45 , 45 , 41 , 116 \} , \{ 46 , 45 , 72 , 84 \} , \{ 46 , 46 , 101 , 53 \} , \{ 46 , 47 , 109 , 47 \} \} , \qquad ( 8 \text{-} 38 )$$

Otherwise, if mipSizeId is equal to 0 and modeId is equal to 1, the following applies:

$$mWeight [ x ] [ y ] = \{ \{ 47 , 70 , 116 , 31 \} , \{ 46 , 80 , 73 , 70 \} , \{ 44 , 61 , 53 , 97 \} , \{ 44 , 49 , 50 , 105 \} , \{ 43 , 50 , 55 , 104 \} , \{ 44 , 42 , 44 , 114 \} , \{ 44 , 43 , 49 , 109 \} , \{ 44 , 46 , 50 , 106 \} , \{ 45 , 46 , 45 , 109 \} , \{ 45 , 47 , 50 , 106 \} , \{ 44 , 48 , 49 , 106 \} , \{ 43 , 48 , 49 , 106 \} , \{ 45 , 47 , 50 , 106 \} , \{ 44 , 47 , 49 , 107 \} , \{ 44 , 47 , 49 , 107 \} , \{ 43 , 47 , 50 , 106 \} \} , \qquad ( 8 \text{-} 39 )$$

Otherwise, if mipSizeId is equal to 0 and modeId is equal to 2, the following applies:

$$mWeight [ x ] [ y ] = \{ \{ 46 , 43 , 106 , 45 \} , \{ 46 , 36 , 87 , 48 \} , \{ 46 , 33 , 62 , 47 \} , \{ 46 , 55 , 46 , 46 \} , \{ 46 , 46 , 113 , 43 \} , \{ 45 , 47 , 119 , 40 \} , \{ 44 , 44 , 117 , 41 \} , \{ 45 , 36 , 101 , 44 \} , \{ 46 , 45 , 63 , 92 \} , \{ 45 , 43 , 78 , 76 \} , \{ 44 , 44 , 96 , 59 \} , \{ 42 , 44 , 108 , 48 \} , \{ 43 , 43 , 39 , 116 \} , \{ 41 , 42 , 39 , 116 \} , \{ 40 , 41 , 42 , 111 \} , \{ 35 , 38 , 54 , 96 \} \} , \qquad ( 8 \text{-} 40 )$$

Otherwise, if mipSizeId is equal to 0 and modeId is equal to 3, the following applies:

$$mWeight [ x ] [ y ] = \{ \{ 46 , 44 , 105 , 33 \} , \{ 46 , 73 , 87 , 46 \} , \{ 44 , 93 , 50 , 73 \} , \{ 48 , 76 , 30 , 95 \} , \{ 47 , 50 , 84 , 82 \} , \{ 47 , 52 , 53 , 106 \} , \{ 49 , 47 , 45 , 113 \} , \{ 52 , 47 , 47 , 112 \} , \{ 48 , 47 , 41 , 114 \} , \{ 50 , 48 , 44 , 113 \} , \{ 51 , 50 , 46 , 111 \} , \{ 53 , 51 , 46 , 111 \} , \{ 50 , 48 , 48 , 110 \} , \{ 52 , 49 , 47 , 111 \} , \{ 53 , 50 , 46 , 112 \} , \{ 54 , 50 , 46 , 112 \} , \} , \qquad ( 8 \text{-} 41 )$$

Otherwise, if mipSizeId is equal to 1 and modeId is equal to 0, the following applies:

$$mWeight [ x ] [ y ] = \{ \{ 47 , 54 , 45 , 47 , 116 , 49 , 45 , 46 \} , \{ 47 , 61 , 50 , 45 , 114 , 41 , 47 , 46 \} , \{ 46 , 51 , 66 , 47 , 104 , 37 , 49 , 45 \} , \{ 46 , 48 , 43 , 79 , 89 , 38 , 49 , 45 \} , \{ 46 , 46 , 47 , 46 , 36 , 118 , 48 , 44 \} , \{ 46 , 47 , 47 , 47 , 46 , 118 , 39 , 47 \} , \{ 46 , 50 , 46 , 48 , 59 , 112 , 35 , 47 \} , \{ 46 , 49 , 48 , 51 , 73 , 98 , 37 , 47 \} , \{ 46 , 47 , 46 , 46 , 49 , 37 , 117 , 47 \} , \{ 46 , 48 , 47 , 47 , 45 , 49 , 114 , 40 \} , \{ 46 , 47 , 47 , 48 , 41 , 64 , 105 , 38 \} , \{ 46 , 47 , 46 , 51 , 38 , 80 , 90 , 39 \} , \{ 46 , 47 , 46 , 47 , 45 , 47 , 36 , 119 \} , \{ 46 , 48 , 46 , 47 , 47 , 43 , 48 , 111 \} , \{ 46 , 47 , 47 , 48 , 49 , 38 , 64 , 99 \} , \{ 46 , 48 , 45 , 52 , 50 , 35 , 80 , 84 \} \} , \qquad ( 8 \text{-} 42 )$$

Otherwise, if mipSizeId is equal to 1 and modeId is equal to 1, the following applies:

$$mWeight [ x ] [ y ] = \{ \{ 46 , 41 , 46 , 46 , 92 , 40 , 47 , 45 \} , \{ 45 , 58 , 42 , 46 , 49 , 45 , 46 , 46 \} , \{ 45 , 103 , 58 , 42 , 46 , 46 , 46 , 46 \} , \{ 45 , 42 , 104 , 54 , 47 , 45 , 47 , 45 \} , \{ 46 , 46 , 46 , 46 , 76 , 89 , 39 , 47 \} , \{ 45 , 42 , 46 , 45 , 97 , 45 , 46 , 45 \} , \{ 45 , 53 , 42 , 46 , 59 , 43 , 45 , 46 \} , \{ 45 , 92 , 51 , 44 , 46 , 47 , 45 , 46 \} , \{ 46 , 45 , 47 , 45 , 40 , 78 , 90 , 39 \} , \{ 45 , 46 , 47 , 45 , 58 , 103 , 44 , 44 \} , \{ 46 , 43 , 47 , 45 , 93 , 59 , 43 , 46 \} , \{ 45 , 47 , 46 , 46 , 72 , 44 , 46 , 45 \} , \{ 46 , 46 , 47 , 45 , 49 , 36 , 77 , 86 \} , \{ 45 , 45 , 47 , 45 , 44 , 60 , 100 , 44 \} , \{ 46 , 46 , 47 , 45 , 51 , 99 , 54 , 46 \} , \{ 45 , 46 , 47 , 46 , 80 , 69 , 46 , 47 \} \} , \qquad ( 8 \text{-} 43 )$$

Otherwise, if mipSizeId is equal to 1 and modeId is equal to 2, the following applies:

$$mWeight [ x ] [ y ] = \{ \{ 49 , 50 , 53 , 50 , 86 , 103 , 74 , 58 \} , \{ 50 , 39 , 45 , 55 , 57 , 111 , 86 , 62 \} , \{ 50 , 51 , 36 , 52 , 48 , 113 , 90 , 64 \} , \{ 50 , 48 , 59 , 35 , 47 , 111 , 90 , 62 \} , \{ 50 , 43 , 45 , 49 , 45 , 101 , 107 , 60 \} , \{ 51 , 47 , 43 , 49 , 47 , 94 , 110 , 62 \} , \{ 52 , 48 , 44 , 47 , 48 , 93 , 110 , 63 \} , \{ 53 , 49 , 43 , 48 , 49 , 95 , 106 , 64 \} , \{ 50 , 45 , 46 , 47 , 47 , 77 , 114 , 76 \} , \{ 53 , 49 , 43 , 49 , 48 , 80 , 114 , 74 \} , \{ 54 , 49 , 43 , 49 , 47 , 79 , 116 , 73 \} , \{ 55 , 50 , 45 , 49 , 48 , 80 , 113 , 71 \} , \{ 50 , 46 , 47 , 48 , 48 , 59 , 108 , 97 \} , \{ 53 , 50 , 43 , 48 , 50 , 63 , 124 , 78 \} , \{ 56 , 49 , 45 , 49 , 51 , 64 , 120 , 80 \} , \{ 56 , 51 , 44 , 50 , 52 , 68 , 113 , 81 \} \} , \qquad ( 8 \text{-} 44 )$$

Otherwise, if mipSizeId is equal to 1 and modeId is equal to 3, the following applies:

$$mWeight [ x ] [ y ] = \{ \{ 45 , 61 , 44 , 45 , 89 , 63 , 39 , 48 \} , \{ 45 , 97 , 57 , 42 , 60 , 66 , 40 , 46 \} , \{ 44 , 37 , 102 , 52 , 44 , 59 , 51 , 43 \} , \{ 44 , 47 , 29 , 114 , 40 , 46 , 62 , 44 \} , \{ 45 , 47 , 48 , 46 , 38 , 85 , 85 , 38 \} , \{ 44 , 48 , 49 , 45 , 42 , 59 , 102 , 41 \} , \{ 44 , 49 , 49 , 47 , 42 , 42 , 100 , 57 \} , \{ 45 , 47 , 45 , 55 , 41 , 37 , 83 , 76 \} , \{ 46 , 45 , 46 , 46 , 46 , 39 , 83 , 80 \} , \{ 47 , 46 , 45 , 47 , 45 , 44 , 57 , 102 \} , \{ 47 , 47 , 44 , 47 , 45 , 49 , 43 , 112 \} , \{ 48 , 48 , 46 , 47 , 44 , 50 , 43 , 111 \} , \{ 47 , 46 , 45 , 47 , 46 , 47 , 36 , 119 \} , \{ 48 , 47 , 45 , 48 , 45 , 46 , 40 , 116 \} , \{ 49 , 47 , 45 , 49 , 46 , 44 , 44 , 113 \} , \{ 50 , 48 , 45 , 51 , 46 , 44 , 47 , 110 \} \} , \qquad ( 8 \text{-} 45 )$$

Otherwise, if mipSizeId is equal to 2 and modeId is equal to 0, the following applies:

$$mWeight [ x ] [ y ] = \{ \{ 84 , 45 , 52 , 127 , 61 , 58 , 48 \} , \{ 70 , 60 , 55 , 90 , 88 , 63 , 50 \} , \{ 39 , 74 , 59 , 65 , 99 , 68 , 52 \} , \{ 38 , 68 , 65 , 55 , 99 , 70 , 55 \} , \{ 51 , 50 , 75 , 51 , 97 , 73 , 56 \} , \{ 52 , 51 , 76 , 49 , 94 , 76 , 56 \} , \{ 48 , 65 , 67 , 47 , 93 , 77 , 55 \} , \{ 48 , 65 , 70 , 45 , 91 , 76 , 55 \} , \{ 46 , 55 , 52 , 53 , 127 , 65 , 51 \} , \{ 40 , 54 , 56 , 46 , 122 , 76 , 53 \} , \{ 42 , 50 , 60 , 45 , 114 , 82 , 55 \} , \{ 46 , 46 , 63 , 45 , 110 , 84 , 56 \} , \{ 46 , 46 , 64 , 46 , 107 , 84 , 57 \} , \{ 48 , 49 , 61 , 47 , 106 , 85 , 55 \} , \{ 48 , 49 , 61 , 46 , 105 , 85 , 56 \} , \{ 48 , 50 , 64 , 47 , 102 , 81 , 58 \} , \{ 45 , 48 , 54 , 49 , 124 , 75 , 55 \} , \{ 45 , 47 , 56 , 47 , 111 , 85 , 58 \} , \{ 46 , 46 , 59 , 47 , 105 , 88 , 60 \} , \{ 45 , 47 , 60 , 47 , 104 , 88 , 60 \} , \{ 45 , 47 , 61 , 46 , 105 , 86 , 60 \} , \{ 46 , 47 , 62 , 46 , 105 , 86 , 59 \} , \{ 46 , 47 , 64 , 46 , 104 , 87 , 58 \} , \{ 47 , 46 , 67 , 46 , 102 , 86 , 58 \} , \{ 46 , 46 , 54 , 46 , 107 , 94 , 57 \} , \{ 44 , 47 , 55 , 46 , 102 , 93 , 63 \} , \{ 45 , 46 , 57 , 46 , 100 , 91 , 65 \} , \{ 45 , 46 , 59 , 46 , 99 , 90 , 66 \} , \{ 45 , 47 , 60 , 45 , 100 , 90 , 63 \} , \{ 45 , 47 , 61 , 44 , 100 , 91 , 62 \} , \{ 46 , 45 , 64 , 44 , 100 , 90 , 61 \} , \{ 46 , 46 , 66 , 44 , 99 , 89 , 60 \} , \{ 45 , 47 , 52 , 45 , 87 , 112 , 61 \} , \{ 45 , 45 , 55 , 45 , 89 , 103 , 68 \} , \{ 45 , 46 , 56 , 44 , 91 , 95 , 71 \} , \{ 45 , 46 , 58 , 43 , 94 , 95 , 69 \} , \{ 45 , 46 , 60 , 44 , 94 , 95 , 67 \} , \{ 46 , 46 , 61 , 43 , 95 , 95 , 65 \} , \{ 46 , 45 , 64 , 43 , 95 , 94 , 64 \} , \{ 46 , 44 , 65 , 43 , 95 , 93 , 63 \} , \{ 45 , 46 , 52 , 44 , 74 , 103 , 85 \} , \{ 45 , 45 , 56 , 43 , 82 , 97 , 82 \} , \{ 45 , 45 , 57 , 43 , 85 , 97 , 78 \} , \{ 45 , 45 , 58 , 43 , 88 , 97 , 73 \} , \{ 46 , 44 , 60 , 43 , 89 , 96 , 71 \} , \{ 46 , 43 , 63 , 43 , 89 , 97 , 68 \} , \{ 45 , 44 , 64 , 43 , 89 , 97 , 67 \} , \{ 47 , 44 , 65 , 43 , 88 , 97 , 66 \} , \{ 45 , 46 , 52 , 44 , 65 , 82 , 114 \} , \{ 44 , 46 , 54 , 43 , 76 , 95 , 91 \} , \{ 44 , 45 , 57 , 42 , 82 , 101 , 78 \} , \{ 45 , 44 , 59 , 42 , 85 , 100 , 75 \} , \{ 46 , 44 , 60 , 42 , 85 , 100 , 73 \} , \{ 46 , 44 , 62 , 43 , 84 , 102 , 70 \} , \{ 46 , 44 , 64 , 43 , 84 , 101 , 69 \} , \{ 46 , 44 , 66 , 44 , 83 , 100 , 68 \} , \{ 46 , 45 , 53 , 44 , 60 , 81 , 119 \} , \{ 44 , 46 , 54 , 43 , 70 , 102 , 89 \} , \{ 46 , 46 , 57 , 43 , 75 , 104 , 79 \} , \{ 47 , 43 , 59 , 42 , 79 , 105 , 74 \} , \{ 46 , 45 , 60 , 43 , 80 , 103 , 73 \} , \{ 46 , 44 , 63 , 44 , 80 , 102 , 72 \} , \{ 47 , 43 , 65 , 45 , 81 , 101 , 70 \} , \{ 47 , 43 , 67 , 46 , 78 , 98 , 72 \} \} , \qquad ( 8 \text{-} 46 )$$

Otherwise, if mipSizeId is equal to 2 and modeId is equal to 1, the following applies:

$$mWeight [ x ] [ y ] = \{ \{ 50 , 47 , 46 , 61 , 50 , 45 , 46 \} , \{ 59 , 49 , 47 , 57 , 51 , 45 , 46 \} , \{ 64 , 52 , 48 , 55 , 51 , 46 , 46 \} , \{ 58 , 61 , 50 , 53 , 51 , 46 , 46 \} , \{ 52 , 66 , 53 , 52 , 51 , 46 , 46 \} , \{ 48 , 62 , 62 , 50 , 51 , 46 , 46 \} , \{ 47 , 49 , 76 , 49 , 51 , 46 , 46 \} , \{ 45 , 33 , 92 , 49 , 52 , 46 , 46 \} , \{ 50 , 48 , 46 , 57 , 63 , 45 , 46 \} , \{ 55 , 52 , 48 , 55 , 63 , 45 , 46 \} , \{ 57 , 56 , 50 , 53 , 63 , 45 , 46 \} , \{ 55 , 60 , 53 , 51 , 63 , 46 , 46 \} , \{ 51 , 60 , 59 , 51 , 63 , 46 , 46 \} , \{ 48 , 55 , 69 , 49 , 63 , 46 , 46 \} , \{ 46 , 42 , 84 , 48 , 62 , 46 , 46 \} , \{ 43 , 28 , 99 , 48 , 61 , 47 , 46 \} , \{ 49 , 49 , 47 , 48 , 73 , 47 , 46 \} , \{ 52 , 52 , 49 , 47 , 73 , 48 , 46 \} , \{ 52 , 55 , 53 , 47 , 72 , 48 , 46 \} , \{ 51 , 56 , 58 , 46 , 72 , 48 , 46 \} , \{ 48 , 54 , 65 , 46 , 71 , 48 , 46 \} , \{ 46 , 47 , 76 , 45 , 71 , 49 , 46 \} , \{ 44 , 34 , 91 , 44 , 70 , 49 , 46 \} , \{ 41 , 23 , 104 , 45 , 68 , 50 , 46 \} , \{ 48 , 48 , 48 , 44 , 68 , 59 , 45 \} , \{ 50 , 51 , 51 , 43 , 69 , 58 , 45 \} , \{ 49 , 52 , 56 , 43 , 68 , 58 , 45 \} , \{ 48 , 52 , 62 , 42 , 68 , 58 , 45 \} , \{ 45 , 48 , 71 , 42 , 68 , 58 , 45 \} , \{ 48 , 52 , 62 , 42 , 68 , 58 , 45 \} , \{ 45 , 48 , 71 , 42 , 68 , 58 , 45 \} , \{ 43 , 38 , 84 , 41 , 68 , 59 , 45 \} , \{ 41 , 27 , 98 , 41 , 67 , 59 , 45 \} , \{ 38 , 19 , 109 , 42 , 66 , 59 , 45 \} , \{ 47 , 47 , 49 , 44 , 52 , 74 , 45 \} , \{ 48 , 48 , 53 , 43 , 54 , 74 , 45 \} , \{ 47 , 48 , 60 , 43 , 55 , 73 , 45 \} , \{ 45 , 46 , 68 , 43 , 55 , 73 , 45 \} , \{ 43 , 40 , 78 , 42 , 56 , 72 , 45 \} , \{ 41 , 30 , 91 , 42 , 57 , 72 , 45 \} , \{ 38 , 20 , 105 , 41 , 57 , 71 , 45 \} , \{ 36 , 13 , 114 , 41 , 57 , 70 , 46 \} , \{ 46 , 47 , 50 , 45 , 43 , 77 , 51 \} , \{ 46 , 46 , 56 , 44 , 44 , 78 , 51 \} , \{ 45 , 43 , 64 , 43 , 45 , 77 , 51 \} , \{ 43 , 39 , 73 , 43 , 45 , 77 , 51 \} , \{ 40 , 31 , 85 , 42 , 46 , 77 , 51 \} , \{ 38 , 22 , 98 , 42 , 46 , 77 , 51 \} , \{ 35 , 12 , 111 , 42 , 47 , 76 , 51 \} , \{ 33 , 7 , 119 , 41 , 48 , 75 , 52 \} , \{ 46 , 46 , 51 , 45 , 44 , 57 , 71 \} , \{ 45 , 43 , 59 , 44 , 44 , 58 , 70 \} , \{ 43 , 37 , 68 , 43 , 45 , 58 , 70 \} , \{ 40 , 31 , 80 , 43 , 45 , 58 , 70 \} , \{ 38 , 22 , 92 , 43 , 46 , 58 , 70 \} , \{ 36 , 13 , 105 , 43 , 46 , 58 , 70 \} , \{ 33 , 5 , 117 , 42 , 47 , 58 , 70 \} , \{ 31 , 2 , 123 , 42 , 48 , 57 , 71 \} , \{ 45 , 41 , 55 , 45 , 51 , 24 , 96 \} , \{ 44 , 36 , 64 , 44 , 52 , 23 , 97 \} , \{ 42 , 29 , 75 , 43 , 53 , 23 , 97 \} , \{ 39 , 22 , 86 , 43 , 52 , 24 , 97 \} , \{ 37 , 14 , 98 , 43 , 53 , 24 , 97 \} , \{ 34 , 7 , 109 , 142 , 53 , 25 , 97 \} , \{ 32 , 1 , 118 , 41 , 53 , 25 , 97 \} , \{ 30 , 0 , 123 , 41 , 53 , 26 , 96 \} \} , \qquad ( 8 \text{-} 47 )$$

Otherwise, if mipSizeId is equal to 2 and modeId is equal to 2, the following applies:

$$mWeight [ x ] [ y ] = \{ \{ 48 , 46 , 46 , 88 , 45 , 46 , 46 \} , \{ 54 , 46 , 46 , 67 , 47 , 46 , 46 \} , \{ 72 , 45 , 46 , 55 , 47 , 46 , 46 \} , \{ 88 , 51 , 45 , 51 , 47 , 47 , 46 \} , \{ 81 , 70 , 44 , 49 , 47 , 47 , 46 \} , \{ 56 , 95 , 46 , 47 , 47 , 46 , 46 \} , \{ 44 , 86 , 68 , 47 , 47 , 46 , 45 \} , \{ 48 , 46 , 105 , 47 , 47 , 46 , 45 \} , \{ 49 , 46 , 46 , 96 , 60 , 45 , 46 \} , \{ 50 , 46 , 46 , 91 , 52 , 46 , 46 \} , \{ 55 , 46 , 46 , 76 , 51 , 46 , 46 \} , \{ 66 , 47 , 45 , 64 , 50 , 47 , 46 \} , \{ 78 , 51 , 45 , 57 , 49 , 47 , 45 \} , \{ 77 , 65 , 45 , 52 , 48 , 47 , 46 \} , \{ 62 , 82 , 48 , 50 , 47 , 47 , 45 \} , \{ 51 , 77 , 66 , 49 , 48 , 46 , 45 \} , \{ 48 , 46 , 46 , 65 , 93 , 43 , 46 \} , \{ 49 , 46 , 46 , 78 , 77 , 45 , 46 \} , \{ 50 , 47 , 46 , 82 , 65 , 46 , 45 \} , \{ 54 , 47 , 46 , 77 , 58 , 47 , 45 \} , \{ 63 , 47 , 46 , 70 , 54 , 47 , 45 \} , \{ 72 , 49 , 46 , 63 , 51 , 47 , 45 \} , \{ 72 , 60 , 46 , 57 , 50 , 47 , 45 \} , \{ 64 , 71 , 49 , 54 , 50 , 46 , 45 \} , \{ 46 , 46 , 46 , 46 , 97 , 60 , 44 \} , \{ 47 , 46 , 46 , 56 , 94 , 52 , 45 \} , \{ 48 , 47 , 46 , 67 , 84 , 49 , 45 \} , \{ 50 , 47 , 46 , 73 , 75 , 48 , 45 \} , \{ 53 , 47 , 46 , 73 , 67 , 47 , 45 \} , \{ 60 , 47 , 46 , 70 , 62 , 47 , 45 \} , \{ 66 , 49 , 46 , 65 , 58 , 46 , 45 \} , \{ 66 , 57 , 47 , 60 , 56 , 46 , 45 \} , \{ 46 , 46 , 46 , 46 , 66 , 94 , 42 \} , \{ 46 , 46 , 46 , 48 , 80 , 77 , 43 \} , \{ 47 , 46 , 46 , 53 , 87 , 64 , 44 \} , \{ 48 , 46 , 46 , 60 , 86 , 56 , 44 \} , \{ 49 , 47 , 46 , 65 , 82 , 51 , 45 \} , \{ 52 , 47 , 46 , 67 , 76 , 48 , 45 \} , \{ 57 , 47 , 46 , 67 , 70 , 47 , 45 \} , \{ 61 , 50 , 46 , 64 , 65 , 47 , 45 \} , \{ 46 , 47 , 46 , 48 , 43 , 104 , 53 \} , \{ 46 , 46 , 46 , 48 , 55 , 99 , 46 \} , \{ 47 , 46 , 46 , 48 , 70 , 86 , 44 \} , \{ 47 , 46 , 46 , 51 , 80 , 73 , 44 \} , \{ 47 , 46 , 46 , 56 , 85 , 62 , 44 \} , \{ 48 , 47 , 46 , 60 , 84 , 56 , 44 \} , \{ 51 , 47 , 46 , 63 , 80 , 52 , 44 \} , \{ 55 , 48 , 46 , 63 , 75 , 50 , 45 \} , \{ 46 , 46 , 46 , 47 , 45 , 67 , 90 \} , \{ 46 , 46 , 46 , 48 , 47 , 83 , 71 \} , \{ 46 , 46 , 46 , 48 , 54 , 91 , 56 \} , \{ 47 , 46 , 46 , 49 , 65 , 87 , 49 \} , \{ 46 , 46 , 46 , 51 , 74 , 78 , 46 \} , \{ 46 , 47 , 46 , 54 , 80 , 69 , 45 \} , \{ 47 , 47 , 46 , 57 , 82 , 61 , 45 \} , \{ 50 , 47 , 46 , 59 , 79 , 57 , 45 \} , \{ 46 , 46 , 46 , 46 , 52 , 33 , 118 \} , \{ 46 , 46 , 46 , 46 , 53 , 45 , 105 \} , \{ 46 , 46 , 46 , 48 , 53 , 63 , 86 \} , \{ 46 , 46 , 46 , 49 , 56 , 77 , 68 \} , \{ 46 , 47 , 45 , 50 , 62 , 80 , 57 \} , \{ 46 , 47 , 46 , 51 , 69 , 77 , 51 \} , \{ 46 , 47 , 46 , 53 , 74 , 71 , 49 \} , \{ 48 , 47 , 47 , 55 , 75 , 66 , 48 \} \} , \qquad ( 8 \text{-} 48 )$$

Otherwise, if mipSizeId is equal to 2 and modeId is equal to 3, the following applies:

$$mWeight [ x ] [ y ] = \{ \{ 59 , 44 , 45 , 87 , 48 , 45 , 47 \} , \{ 88 , 44 , 45 , 60 , 61 , 41 , 48 \} , \{ 83 , 65 , 44 , 46 , 65 , 42 , 48 \} , \{ 50 , 94 , 47 , 41 , 60 , 48 , 46 \} , \{ 40 , 83 , 69 , 42 , 53 , 54 , 45 \} , \{ 45 , 50 , 97 , 43 , 47 , 55 , 48 \} , \{ 48 , 37 , 105 , 43 , 44 , 54 , 54 \} , \{ 48 , 38 , 97 , 44 , 41 , 51 , 65 \} , \{ 60 , 49 , 45 , 75 , 86 , 35 , 49 \} , \{ 55 , 63 , 46 , 51 , 90 , 40 , 48 \} , \{ 43 , 73 , 53 , 41 , 76 , 55 , 46 \} , \{ 40 , 63 , 69 , 41 , 58 , 66 , 47 \} , \{ 44 , 47 , 83 , 43 , 47 , 68 , 53 \} , \{ 47 , 37 , 88 , 44 , 41 , 65 , 63 \} , \{ 49 , 36 , 85 , 44 , 39 , 58 , 75 \} , \{ 49 , 40 , 77 , 43 , 39 , 50 , 86 \} , \{ 43 , 55 , 47 , 40 , 107 , 47 , 47 \} , \{ 37 , 59 , 54 , 40 , 81 , 70 , 44 \} , \{ 40 , 51 , 64 , 44 , 56 , 83 , 48 \} , \{ 44 , 41 , 71 , 45 , 44 , 80 , 60 \} , \{ 47 , 38 , 72 , 46 , 40 , 71 , 73 \} , \{ 48 , 39 , 69 , 46 , 39 , 60 , 86 \} , \{ 48 , 41 , 64 , 45 , 39 , 51 , 96 \} , \{ 48 , 44 , 61 , 45 , 41 , 46 , 101 \} , \{ 41 , 49 , 50 , 41 , 66 , 95 , 41 \} , \{ 42 , 45 , 57 , 46 , 47 , 99 , 50 \} , \{ 45 , 41 , 61 , 48 , 41 , 85 , 67 \} , \{ 46 , 39 , 62 , 47 , 40 , 68 , 84 \} , \{ 47 , 40 , 60 , 46 , 41 , 55 , 97 \} , \{ 47 , 42 , 57 , 46 , 42 , 48 , 104 \} , \{ 47 , 44 , 54 , 46 , 42 , 43 , 109 \} , \{ 47 , 45 , 54 , 45 , 43 , 42 , 109 \} , [ 45 , 44 , 51 , 47 , 41 , 102 , 55 \} , \{ 46 , 41 , 55 , 48 , 40 , 81 , 76 \} , \{ 46 , 40 , 56 , 47 , 42 , 61 , 94 \} , \{ 46 , 42 , 54 , 47 , 44 , 49 , 105 \} , \{ 46 , 43 , 53 , 46 , 45 , 43 , 110 \} , \{ 46 , 44 , 51 , 46 , 45 , 40 , 113 \} , \{ 47 , 45 , 50 , 46 , 45 , 39 , 115 \} , \{ 46 , 45 , 50 , 45 , 45 , 39 , 113 \} , \{ 46 , 44 , 50 , 47 , 43 , 69 , 89 \} , \{ 46 , 42 , 52 , 46 , 45 , 51 , 104 \} , \{ 46 , 42 , 52 , 46 , 46 , 42 , 111 \} , \{ 46 , 43 , 51 , 46 , 46 , 39 , 115 \} , \{ 45 , 45 , 49 , 46 , 46 , 38 , 116 \} , \{ 46 , 45 , 48 , 46 , 47 , 37 , 117 \} , \{ 46 , 45 , 48 , 46 , 47 , 37 , 117 \} , \{ 46 , 46 , 48 , 45 , 47 , 38 , 115 \} , \{ 46 , 44 , 49 , 46 , 46 , 43 , 112 \} , \{ 46 , 43 , 49 , 46 , 47 , 38 , 116 \} , \{ 46 , 44 , 49 , 46 , 47 , 36 , 118 \} , \{ 45 , 45 , 48 , 46 , 47 , 37 , 118 \} , \{ 45 , 46 , 47 , 46 , 47 , 37 , 117 \} , \{ 45 , 46 , 47 , 46 , 47 , 38 , 117 \} , \{ 46 , 46 , 46 , 46 , 47 , 38 , 116 \} , \{ 46 , 46 , 46 , 46 , 48 , 40 , 114 \} , \{ 46 , 45 , 48 , 46 , 48 , 37 , 117 \} , \{ 46 , 44 , 48 , 46 , 48 , 36 , 118 \} , \{ 46 , 45 , 47 , 46 , 48 , 37 , 117 \} , \{ 45 , 46 , 47 , 46 , 47 , 38 , 116 \} , \{ 45 , 46 , 47 , 46 , 47 , 39 , 115 \} , \{ 45 , 46 , 46 , 46 , 47 , 40 , 115 \} , \{ 46 , 46 , 46 , 46 , 48 , 40 , 114 \} , \{ 46 , 46 , 46 , 46 , 47 , 41 , 112 \} \} , \qquad ( 8 \text{-} 49 )$$

### 1.2.2 Binarization Process

### 1.2.2.1 General

Input to this process is a request for a syntax element.

Output of this process is the binarization of the syntax element.

Table 9-77 specifies the type of binarization process associated with each syntax element and corresponding inputs.

The specification of the truncated Rice (TR) binarization process, the truncated binary (TB) binarization process, the k-th order Exp-Golomb (EGk) binarization process and the fixed-length (FL) binarization process are given in clauses 9.3.3.3 through 9.3.3.7, respectively.

TABLE 9-77
Syntax elements and associated binarizations

| Syntax | | Binarization | |
|---|---|---|---|
| structure | Syntax element | Process | Input parameters |
| slice_data( ) | end_of_brick_one_bit | FL | cMAX = 1 |
| coding_tree_unit( ) | alf_ctb_flag[ ][ ][ ] | FL | cMAX = 1 |
| | alf_ctb_use_first_aps_flag | FL | cMAX = 1 |
| | alf_use_aps_flag | FL | cMAX = 1 |
| | alf_luma_fixed_filter_idx | TB | cMAX = 15 |
| | alf_luma_prev_filter_idx_minus1 | TB | cMax = slice_num_alf_aps_ids_luma − 2 |
| | alf_ctb_filter_alt_idx[ ][ ][ ] | TR | cMax = alf_chroma_num_alt_filters_minus1, |
| | | | cRiceParam = 0 |
| sao( ) | sao_merge_left_flag | FL | cMax = 1 |
| | sao_merge_up_flag | FL | cMax = 1 |
| | sao_type_idx_luma | TR | cMax = 2, cRiceParam = 0 |
| | sao_type_idx_chroma | TR | cMax = 2, cRiceParam = 0 |
| | sao_offset_abs[ ][ ][ ][ ] | TR | cMax = ( 1 << ( Min( bitDepth, 10 ) − 5 ) ) − 1, |
| | | | cRiceParam = 0 |
| | sao_offset_sign[ ][ ][ ][ ] | FL | cMax = 1 |
| | sao_band_position[ ][ ][ ] | FL | cMax = 31 |
| | sao_eo_class_luma | FL | cMax = 3 |
| | sao_eo_class_chroma | FL | cMax = 3 |
| coding_tree( ) | split_cu_flag | FL | cMax = 1 |
| | split_qt_flag | FL | cMax = 1 |
| | mtt_split_cu_vertical_flag | FL | cMax = 1 |
| | mtt_split_cu_binary_flag | FL | cMax = 1 |
| | mode_constraint_flag | FL | cMax = 1 |
| coding_unit( ) | cu_skip_flag[ ][ ] | FL | cMax = 1 |
| | pred_mode_ibc_flag | FL | cMax = 1 |
| | pred _mode_plt_flag | FL | cMax = 1 |
| | pred_mode_flag | FL | cMax = 1 |
| | intra_bdpcm_flag | FL | cMax = 1 |
| | intra_bdpcm_dir_flag | FL | cMax = 1 |
| | intra_mip_flag[ ][ ] | FL | cMax = 1 |
| | intra_mip_transposed[ ][ ] | FL | cMax = 1 |
| | intra_mip_mode[ ][ ] | FL | cMax = 2 |
| | intra_luma_ref_idx[ ][ ] | TR | cMax = 2, cRiceParam = 0 |
| | intra_subpartitions_mode_flag | FL | cMax = 1 |
| | intra_subpartitions_split_flag | FL | cMax = 1 |
| | intra_luma_mpm_flag [ ][ ] | FL | cMax = 1 |
| | intra_luma_not_planar_flag[ ][ ] | FL | cMax = 1 |
| | intra_luma_mpm_idx[ ][ ] | TR | cMax = 4, cRiceParam = 0 |
| | intra_luma_mpm_remainder[ ][ ] | TB | cMax = 60 |
| | cclm_mode_flag | FL | cMax = 1 |
| | cclm_mode_idx | TR | cMax = 2, cRiceParam = 0 |
| | intra_chroma_pred_mode | 9.3.3.8 | — |
| | general_merge_flag[ ][ ] | FL | cMax = 1 |
| | inter_pred_idc[ x0 ][ y0] | 9.3.3.9 | cbWidth, cbHeight |
| | inter_affine_flag[ ][ ] | FL | cMax = 1 |
| | cu_affine_type_flag[ ][ ] | FL | cMax = 1 |
| | sym_mvd_flag[ ][ ] | FL | cMax = 1 |
| | ref_idx_10[ ][ ] | TR | cMax = NumRefIdxActive[ 0 ] − 1, |
| | | | cRiceParam = 0 |
| | mvp_10_flag[ ][ ] | FL | cMax = 1 |
| | ref_idx_11[ ][ ] | TR | cMax = NumRefIdxActive[ 1 ] − 1, |
| | | | cRiceParam = 0 |
| | mvp_11_flag[ ][ ] | FL | cMax = 1 |
| | avmr_flag[ ][ ] | FL | cMax = 1 |
| | amvr_precision_idx[ ][ ] | FL | cMax = (inter_affine_flag = = 0 && |
| | | | CuPredMode[ 0 ][ x0 ][ y0 ] ! = |
| | | | MODE_IBC ) ? 2 : 1, cRiceParam = 0 |
| | bcw_idx[ ][ ] | TR | cMax = NoBackwardPredFlag ? 4: 2 |
| | cu_cbf | FL | cMax = 1 |
| | cu_sbt_flag | FL | cMax = 1 |
| | cu_sbt_quad_flag | FL | cMax = 1 |
| | cu_sbt_horizontal_flag | FL | cMax = 1 |
| | cu_sbt_pos_flag | FL | cMax = 1 |
| | lfnst_idx[ ][ ] | TR | cMax = 2, cRiceParam = 0 |
| | palette_predictor_run | EG0 | — |
| | num_signalled_palette_entries | EG0 | — |
| | new_palette_entries | FL | cMax = cldx = = 0 ? |
| | | | ( ( 1 << BitDepth_{Y} ) − 1 ) : |
| | | | ( ( 1 << BitDepth_{C} ) − 1 ) |
| | palette_escape_val_present_flag | FL | cMax = 1 |
| | num_palette_indices_minus1 | 9.5.3.13 | MaxPalettelndex |
| | palette_idx_idc | 9.5.3.14 | MaxPalettelndex |
| | copy_above_indices_for_final_run_flag | FL | cMax = 1 |
| | palette_transpose_flag | FL | cMax = 1 |
| | copy_above_palette_indices_flag | FL | cMax = 1 |
| | palette_run_prefix | TR | cMax = Floor( Log2( PaletteMaxRunMinus1 ) ) + 1, |
| | | | cRiceParam = 0 |
| | palette_run_suffix | TB | cMax = ( PrefixOffset << 1 ) > |
| | | | PaletteMaxRunMinus1 ? ( PalletMaxRun − PrefixOffset ) : |
| | | | ( PrefixOffset − 1 ) |
| | palette_escape_val | EG3 | |
| merge_data( ) | regular_merge_flag[ ][ ] | FL | cMax = 1 |
| | mmvd_merge_flag[ ][ ] | FL | cMax = 1 |
| | mmvd_cand_flag[ ][ ] | FL | cMax = 1 |
| | mmvd_distance_idx[ ][ ] | TR | cMax = 7, cRiceParam = 0 |
| | mmvd_direction_idx [ ][ ] | FL | cMax = 3 |
| | ciip_flag[ ][ ] | FL | cMax = 1 |
| | merge_subblock_flag[ ][ ] | FL | cMax = 1 |
| | merge_subblock_idx[ ][ ] | TR | cMax = MaxNumSubblockMergeCand − 1, |
| | merge_triangle_split_dir[ ][ ] | FL | cRiceParam = 0 |
| | | | cMax = 1 |
| | merge_triangle_idx0[ ][ ] | TR | cMax = MaxNumTriangleMergeCand − 1, |
| | merge_triangle_idx1[ ][ ] | TR | cRiceParam = 0 |
| | | | cMax = MaxNumTriangleMergeCand − 2, |
| | merge_idx[ ][ ] | TR | cRiceParam = 0 |
| | | | cMax = MaxNumMergeCand − 1, |
| mvd_coding( ) | abs_mvd_greater0_flag[ ] | FL | cRiceParam = 0 |
| | | | cMax = 1 |
| | abs_mvd_greater1_flag[ ] | FL | cMax = 1 |
| | abs_mvd_minus2[ ] | EG1 | — |
| | mvd_sign_flag[ ] | FL | cMax = 1 |
| transform_unit( ) | tu_cbf_luma[ ][ ][ ] | FL | cMax = 1 |
| | tu_cbf_cb[ ][ ][ ] | FL | cMax = 1 |
| | tu_cbf_cr[ ][ ][ ] | FL | cMax = 1 |
| | cu_qp_delta_abs | 9.3.3.10 | — |
| | cu_qp_delta_sign_flag | FL | cMax = 1 |
| | cu_chroma_qp_offset_flag | FL | cMax = 1 |
| | cu_chroma_qp_offset_idx | TR | cMax = chroma_qp_offset_list_len_minus1, |
| | | | cRiceParam = 0 |
| | transfom_skip_flag[ ][ ] | FL | cMax = 1 |
| | tu_mts_idx[ ][ ] | TR | cMax = 4, cRiceParam = 0 |
| | tu_joint_cbcr_residual_flag[ ][ ] | FL | cMax = 1 |
| residual_coding( ) | last_sig_coeff_x_prefix | TR | cMax = ( log2ZoTbWidth << 1 ) − 1, |
| | | | cRiceParam = 0 |
| | last_sig_coeff_y_prefix | TR | cMax = (log2ZoTbHeight << 1 ) − 1, |
| | | | cRiceParam = 0 |
| | last_sig_coeff_x_suffix | FL | cMax = ( 1 << ( ( last_sig_coeff_x_prefix >> 1 ) − 1 ) − 1 ) |
| | last_sig_coeff_y_suffix | FL | cMax = ( 1 << ( ( last_sig_coeff_y_prefix >> 1 ) − 1 ) − 1 ) |
| | coded_subblock_flag[ ][ ] | FL | cMax = 1 |
| | sig_coeff_flag[ ][ ] | FL | cMax = 1 |
| | par_level_flag[ ] | FL | cMax = 1 |
| | abs_level_gtx_flag[ ][ ] | FL | cMax = 1 |
| | abs_remainder[ ] | 9.3.3.11 | cldx, current sub-block index i, x0, y0, xC, |
| | | | yC, log2TbWidth, log2TbHeight |
| | dec_abs_level[ ] | 9.3.3.12 | cldx, x0, y0, xC, yC, log2TbWidth, |
| | | | log2TbHeight |
| | coeff_sign_flag[ ] | FL | cMax = 1 |

Derivation Process for ctxTable, ctxIdx and bypassFlag

General

Input to this process is the position of the current bin within the bin string, binIdx.

Outputs of this process are ctxTable, ctxIdx and bypassFlag.

The values of ctxTable, ctxIdx and bypassFlag are derived as follows based on the entries for binIdx of the corresponding syntax element in Table 9-82:
If the entry in Table 9-82 is not equal to “bypass”, “terminate” or “na”, the values of binIdx are decoded by invoking the DecodeDecision process as specified in clause 9.3.4.3.2 and the following applies:
   ctxTable is specified in Table 9-4
   The variable ctxInc is specified by the corresponding entry in Table 9-82 and when more than one value is listed in Table 9-82 for a binIdx, the assignment process for ctxInc for that binIdx is further specified in the clauses given in parenthesis.
   The variable ctxIdxOffset is specified in Table 9-4 depending on the current value of initType.
   ctxIdx is set equal to the sum of ctxInc and ctxIdxOffset.
   bypassFlag is set equal to 0.
Otherwise, if the entry in Table 9-82 is equal to “bypass”, the values of binIdx are decoded by invoking the DecodeBypass process as specified in clause 9.3.4.3.4 and the following applies:
   ctxTable is set equal to 0.
   ctxIdx is set equal to 0.
   bypassFlag is set equal to 1.a
Otherwise, if the entry in Table 9-82 is equal to “terminate”, the values of binIdx are decoded by invoking the DecodeTerminate process as specified in clause 9.3.4.3.5 and the following applies:
   ctxTable is set equal to 0.
   ctxIdx is set equal to 0.
   bypassFlag is set equal to 0.
Otherwise (the entry in Table 9-82 is equal to “na”), the values of binIdx do not occur for the corresponding syntax element.

TABLE 9-82
Assignment of ctxInc to syntax elements with context coded bins

| | binIdx | | | | | |
|---|---|---|---|---|---|---|
| Syntax element | 0 | 1 | 2 | 3 | 4 | >= 5 |
| end_of_brick_one_bit | terminate | na | na | na | na | na |
| alf_ctb_flag[ ][ ][ ] | 0..8 | na | na | na | na | na |
| | (clause 9.3.4.2.2) | | | | | |
| alf_ctb_use_first_aps_flag | 0 | na | na | na | na | na |
| alf_use_aps_flag | 0 | na | na | na | na | na |
| alf_luma_fixed_filter_idx | bypass | bypass | bypass | bypass | bypass | bypass |
| alf_luma_prev_filter_idx_ | bypass | bypass | bypass | bypass | bypass | bypass |
| minus1 | | | | | | |
| alf_ctb_filter_alt_idx[ 0 ][ ][ ] | 0 | 0 | 0 | 0 | 0 | 0 |
| alf_ctb_filter_alt_idx[ 1 ][ ][ ] | 1 | 1 | 1 | 1 | 1 | 1 |
| sao_merge_left_flag | 0 | na | na | na | na | na |
| sao_merge_up_flag | 0 | na | na | na | na | na |
| sao_type_idx_luma | 0 | bypass | na | na | na | na |
| sao_type_idx_chroma | 0 | bypass | na | na | na | na |
| sao_offset_abs[ ][ ][ ][ ] | bypass | bypass | bypass | bypass | bypass | na |
| sao_offset_sign[ ][ ][ ][ ] | bypass | na | na | na | na | na |
| sao_band_position[ ][ ][ ] | bypass | bypass | bypass | bypass | bypass | bypass |
| sao_eo_class_luma | bypass | bypass | na | na | na | na |
| sao_eo_class_chroma | bypass | bypass | na | na | na | na |
| split_cu_flag | 0..8 | na | na | na | na | na |
| | (clause 9.3.4.2.2) | | | | | |
| split_qt_flag | 0..5 | na | na | na | na | na |
| | (clause 9.3.4.2.2) | | | | | |
| mtt_split_cu_vertical_flag | 0..4 | na | na | na | na | na |
| | (clause 9.3.4.2.3) | | | | | |
| mtt_split_cu_binary_flag | ( 2 * | na | na | na | na | na |
| | mtt_split_cu_vertical_ | | | | | |
| | flag ) + | | | | | |
| | ( mttDepth < = 1 ? 1 : | | | | | |
| | 0 ) | | | | | |
| mode_constraint_flag | 0,1 | na | na | na | na | na |
| | (clause 9.3.4.2.2) | | | | | |
| cu_skip_flag[ ][ ] | 0,1,2 | na | na | na | na | na |
| | (clause 9.3.4.2.2) | | | | | |
| pred_mode_flag | 0,1 | na | na | na | na | na |
| | (clause 9.3.4.2.2) | | | | | |
| pred_mode_ibc_flag | 0,1,2 | na | na | na | na | na |
| | (clause 9.3.4.2.2) | | | | | |
| pred_mode_plt_flag | 0 | na | na | na | na | na |
| intra_bdpcm_flag | 0 | na | na | na | na | na |
| intra_bdpcm_dir_flag | 0 | na | na | na | na | na |
| intra_mip_flag[ ][ ] | (Abs( Log2(cbWidth) − | | | | | |
| | Log2(cbHeight) ) | | | | | |
| | > 1) ? | | | | | |
| | 3 : ( 0,1,2 | | | | | |
| | (clause 9.3.4.2.2) ) | | | | | |
| intra_mip_transposed[ ][ ] | bypass | bypass | bypass | bypass | bypass | bypass |
| intra_mip_mode[ ][ ] | bypass | bypass | bypass | bypass | bypass | bypass |
| intra_luma_ref_idx[ ][ ] | 0 | 1 | na | na | na | na |
| intra_subpartitions_mode_ | 0 | na | na | na | na | na |
| flag | | | | | | |
| intra_subpartitions_split_ | 0 | na | na | na | na | na |
| flag | | | | | | |
| intra_luma_mpm_flag[ ][ ] | 0 | na | na | na | na | na |
| intra_luma_not_planar_ | intra_subpartitions_ | na | na | na | na | na |
| flag[ ][ ] | mode_flag | | | | | |
| intra_luma_mpm_idx[ ][ ] | bypass | bypass | bypass | bypass | na | na |
| intra_luma_mpm_ | bypass | bypass | bypass | bypass | bypass | bypass |
| remainder[ ][ ] | | | | | | |
| cclm_mode_flag | 0 | na | na | na | na | na |
| cclm_mode_idx | 0 | bypass | na | na | na | na |
| intra_chroma_pred_mode | 0 | bypass | bypass | na | na | na |
| palette_predictor_run | bypass | bypass | bypass | bypass | bypass | bypass |
| num_signalled_palette_ | bypass | bypass | bypass | bypass | bypass | bypass |
| entries | | | | | | |
| new_palette_entries | bypass | bypass | bypass | bypass | bypass | bypass |
| palette_escape_val_ | bypass | na | na | na | na | na |
| present_flag | | | | | | |
| palette_transpose_flag | 0 | na | na | na | na | na |
| num_palette_indices_ | bypass | bypass | bypass | bypass | bypass | bypass |
| minus1 | | | | | | |
| palette_idx_idc | bypass | bypass | bypass | bypass | bypass | bypass |
| copy_above_palette_indices_ | 0 | na | na | na | na | |
| flag | | | | | | |
| copy_above_indices_for_ | 0 | na | na | na | na | na |
| final_run_flag | | | | | | |
| palette_run_prefix | 0..7 | | | | | |
| | (clause 9.3.4.2.11) | | | | | |
| palette_run_suffix | bypass | bypass | bypass | bypass | bypass | bypass |
| palette_escape_val | bypass | bypass | bypass | bypass | bypass | bypass |
| general_merge_flag[ ][ ] | 0 | na | na | na | na | na |
| regular_merge_flag[ ][ ] | cu_skip_flag[ ][ ] ? | na | na | na | na | na |
| | 0 : 1 | | | | | |
| mmvd_merge_flag[ ][ ] | 0 | na | na | na | na | na |
| mmvd_cand_flag[ ][ ] | 0 | na | na | na | na | na |
| mmvd_distance_idx[ ][ ] | 0 | bypass | bypass | bypass | bypass | bypass |
| mmvd_direction_idx[ ][ ] | bypass | bypass | na | na | na | na |
| merge_subblock_flag[ ][ ] | 0,1,2 | na | na | na | na | na |
| | (clause 9.3.4.2.2) | | | | | |
| merge_subblock_idx[ ][ ] | 0 | bypass | bypass | bypass | bypass | na |
| ciip_flag[ ][ ] | 0 | na | na | na | na | na |
| merge_idx[ ][ ] | 0 | bypass | bypass | bypass | bypass | na |
| merge_triangle_split_ | bypass | na | na | na | na | na |
| dir[ ][ ] | | | | | | |
| merge_triangle_idx0[ ][ ] | 0 | bypass | bypass | bypass | bypass | na |
| merge_triangle_idx1[ ][ ] | 0 | bypass | bypass | bypass | na | na |
| inter_pred_idc[ x0 ][ y0 ] | ( cbWidth + | 4 | na | na | na | na |
| | cbHeight ) > 12 ? | | | | | |
| | 7 − ( ( 1 + | | | | | |
| | Log2( cbWidth ) + | | | | | |
| | Log2( cbHeight) ) >> | | | | | |
| | 1 ) : 4 | | | | | |
| inter_affine_flag[ ][ ] | 0,1,2 | na | na | na | na | na |
| | (clause 9.3.4.2.2) | | | | | |
| cu_affine_type_flag[ ][ ] | 0 | na | na | na | na | na |
| sym_mvd_flag[ ][ ] | 0 | na | na | na | na | na |
| ref_idx_l0[ ][ ] | 0 | 1 | bypass | bypass | bypass | bypass |
| ref_idx_l1 [ ][ ] | 0 | 1 | bypass | bypass | bypass | bypass |
| mvp_l0_flag[ ][ ] | 0 | na | na | na | na | na |
| mvp_l1_flag[ ][ ] | 0 | na | na | na | na | na |
| amvr_flag[ ][ ] | inter_affine_flag[ ][ ] | na | na | na | na | na |
| | ? 1 : 0 | | | | | |
| amvr_precision_idx[ ][ ] | 0 | 1 | na | na | na | na |
| bcw_idx[ ][ ] | 0 | bypass | na | na | na | na |
| NoBackwardPredFlag | | | | | | |
| = = 0 | | | | | | |
| bcw_idx[ ][ ] | 0 | bypass | bypass | bypass | na | na |
| NoBackwardPredFlag | | | | | | |
| = = 1 | | | | | | |
| cu_cbf | 0 | na | na | na | na | na |
| cu_sbt_flag | ( cbWidth * | na | na | na | na | na |
| | cbHeight < 256 ) ? | | | | | |
| | 1 : 0 | | | | | |
| cu_sbt_quad_flag | 0 | na | na | na | na | na |
| cu_sbt_horizontal_flag | ( cbWidth = = | na | na | na | na | na |
| | cbHeight ) ? 0 : | | | | | |
| | ( cbWidth < | | | | | |
| | cbHeight ) ? 1 : 2 | | | | | |
| cu_sbt_pos_flag | 0 | na | na | na | na | na |
| lfnst_idx[ ][ ] | ( tu_mts_idx[ x0 ] | bypass | na | na | na | na |
| | [ y0 ] = = 0 && | | | | | |
| | treeType != | | | | | |
| | SINGLE_TREE ) ? | | | | | |
| | 1 : 0 | | | | | |
| abs_mvd_greater0_flag[ ] | 0 | na | na | na | na | na |
| abs_mvd_greater1_flag[ ] | 0 | na | na | na | na | na |
| abs_mvd_minus2[ ] | bypass | bypass | bypass | bypass | bypass | bypass |
| mvd_sign_flag[ ] | bypass | na | na | na | na | na |
| tu_cbf_luma[ ][ ][ ] | 0,1,2,3 | na | na | na | na | na |
| | (clause 9.3.4.2.5) | | | | | |
| tu_cbf_cb[ ][ ][ ] | 0 | na | na | na | na | na |
| tu_cbf_cr[ ][ ][ ] | tu_cbf_cb[ ][ ][ ] | na | na | na | na | na |
| cu_qp_delta_abs | 0 | 1 | 1 | 1 | 1 | bypass |
| cu_qp_delta_sign_flag | bypass | na | na | na | na | na |
| cu_chroma_qp_offset_flag | 0 | na | na | na | na | na |
| cu_chroma_qp_offset_idx | 0 | 0 | 0 | 0 | 0 | na |
| transform_skip_flag[ ][ ] | 0 | na | na | na | na | na |
| tu_mts_idx[ ][ ] | 0 | 1 | 2 | 3 | na | na |
| tu_joint_cbcr_residual_ | 2*tu_cbf_cb[ ][ ] + | na | na | na | na | na |
| flag[ ][ ] | tu_cbf_cr[ ][ ] − 1 | | | | | |
| last_sig_coeff_x_prefix | 0..22 | | | | | |
| | (clause 9.3.4.2.4) | | | | | |
| last_sig_coeff_y_prefix | 0..22 | | | | | |
| | (clause 9.3.4.2.4) | | | | | |
| last_sig_coeff_x_suffix | bypass | bypass | bypass | bypass | bypass | bypass |
| last_sig_coeff_y_suffix | bypass | bypass | bypass | bypass | bypass | bypass |
| coded_sub_block_flag[ ][ ] | 0 .7 | na | na | na | na | na |
| | (clause 9.3.4 2.6) | | | | | |
| sig_coeff_flag[ ][ ] | ( MaxCcbs > 0) ? | na | na | na | na | na |
| | (0..93 | | | | | |
| | (clause 9.3.4.2 8) ) : | | | | | |
| | bypass | | | | | |
| par_level_flag[ ] | ( MaxCcbs > 0) ? | na | na | na | na | na |
| | (0..32 | | | | | |
| | (clause 9.3.42.9) ) : | | | | | |
| | bypass | | | | | |
| abs_level_gtx_flag[ ] | (MaxCcbs > 0) ? | na | na | na | na | na |
| | (0..73 | | | | | |
| | (clause 9.3.4.2.9) ) : | | | | | |
| | bypass | | | | | |
| abs_remainder[ ] | bypass | bypass | bypass | bypass | bypass | bypass |
| dec_abs_level[ ] | bypass | bypass | bypass | bypass | bypass | bypass |
| coeff_sign_flag[ ] | bypass | na | na | na | na | na |
| transform_skip_flag | | | | | | |
| [ x0 ][ y0 ] = = 0 | | | | | | |
| coeff_sign_flag[ ] | ( MaxCcbs > 0) ? | na | na | na | na | na |
| transform_skip_flag | (0..5 | | | | | |
| [ x0 ][ y0 ] = = 1 | (clause 9.3.4.2.10) ) : | | | | | |
| | bypass | | | | | |

What is claimed is:

1. A method of decoding video data, the method comprising:
storing a plurality of Matrix Intra Prediction (MIP) matrices;
obtaining, from a bitstream that includes an encoded representation of the video data, a MIP mode syntax element indicating a MIP mode index for a current block of the video data;
obtaining a transpose flag from the bitstream;
determining an input vector based on neighboring samples for the current block, wherein the transpose flag indicates whether the input vector is transposed;
determining a prediction signal, wherein determining the prediction signal comprises multiplying a MIP matrix by the input vector, wherein the prediction signal comprises values corresponding to a first set of locations in a prediction block for the current block, the MIP matrix is one of the plurality of stored MIP matrices, and the MIP matrix corresponds to the MIP mode index;
applying an interpolation process to the prediction signal to determine values corresponding to a second set of locations in the prediction block for the current block; and
reconstructing the current block by adding samples of the prediction block for the current block to corresponding residual samples for the current block.

2. The method of claim 1, wherein the MIP mode index is equal to 0.

3. The method of claim 1, further comprising:
bypass decoding the transpose flag; and
bypass decoding the MIP mode syntax element.

4. The method of claim 1, wherein determining the prediction signal further comprises adding an offset vector to a product of the multiplication of the MIP matrix by the input vector.

5. The method of claim 1, wherein an order in which top boundary pixel values and left boundary pixel values are concatenated to each other is dependent on whether the input vector is transposed, the neighboring samples including the top boundary pixel values and the left boundary pixel values.

6. A method of encoding video data, the method comprising:
storing a plurality of Matrix Intra Prediction (MIP) matrices;
determining an input vector based on neighboring samples for a current block of the video data;
determining a MIP matrix from the plurality of stored MIP matrices;
signaling, in a bitstream that includes an encoded representation of the video data, a MIP mode syntax element indicating a MIP mode index for the current block;
signaling, in the bitstream, a transpose flag that indicates whether the input vector is transposed;
determining a prediction signal, wherein determining the prediction signal comprises multiplying the determined MIP matrix by the input vector, wherein the prediction signal comprises values corresponding to a first set of locations in a prediction block for the current block, and the determined MIP matrix corresponds to the MIP mode index;
applying an interpolation process to the prediction signal to determine values corresponding to a second set of locations in the prediction block for the current block; and
generating residual samples for the current block based on differences between samples of the current block and corresponding samples of the prediction block for the current block.

7. The method of claim 6, wherein the MIP mode index is equal to 0.

8. The method of claim 6, further comprising:
bypass encoding the transpose flag; and
bypass encoding the MIP mode syntax element.

9. The method of claim 6, wherein determining the prediction signal further comprises adding an offset vector to a product of the multiplication of the determined MIP matrix by the input vector.

10. The method of claim 6, further comprising determining whether to transpose the input vector.

11. The method of claim 6, wherein an order in which top boundary pixel values and left boundary pixel values are concatenated to each other is dependent on whether the input vector is transposed, the neighboring samples including the top boundary pixel values and the left boundary pixel values.

12. A device for decoding video data, the device comprising:
a memory to store a plurality of Matrix Intra Prediction (MIP) matrices; and
one or more processors implemented in circuitry, the one or more processors configured to:
obtain, from a bitstream that includes an encoded representation of the video data, a MIP mode syntax element indicating a MIP mode index for a current block of the video data;
obtain a transpose flag from the bitstream;
determine an input vector based on neighboring samples for the current block, wherein the transpose flag indicates whether the input vector is transposed;
determine a prediction signal, wherein the one or more processors are configured such that, as part of determining the prediction signal, the one or more processors multiply a MIP matrix by the input vector, wherein the prediction signal comprises values corresponding to a first set of locations in a prediction block for the current block, the MIP matrix is one of the plurality of stored MIP matrices, and the MIP matrix corresponds to the MIP mode index;
apply an interpolation process to the prediction signal to determine values corresponding to a second set of locations in the prediction block for the current block; and
reconstruct the current block by adding samples of the prediction block for the current block to corresponding residual samples for the current block.

13. The device of claim 12, wherein the MIP mode index is equal to 0.

14. The device of claim 12, wherein the one or more processors are further configured to:
bypass decode the transpose flag; and
bypass decode the MIP mode syntax element.

15. The device of claim 12, wherein the one or more processors are configured such that, as part of determining the prediction signal, the one or more processors add an offset vector to a product of the multiplication of the MIP matrix by the input vector.

16. The device of claim 12, further comprising a display configured to display decoded video data.

17. The device of claim 12, wherein the device comprises one or more of a camera, a computer, a mobile device, a broadcast receiver device, or a set-top box.

18. The device of claim 12, wherein an order in which top boundary pixel values and left boundary pixel values are concatenated to each other is dependent on whether the input vector is transposed, the neighboring samples including the top boundary pixel values and the left boundary pixel values.

19. A device for encoding video data, the device comprising:
a memory to store a plurality of Matrix Intra Prediction (MIP) matrices; and
one or more processors implemented in circuitry, the one or more processors configured to:
determine an input vector based on neighboring samples for a current block of the video data;
determine a MIP matrix from the plurality of stored MIP matrices;
signal, in a bitstream that includes an encoded representation of the video data, a MIP mode syntax element indicating a MIP mode index for the current block;
signal, in the bitstream, a transpose flag that indicates whether the input vector is transposed;
determine a prediction signal, wherein the one or more processors are configured such that, as part of determining the prediction signal, the one or more processors multiply the determined MIP matrix by the input vector, wherein the prediction signal comprises values corresponding to a first set of locations in a prediction block for the current block, and the determined MIP matrix corresponds to the MIP mode index;
apply an interpolation process to the prediction signal to determine values corresponding to a second set of locations in the prediction block for the current block; and
generate residual samples for the current block based on differences between samples of the current block and corresponding samples of the prediction block for the current block.

20. The device of claim 19, wherein the MIP mode index is equal to 0.

21. The device of claim 19, wherein the one or more processors are further configured to:
bypass encode the transpose flag; and
bypass encode the MIP mode syntax element.

22. The device of claim 19, wherein the one or more processors are configured such that, as part of determining the prediction signal, the one or more processors add an offset vector to a product of the multiplication of the determined MIP matrix by the input vector.

23. The device of claim 19, wherein the one or more processors are further configured to determine whether to transpose the input vector.

24. The device of claim 19, wherein an order in which top boundary pixel values and left boundary pixel values are concatenated to each other is dependent on whether the input vector is transposed, the neighboring samples including the top boundary pixel values and the left boundary pixel values.

25. A device for decoding video data, the device comprising:
means for storing a plurality of Matrix Intra Prediction (MIP) matrices;
means for obtaining, from a bitstream that includes an encoded representation of the video data, a MIP mode syntax element indicating a MIP mode index for a current block of the video data;
means for obtaining a transpose flag from the bitstream;
means for determining the input vector based on neighboring samples for the current block, wherein the transpose flag indicates whether the input vector is transposed;
means for determining a prediction signal, wherein determining the prediction signal comprises multiplying a MIP matrix by the transposed input vector, wherein the prediction signal comprises values corresponding to a first set of locations in a prediction block for the current block, the MIP matrix is one of the plurality of stored MIP matrices, and the MIP matrix corresponds to the MIP mode index;
means for applying an interpolation process to the prediction signal to determine values corresponding to a second set of locations in the prediction block for the current block; and
means for reconstructing the current block by adding samples of the prediction block for the current block to corresponding residual samples for the current block.

26. A device for encoding video data, the method comprising:
means for storing a plurality of Matrix Intra Prediction (MIP) matrices;
means for determining an input vector based on neighboring samples for a current block of the video data;
means for determining a MIP matrix from the plurality of stored MIP matrices;
means for signaling, in a bitstream that includes an encoded representation of the video data, a MIP mode syntax element indicating a MIP mode index for the current block;
means for signaling, in the bitstream, a transpose flag that indicates whether the input vector is transposed;
means for determining a prediction signal, wherein determining the prediction signal comprises multiplying the determined MIP matrix by the input vector, wherein the prediction signal comprises values corresponding to a first set of locations in a prediction block for the current block, and the determined MIP matrix corresponds to the MIP mode index;
means for applying an interpolation process to the prediction signal to determine values corresponding to a second set of locations in the prediction block for the current block; and
means for generating residual samples for the current block based on differences between samples of the current block and corresponding samples of the prediction block for the current block.

27. A computer-readable storage medium having stored thereon instructions that, when executed, cause one or more processors to:
store a plurality of Matrix Intra Prediction (MIP) matrices;
obtain, from a bitstream that includes an encoded representation of the video data, a MIP mode syntax element indicating a MIP mode index for a current block of the video data;
obtain a transpose flag from the bitstream;
determining the input vector based on neighboring samples for the current block, wherein the transpose flag indicates whether the input vector is transposed;
determine a prediction signal, wherein determining the prediction signal comprises multiplying a MIP matrix by the transposed input vector, wherein the prediction signal comprises values corresponding to a first set of locations in a prediction block for the current block, the MIP matrix is one of the plurality of stored MIP matrices, and the MIP matrix corresponds to the MIP mode index;
apply an interpolation process to the prediction signal to determine values corresponding to a second set of locations in the prediction block for the current block; and
reconstruct the current block by adding samples of the prediction block for the current block to corresponding residual samples for the current block.

28. A computer-readable storage medium having stored thereon instructions that, when executed, cause one or more processors to:
store a plurality of Matrix Intra Prediction (MIP) matrices;
determine an input vector based on neighboring samples for a current block of the video data;
determine a MIP matrix from the plurality of stored MIP matrices;
signal, in a bitstream that includes an encoded representation of the video data, a MIP mode syntax element indicating a MIP mode index for the current block;
signal, in the bitstream, a transpose flag that indicates whether the input vector is transposed;
determine a prediction signal, wherein determining the prediction signal comprises multiplying the determined MIP matrix by the transposed input vector, wherein the prediction signal comprises values corresponding to a first set of locations in a prediction block for the current block, and the MIP matrix corresponds to the MIP mode index;
apply an interpolation process to the prediction signal to determine values corresponding to a second set of locations in the prediction block for the current block; and
generate residual samples for the current block based on differences between samples of the current block and corresponding samples of the prediction block for the current block.
